(19) United States
(12) Patent Application Publication
(10) Pub. No.: US 2017/0206291 A1
(43) Pub. Date: Jul. 20, 2017

(54) Method for computational fluid dynamics and apparatuses for jet-effect use

(71) Applicant: SOLITON HOLDINGS CORPORATION, DELAWARE CORPORATION, New York, NY (US)

(72) Inventor: Yuri ABRAMOV, Holon (IL)

(21) Appl. No.: 15/409,876

(22) Filed: Jan. 19, 2017

Related U.S. Application Data
(63) Continuation-in-part of application No. 15/175,260, filed on Jun. 7, 2016, now abandoned.

(30) Foreign Application Priority Data
Jan. 20, 2016 (GB) 1601094.4
Mar. 22, 2016 (GB) 1604802.7
Aug. 2, 2016 (GB) 1613335.7
Aug. 2, 2016 (GB) 1613336.5

(51) Int. Cl. G06F 17/50; G06F 17/16; G06F 17/13

(52) U.S. Cl. CPC G06F 17/5009; G06F 17/13; G06F 17/16

(57) ABSTRACT

The invention provides a method for computational fluid dynamics and apparatuses making enable an efficient implementation and use of an enhanced jet-effect, triggered by a specifically shaped tunnel, and of a hydrophobic jet-effect, triggered by a hydrophobic corpus. The method is based on the approaches of the kinetic theory of matter, thermodynamics, and continuum mechanics, providing generalized equations of fluid motion. The method is applicable for slow-flowing as well as fast-flowing real compressible-extendable fluids and enables optimal design of convergent-divergent nozzles, providing for the most efficient jet-effect at subsonic, transonic, supersonic and hypersonic velocities. The method can be applied to airfoil shape optimization for bodies flying separately and in a multi-stage cascaded sequence. The method enables a design of a flying-saucer of high mobility. The method enables apparatuses for electricity harvesting from the fluid heat-energy, providing a positive net-efficiency. The method enables efficient water-harvesting from air.

### FIELD OF THE INVENTION

The invention relates generally to fluid dynamics and, more particularly, to jet-effect modeling and use for convergent-divergent jet-nozzle design and for hydrophobic jet-gear implementation.

### BACKGROUND OF THE INVENTION

The following issued patents and patent publications provide potentially relevant background material, and are all incorporated by reference in their entirety: U.S. Pat. No. 6,981,366 (Sharpe), US 2008/0061559 A1 (Hirshberg), U.S. Pat. No. 8,268,030 (Abramov), U.S. Pat. No. 8,221,514 (Abramov), U.S. Pat. No. 8,611,787 (Bulman), GB894450 A (GENERAL ELECTRIC), US2011/083420 A1 (CLAY), US2005/027498 A1 (CANON), and US2014/288906 A1 (JAPAN).

The well-known and widely-used jet-effect provides for the effect of gas extension and thereby acceleration. Accelerated flow is widely applied to propelling some kinds of vehicles having jet-engines usually supplied by either converging or convergent-divergent nozzles, to which the term “jet-nozzle” is also applied to emphasize the jet-effect importance. U.S. Pat. No. 6,981,366 by Sharpe overviews numerous modifications of the jet-effect implementation.

For the purposes of the present patent application, the term “jet-effect” is used in a wide sense as the effect of fluid flow portion convective acceleration at the expense of fluid portion internal heat energy. In particular, a jet-effect occurs when the fluid portion moves adjacent to configured walls and is subjected to the walls accelerating action. For example, the fluid is gas and the walls are configured to form a converging or convergent-divergent nozzle. Another example is a case, wherein the fluid is water and the configured walls have a hydrophobic surface. Thus, the term “jet-effect”, used here in a wide sense, assumes that the process of gas extension may be insignificant or latent. For example, the term “jet-effect” may also be applied to the well-known and widely-used effect of convective acceleration of a wind-portion, which is flowing over a convex upper surface of an airplane wing and is thereby being subjected to the varying of flow front cross-section in an imaginary convergent-divergent nozzle.

For the purposes of the present invention, the term “imaginary wall”, applied to flowing fluid streamlines, should be understood as a material (but not virtual in a vacuum) wall, formed by the fluid's matter, forcedly-bordering a portion of the flowing fluid. I.e. the material but invisible by the human eye and thereby imaginary wall acts on adjoining fluid portions, enforcing the fluid portions to move along the streamlines, i.e. in alignment with the imaginary wall. When flowing plasma is subjected to an action of a magnetic field, “imaginary walls” can be also formed by the magnetic field's force-lines defining the streamlines of the flowing plasma.

In US 2008/0061559 A1 patent application, Hirshberg points out that the jet-effect is accompanied by decreasing static pressure and temperature, and suggests applying the phenomenon as a trigger for vapor-to-water condensation.

In U.S. Pat. No. 8,268,030 “Wind Energy Use” and U.S. Pat. No. 8,221,514 “Ecologically Clean Method and Apparatus for Water Harvesting from Air”, Abramov points out that a long cascade of streamlined nozzles provides a convergence of a wider front of fluid flow, and provides for an adaptation of the jet-effect use for big-scale devices.

The primary teaching of the present patent application, in general, is a method for computational fluid dynamics, and, in particular, a modeling and optimal implementation of jet-effect, in particular, including the de Laval effect. Optimized jet-boosters and hydrophobic jet-gears are suggested.

For the purposes of the present patent application, the term “velocity of a flying body” should be understood as the body motion velocity relative to a stationary fluid; and vice-versa, the term “flow velocity” should be understood as the fluid flow velocity relative to the considered body submerged in the flowing fluid. These two terms are interrelated according to Galilean relativity.

For the purposes of the present patent application, the term “M-velocity” should be understood as the fluid velocity measured in Mach numbers, or identically, velocity normalized to the temperature dependent velocity of sound in the fluid.

For the purposes of the present patent application, the well-known terms “low-subsonic”, “high-subsonic”, “transonic”, “supersonic”, and “hypersonic” are used to specify the flow velocity ranges as the following:
(a) the low-subsonic velocity range is defined as the M-velocity range comprising M-velocities lower than 0.3 Mach;
(b) the high-subsonic velocity range is defined as the M-velocity range comprising M-velocities higher than 0.3 Mach and lower than 0.8 Mach;
(c) the transonic velocity range is defined as the M-velocity range comprising M-velocities higher than 0.8 Mach and lower than 1.2 Mach;
(d) the supersonic velocity range is defined as the M-velocity range comprising M-velocities higher than 1 Mach and lower than 5 Mach; and
(e) the hypersonic velocity range is defined as the M-velocity range comprising M-velocities higher than 5 Mach.

Moreover, for the purposes of the present patent application, the term “specific M-velocity” is introduced to separate the terms “low M-velocities”, associated with M-velocities lower than the specific M-velocity indicated by M_{*}, and “high M-velocities”, associated with M-velocities higher than the specific M-velocity M_{*}. The value of the specific M-velocity M_{*} will be defined hereinbelow by a specific molecular structure of fluid. Furthermore, the term “essential M-velocity range” is defined as an M-velocity range comprising the specific M-velocity M_{*}.

For the purposes of the present patent application, the term “molecular fluid” should be understood as a fluid substance composed of randomly moving and interacting molecules, according to the kinetic theory of matter.

For instance, air is considered as a molecular fluid, and wind is considered as a natural process, bringing fresh portions of air, storing both: the heat energy of molecules Brownian random motion and the kinetic energy of wind motion. Normally, in nature, when the wind is of 10 m/sec, the proportion is such that 99.96% is the heat energy [i.e. warmth] and only 0.04% is the kinetic energy. A phenomenon of a transformation of warmth into a hurricane power is well-known; however, the warmth of ambient natural air remains unused in the world industry. Possession of a technology to control the transformation of the surrounding air and/or water warmth into a directional motion of the fluid could provide a renewable cycle, comprising:
transformation of the flowing fluid heat-power into acquired kinetic-power of an arisen jetstream;
conversion of the jetstream kinetic-power into useful electric-power; and consumption of the electric-power, in the final analysis, inevitably dissipating back into the warmth of surrounding matter.

There is therefore a need in the art for a method and apparatus to provide a proper analysis and optimal design of a system, implementing a controllable enhanced jet-effect, appropriate for use in industry.

### The Origin of Life

The term “chiral”, applied to a body, has a sense that the body has an overall shape, asymmetric in such a way that the shape and its mirror image are not superimposable. Reference is now made to prior art FIG. 1a, showing schematically a so-called “left-handed” stereoisomer of an amino acid molecule, marked by numeral 1, being chiral, i.e. there is another so-called “right-handed” stereoisomer, marked by numeral 2, in reality or in potential, that is of identical composition, but which is arranged in a non-superimposable mirror image configuration.

A definition of life is neither simple nor unequivocal in the nowaday science. One qualifies a life as an existence of matter in a form of self-replicating protein molecules, or more fundamentally, of ribonucleic acid (RNA) molecules. However, the origin of life remains an extraordinary problem. The principle question about the origin of life is the following. What is the origin of the dominant presence of left-handed stereoisomers of amino acids in the live-nature on the Earth, even though their synthesis normally results in an equal mixture of the right- and left-handed molecular forms? Innumerable mechanisms have been proposed for the origin of left-chiral dominance in amino acids, and none has been proven.

There is therefore a need in the art for a method to provide a proper possible natural mechanism allowing for a synthesis of long spiral-like molecules, composed of a certain kind of stereoisomers of amino acids only.

### Venturi Effect

Reference is now made to prior art FIG. 1b. FIG. 1b is a schematic illustration of a shaped convergent-divergent nozzle 102, pipe-section in a sagittal plane. The shape can be described as comprising an inlet part 103 constricting into a narrow throat 104, further followed by a divergent outlet part 105. When a fluid 106 flows slowly through convergent-divergent nozzle 102, a jet-effect is observed in an adiabatic process, i.e. velocity increases in narrow throat 104 at the expense of the static pressure in fluid 106. Speedometers 1071, 1072, 1073 and barometers 1081, 1082, 1083 illustrate the interrelated behavior of the velocity and static pressure. This jet-effect is known also as the Venturi effect. Thus, the Venturi acceleration effect is observed in the case of a slow and converging flow, and the Venturi retarding effect is observed in the case of a slow and divergent flow.

### De Laval Effect

Reference is now made to prior art FIGS. 1c and 1d. FIG. 1c shows schematically a pipe 100 referred to the de Laval nozzle that, in principle, is similar to pipe 102 shown in FIG. 1b, but now the incoming fluid-flow 101 is fast enough such that fluid 101 becomes substantially compressible-expandable. In this case, in an adiabatic process, the de Laval effect is observed. This is the effect of extension of fluid 101 in the divergent outlet part 142 resulting in a further decrease of the static pressure and temperature and a correlated increase of the flow velocity.

FIG. 1d illustrates schematically graphics of distributions of the fluid-flow 101's (FIG. 1c) three parameters: velocity 150, static pressure 160, and temperature 170, each along the length of nozzle 100. A standard rocket convergent-divergent jet-nozzle 100 can be modeled as a cylinder 140 that leads to a constriction 141, known as the “throat”, which leads into a widening “exhaust bell” 142 open at the end. The location of the narrowest cross-section of the throat is called as the “critical condition” point 180. High speed and therefore compressible-expandable hot fluid 101 flows through throat 141, where the velocity picks up 151 and the pressure and temperature fall, 161 and 171 correspondingly. Hot fluid 101 exits throat 141 and enters the widening exhaust bell 142. It expands rapidly, and this expansion drives the velocity up 152, while the pressure and temperature continue to fall, 162 and 172 correspondingly. This jet-effect phenomenon of fluid 101 extra-acceleration at the expense of the fluid 101 heat energy, defined by the static pressure, temperature, and density, is applied to jet-engines, particularly to accelerate a rocket. A sharp slope of the static pressure, observed in throat 141, results in pressure waves, called Mach waves. An undesired influence of the Mach waves in the de Laval nozzle is described, for example, in U.S. Pat. No. 8,611,787 “Rocket nozzles for unconventional vehicles” by Bulman.

Ordinary. Blowing Ventilator

FIG. 1e is a prior art schematic drawing of ordinary blowing ventilator 110 operating in open air space. Ordinary blowing ventilator 110, defined by the main functionality to launch a jetstream characterized by the flow headway-motion kinetic-power, has an inherent engine [not shown here] consuming either a power of burned fuel or an electrical power. Ordinary blowing ventilator 110 comprises blades 112, having an asymmetrical shape such that, when forcedly rotating in frontal plane 119 and covering effective cross-section 114, suck air portions 115.A from space “A1” located upstream-afore effective cross-section 114 and convert air portions 115.A into an accelerated jetstream 115.B entering space “B1” located downstream-behind effective cross-section 114. Space “A1”, comprising air portions 115.A subjected to the sucking and motion through effective cross-section 114, is bordered by streamlines, forming imaginary contours 116.A. The imaginary contours 116.A separate space “A1” from space “C1”, comprising air portions 115.C, drawn by moving air portions 115.A and flowing toward frontal plane 119 out of effective cross-section 114. Space “B1”, comprising jetstream 115.B, is bordered by streamlines, forming imaginary contours 116.B. The imaginary contours 116.B separate space “B1” from space “DI”, comprising air portions 115.D, drawn by jetstream 115.B and flowing downstream-behind frontal plane 119. A complicated motion of air portions 115.A, 115.B, 115.C, and 115.D comprises both: a headway-motion, i.e. a laminar component of motion aligned with the imaginary contours 116.A and 116.B having a prevalent direction along imaginary sagittal axis 111, and a whirling-motion, i.e. a turbulent component of motion, dominantly, whirling around imaginary sagittal axis 111. For the purposes of the present patent application, the term “sagittal axis” is applied to an axis co-directed with a prevalent direction of a flow headway motion. The mentioned term “streamlines”, applied to imaginary contours 116.A and 116.B, has a widened sense, spread to the streamlines projections on a plane comprising imaginary sagittal axis 111, for instance, either sagittal or transversal, meaning that there is no essential mass exchange between:
air portions 115.A of space “A1” and air portions 115.C of space “C1”, and
helically whirling jetstream 115.B of space “B1” and air portions 115.D of space “DI”.
   The power, consumed by ordinary blowing ventilator 110 is expended for:
the complicated motion of air portions 115.A, which then are transformed into helically whirling jetstream 115.B;
the complicated motion of air portions 115.C, which then are transformed into moving air portions 115.D;
the overcoming of air viscous-resistance; and
the compensation of inner resistance of the inherent engine.
   Wherein the part of the power consumption, expended for the overcoming of air viscous-resistance and compensation of inner resistance of the inherent engine, dissipates in the acquired warmth of outflowing air portions 115.B and 115.D. Streamlines 116.A and 116.B constitute an imaginary convergent-divergent tunnel, where, in addition to the mentioned effect of flow complicated motion, powered by forcedly rotating blades 112, the Venturi effect, described above referring to FIG. 1b, occurring in an adiabatic process, is expected, thereby saving the power for the additionally acquired convective acceleration of jetstream 115.B. The velocity of jetstream 115.B headway-motion is distributed on cross-section 118 non-uniformly. Shapes of forcedly rotating blades 112, on the one hand, define the shapes of imaginary contours 116.A and 116.B, and on the other hand, define the jetstream 115.B headway-motion velocity distribution on cross-section 118. The resulting functionality net-efficiency of ordinary blowing ventilator 110 is defined by the ratio of the kinetic-power of launched jetstream 115.B headway-motion to the power, consumed by the inherent engine of ordinary blowing ventilator 110. Taking into the account the mentioned Venturi effect, the resulting net-efficiency of ordinary blowing ventilator 110 interrelates with the Venturi effect efficiency.

There is therefore a need in the art for a method and apparatus to provide a proper analysis and optimal design of an improved ventilator and propeller to implement the most efficient and controlled desired functionality.

### Phenomenon of Convective Self-Acceleration

FIG. 1f is a prior art schematic drawing of a body 12.0 blown by an initially laminar airflow having portion 12.2 enveloping body 12.0. It is assumed that a velocity of the airflow motion is much lower than 0.5 Mach, for instance, 1 m/sec. For simplicity and without loss of reasoning, consider a case when the body 12.0 corpus has at least partially airfoil shape providing for that ambient-adjoining sub-portions 12.5 and 12.6 of airflow portion 12.2 remain laminar at least upstream afore a frontal plane, crossing the body 12.0 corpus.

Here,
such a frontal plane is marked with the dotted line having numeral 12.1;
dashed lines 12.3 and 12.4 are imaginary streamlines bordering airflow portion 12.2 as a whole and being sufficiently far from body 12.0 that allows to ignore the airflow streamlines minor curving when bordering ambient-adjoining sub-portions 12.5 and 12.6; and
arrow 12.7 symbolizes a portion of downstream airflow, not obligatorily laminar.

When flowing around body 12.0, ambient-adjoining sub-portions 12.5 and 12.6 of airflow portion 12.2 become subjected to reshaping and can be considered as moving through an imaginary tunnel, which is characterized by varying cross-sectional area. According to the mass conservation law, called also the equation of continuity: ρAu=Const, where ρ is the density of flux; u is the flux velocity, and A is the flux cross-sectional area, ambient-adjoining sub-portions 12.5 and 12.6 move faster than yet to be reshaped airflow portion 12.2 because the air density changes are minor at low airflow velocities and the sub-portions have the cumulative cross-sectional area smaller than the cross-sectional area of yet to be reshaped airflow portion 12.2. Therefore, the cumulative kinetic energy of ambient-adjoining sub-portions 12.5 and 12.6 is higher than the kinetic energy of oncoming airflow portion 12.2 yet to be subjected to the reshaping.

One of the key questions about the origin of flowing fluid portion acceleration is the following. At the expense of what kind of energy the sub-portions became accelerated, if the case is adiabatic? The answer to the question is the self-acceleration occurs at the expense of the internal heat energy of the flowing fluid portion itself, wherein the initial velocity of the flowing fluid portion plays a role of a “trigger-catalyst” defining an intensity of the self-acceleration, namely, a higher velocity results in a greater self-acceleration. The answer shows that the phenomenon of convective self-acceleration is inevitable for fluid flowing around a body with relatively low velocities in an adiabatic process, i.e. upon conditions usually provided in the actual practice.

### Airfoil Wing

FIG. 1g is a prior art schematic drawing of a classic airfoil profile of an airplane wing 10 in a sagittal plane. The wing profile is recognizable by a rounded leading edge, a convex profile contour, having smoothly curved, elongated sides: more convex and lesser convex, and a sharp trailing end. A horizontal oncoming air stream 12 runs on the rounded leading edge and flows around wing 10, thereby being divided into two laminarly moving portions: upper air flux 14 and lower air flux 15, both stalling at the sharp trailing end. The axis 11 of wing 10 is defined as separating the upper and lower fluxes. Axis 11 of wing 10 and the horizontal direction of oncoming air stream 12 constitute a so-called “attack angle” 13. The more convex upper side provides a slippery surface, and the lesser convex lower side, exposed to oncoming air stream 12 with attack angle 13, and so subjected to an impact by lower air flux 15, has thereby more frictional-dragging surface. The Coanda-effect is defined as a tendency of a fluid jetstream to be attracted to and aligned with a nearby airfoil surface. The well-known lift-effect of an airplane wing 10 results from the non-symmetrical profile of wing 10 when the upper side is more convex. Firstly, a lift-force is defined by attack angle 13, which redirects the flowing wind. Secondly, when attack angle 13 is equal to zero, wing 10, having an ideally streamlined contour, provides that the sliding upper air flux 14 and the impacting lower air flux 15, both subjected to the Coanda-effect operation, meet behind wing 10. Sliding upper air flux 14 and impacting lower air flux 15, flowing around wing 10, incur changes in their cross-sectional areas and are accelerated convectively according to the mass conservation law. Considering relatively low velocities, the varying cross-sectional areas result in that the sliding upper air flux 14 runs faster than the impacting lower flux 15. According to Bernoulli's principle, this results in less so-called static pressure on wing 10 from sliding upper flux 14 than the static pressure from the impacting lower flux 15. If upper flux 14 and lower flux 15 flow around wing 10 laminarly, the difference of the static pressures is defined as ΔP=C_{d}ρu²/2, where ΔP is the static pressure difference defining the lift-force, in particular, when attack angle 13 is equal to zero, C_{d} is the coefficient, depending on wing 10's non-symmetrical profile, ρ is the density of the air; and u is the velocity of the ambient airflow relative to wing 10. A wing, having an ideally-airfoil profile, provides for a gradual variation of the airflow static pressure along the profile's smoothly curved contour and, when flying with a certain velocity, results in a linear change of the airflow static pressure along the profile's smoothly curved contour, thereby satisfying a condition preventing an origination of turbulences. In practice, there are also turbulences and vortices of the fluxes, which are not shown here. The prevalent flows, turbulences and vortices result in a spatial distribution of the air static pressure, particularly, in a local static pressure reduction and local extensions of the flowing air. Consider an air portion flowing around wing 10, referring to the Clapeyron-Mendeleev law concerning a so-called hypothetical ideal gas state: P=ρR₀T/μ, where P is the gas static pressure, ρ is the gas density, T is the absolute temperature of the gas, μ is the gas molar mass, and R₀ is the universal gas constant. One could apply rough and more exact explanations for changes in the gas state parameters of the air portion flowing around wing 10.

Roughly, for relatively slow wind, if considering the flowing air as substantially incompressible gas, Gay-Lussac's law for an isochoric process interrelates the static pressure P and absolute temperature T by the equation ΔP/P=ΔT/T, i.e. the reducing static pressure is accompanied by the decreasing absolute temperature.

More exactly, for the wind at slow speeds as well as at higher speeds running, in general, at a non-zero attack angle 13, the air, being compressible-expandable as an ideal gas, flowing around wing 10, performs work W for the air portion volume extension, wherein the volume extension process is substantially adiabatic. The adiabatic extension results in a change of the portion of gas internal energy, accompanied by a static pressure reduction and temperature decrease. The work W performed by the wind portion of 1 mole flowing around wing 10 for the adiabatic process is defined as: W=C_{V}ΔTₐ, where C_{V} is the molar heat capacity for an isochoric process, and ΔTₐ is the adiabatic temperature decrease of the considered air portion. The value of the adiabatic temperature decrease ΔT=T₂−T₁ is bonded with static pressure reduction by the relation: T₂/T₁=(P₂/P₁)^{(j-1)/j}, where P₁ and P₂ are the static pressures of the subject air portion before and after the adiabatic process correspondingly, and j is the adiabatic compressibility-constant, which is defined by molecular structure of gas, wherein the value j=7/5 is a good approximation for natural air as consisting dominantly of diatomic molecules. So, considering relatively low velocities, the Coanda-effect, occurring upon the convex side of wing 10, is accompanied by a kind of jet-effect, i.e. is accompanied by an observed acceleration of a wind portion and by the wind portion's static pressure and temperature decrease.

For the purposes of the present patent application, to emphasize the jet-effect nature of the Coanda-effect, the term “Coanda-jet-effect” is a so applied as equivalent to the commonly known term “Coanda-effect”.

A well-known phenomenon of upper flux 14 adiabatic cooling at low-subsonic velocities is observed. Natural air is humid, and the local cooling, accompanied by the pressure reduction, acts, in particular, as a water condensation trigger. If the wind flows around a wing with an M-velocity equal to or higher than the Mach number (i.e. the speed of sound), a well-known phenomenon of shock sound-wave emission takes place. This shock wave is not caused by wing vibration, but arises at the expense of the internal heat energy of air, and so is accompanied by the air temperature shock decrease, provoking the process of vapor condensation into water-aerosols.

FIG. 1h is a prior art schematic drawing of considerable amounts of water-vapor condense into water-aerosols 16.1 and sublimate into micro-flakes-of-snow 16.2, which are observed behind the high-speed aircraft's 16 wings' nozzles. One could note that the effect occurs at flow speeds substantially lower than the Mach number, i.e. it is not triggered by the mentioned phenomenon of shock sound-wave emission. This phenomenon explanation cannot be derived from the classical equations of fluid motion, predicting the extra-decrease of static pressure and temperature at transonic and supersonic velocities only. On the other hand, air-fluxes, which flow nearby around a body, become warmer and extra-warmed, when the body flies in air-environment with transonic, supersonic, and/or hypersonic velocities. A correct prediction of thermodynamic effects occurred in fluid flowing around a wing, would provide an improved design of the wing-shape to control and optimize the lift-effect.

There is therefore a need in the art for a method and apparatus to provide a correct optimal design of the wing shape to reach the most efficient and controlled lift-effect.

### Point of Sail

The term “point of sail” is used to describe a sailing boat orientation with respect to a prevalent direction of the ambient wind.

Prior art FIG. 1i is a schematic illustration of points of sail. A sailboat exposed to ambient wind 18.0 in positions and orientations: 18.1, 18.3, 18.5, 18.6, 18.7, 18.9, 18.11, and 18.12 with respect to the prevalent direction of ambient wind 18.0 is shown schematically. The positions and orientations of the sailboat, i.e. the points of sail, are classified by groups, indicated by symbols “ [symbol] ”, “ [symbol] ”, “ [symbol] ”, “ [symbol] ”, and “ [symbol] ”. Group “ [symbol] ” is so-called “in irons” (into the wind) or “no-go zone”, group “ [symbol] ” is so-called “close-hauled”, group “ [symbol] ” is so-called “beam reach”, group “ [symbol] ” is so-called “broad reach”, and group “ [symbol] ” is so-called “running”.

A sailboat is a well-known example, showing that a passive sail, playing a role of a trivial nozzle, enables to move the sailboat at least partially in the upstream direction against ambient wind 18.0, for instance along a zigzag path. In other words, in fact, the passive sail exposed to ambient wind 18.0 produces “a net thrust” against ambient wind 18.0. Shaded sector 18.2 corresponds to the “no-go zone”, where the single passive sail, being in position and orientation 18.12 belonging to point of sail group “ [symbol] ”, does not provide a net thrust in the upstream direction against ambient wind 18.0.

Point of sail “ [symbol] ”, having the sailboat position and orientation 18.1, is shown also in enlarged view 18. Streamlines 18.13 show a windward wind flow aligned with the concave side of sail; streamlines 18.14 show a leeward wind flow subjected to the Coanda-effect and so moving along a curved trajectory adjoining the convex side of sail; a multiplicity of arrows 18.15 indicate “lift-forces”, in this case, directed horizontally, caused by the difference between static pressures at the concave and convex sides of sail; and arrow 18.16 indicates a portion of wind accelerated convectively, i.e. at the expense of the internal heat energy of wind. The convectively accelerated wind portion 18.16 acts on the sailboat by reactive force 18.17 according to Newton's Third Law. Reactive force 18.17 is vectored in the upstream direction. While lift-forces 18.15 become compensated dominantly by a stabilizing reaction of the sailboat's keel, which is not shown here, the reactive force 18.17 defines the sailboat headway motion primarily.

The effect of net thrust against ambient wind is a kind of jet-effect; i.e. it is the effect of convective acceleration of a wind portion flowing along a curved trajectory adjoining the convex side of passive sail due to the Coanda-jet-effect, and in turn, the accelerated wind portion causes the net thrust, according to Newton's Third Law.

In view of the foregoing description referring to prior art FIG. 1i, it will be evident to a person skilled in the art that two sailboats, both having point of sail “ [symbol] ”, wherein one of the sailboats has position and orientation 18.1 and the other sailboat has position and orientation 18.11, when connected and consolidated together and thereby aggregated as a whole, provide a condition for a resultant net thrust applied to the aggregation, directed straight against ambient wind 18.0.

In spite of the fact that the effect of net thrust against the ambient wind is widely used in cruising on water, the effect remains unused in the world industry.

There is, therefore, a need in the art for a method and apparatus to provide a proper analysis and optimal design of a system, implementing the kind of jet-effect providing the net thrust in the upstream direction, for a controllable use in industry.

### Flying Large Bird

For the purposes of the present patent application, the inventor points out to a flying relatively large bird, to take note that the jet-effect is not so exotic, to emphasize the jet-effect potential efficiency, and to make clear that the Coanda-jet-effect is one of the primary and quintessential aspects of the present patent application. For a comparison, a flying relatively large bird, for instance, a golden-eagle, and a running cheetah, both overcome the air drag and support the upward and downward mobility (wherein the cheetah's vertical mobility is defined by a ground relief and small jumps of the cheetah's center of mass only). For simplicity of the comparison, ignore the sidelong (leftward and rightward) mobility. The flying golden-eagle, pushing off gaseous air (take note, the “pushing off” is not intensively-frequent), overcomes the air drag and supports the upward and downward mobility much easier and moves in the horizontal direction much faster, than the running cheetah pushing off a solid surface, wherein pushing off substantially more intensive-frequently. At the first glance, this fact looks as mystery and confusing-paradoxical. However, it becomes easily-explainable, if not to ignore the triggered Coanda-jet-effect as for the lift-force as well as for the forward motion acceleration (analogously as the net thrust in the aforementioned example with the sailboat described with the reference to FIG. 1i). In spite of the fact, that the efficiency of net thrust of the flying large bird is attractively high, the phenomenon remains unused in the world industry.

Furthermore, a style of a flock of cranes flying is well-known. This style prompts that there are no turbulent vortices behind wings of the flying cranes. In spite of the fact that the cranes apply the cascaded multi-stage repeating and thereby reinforcing the Coanda-jet-effect for originating both: the lift-force and the net thrust during a long time, this technique remains unused in the world industry.

There is, therefore, a need in the art for a method and apparatus to provide a proper analysis and optimal design of a system implementing the repeatedly reinforced Coanda-jet-effect providing the scalable and controllable use of the acquired power in the industry.

In view of the foregoing description of subparagraph Phenomenon of Convective Self-Acceleration with the reference to prior art FIG. 1f, subparagraph “Airfoil Wing” with the reference to prior art FIG. 1g, and subparagraphs “Point of Sail” and “Flying Large Bird”, both with the reference to prior art FIG. 1i, it will be evident to a person skilled in the art that:
Regarding the well-known “ground-effect”, in contrast to the well-known effect of proportional interrelation between the lift-force and drag-force predicted for alone classic wing flying in a free space, the “ground-effect”, at the first glance characterized by a confusingly-paradoxical interrelation between the lift-force and drag-force, namely, by the increased lift-force and decreased aerodynamic drag, becomes explainable if one takes into account that, when the classic wing is moving above and nearby a flat surface of ground, a boosting of the Coanda-jet-effect upon the convex upper surface of the wing is expected, and, as a result, the additional lift-force in the vertical direction and the additional net thrust in the horizontal direction, both are acquired due to the Coanda-jet-effect boosting; wherein the seemingly aerodynamic drag reduction, actually, is the additional net thrust acquired due to the boosted Coanda-jet-effect; and
Regarding the well-known Gray's paradox in relation to a dolphin high-speed swimming, saying that, considering the water viscous resistance and the dolphin's potential muscle power, the dolphin swimming with the velocity ten times higher than expected is confusingly-paradoxical, the Gray's paradox becomes solvable if, in addition to the dolphin muscle power, one takes into account:
   the dolphin epidermis hydrophobicity resulting in a reduction of the viscous skin-friction, and especially
   the net thrust originated due to the Coanda-jet-effect (i.e. at the expense of the ambient water warmth) which becomes triggered when the dolphin headway motion is accompanied by the dolphin's body waving.
      The inventor points out that the mentioned tenfold increase in velocity corresponds to the increase in power by the factor of 1000. This says that the combination of hydrophobicity and shaping of a body may become the primary-decisive mechanism of motion that will be shown hereinafter in the description referring to FIGS. 5c, 5d, 5f, 5g, 5h, 5i, 5j, and 5k.

### Tornado as a Kind of Jet-Effect

The inventor points out to the fact that a source of the natural tornado is two meeting relatively slow winds, resulting in that an arisen weak vortex is gradually transforming into a strong tornado. As well, the inventor takes note that the tornado brings rain, i.e. it condenses airborne vapors into water-aerosols and further into drops of rain. I.e. the tornado reduces the temperature down to the dew-point temperature even in a warm day. In other terms, the tornado, as an open thermodynamic system, decreases its entropy as well. This is an additional example, wherein the temperature of air is transformed into the kinetic energy of airflow. Hence, the natural tornado self-acceleration is a kind of the jet-effect. In spite of the fact, that the efficiency of the tornado jet-effect is attractively high, the phenomenon remains unused in the world industry.

Further, the inventor points out that the well-known Great Red Spot of Jupiter is a stabilized tornado having portions of gas having the static pressure of about 100 kPa and rotating with the velocity of about 180 m/sec. Looking forward, in view of the description referring to FIG. 9e of the invention, it will be evident to a person studied the invention, that an artificially or naturally created tornado becomes stabilized when the effective velocity of a dominant portion of rotating gas is reaching the specific M-velocity, depending on the effective adiabatic compressibility parameter of the gas.

There is, therefore, a need in the art for a method and apparatus to provide a proper analysis and optimal design of a system implementing the tornado jet-effect providing the scalable and controllable use of the acquired power in the industry.

### Betz's Law Applicability and Confusing-Paradoxical Approach

Betz's law, derived in frames of the continuum mechanics, is declared as applicable to a hypothetical incompressible fluid stream undergoing an isothermal process and indicates the maximum power that can be extracted from wind, considered as such a fluid stream. The maximum power is independent of the design of a wind turbine in open flow. The law is derived from the principles of conservation of mass and momentum of the fluid stream flowing through an idealized “actuator disk”, that can be imagined as effective cross-section covered by blades of the rotor, that extracts kinetic-power from the wind stream. According to Betz's law, no turbine can capture more than 16/27 (59.3%) of the kinetic-power in wind. The factor 16/27 (0.593) is known as Betz's coefficient.

One explains the Betz approach as follows. Consider that if all of the kinetic energy coming from the wind moving through a turbine's effective cross-section was extracted as useful energy the wind speed afterward would drop to zero. If the wind stopped moving at the exit of the turbine's effective cross-section, then no more fresh wind could get in—it would be blocked. In order to keep the wind moving through the turbine's effective cross-section, there has to be some wind movement, however small, on the other side with a wind speed greater than zero. Betz's law shows that as the fluid flows through a certain area, and when it slows from losing the kinetic energy to extraction from a turbine, it must spread out to a wider area.

The mass conservation law and the energy conservation law, both applied to the hypothetical case of incompressible fluid stream undergoing an isothermal process, limit any turbine efficiency to 59.3%. The Betz limit has no dependence on the geometry of the wind extraction system; therefore, the cross-sectional area of the rotor may take any form, providing that the flow travels from the entrance to the exit and wherein the control volume has uniform entry and exit velocities. Any extraneous effects can only decrease the performance of the system (usually a turbine) since this analysis was idealized to disregard friction. Any non-ideal effects would detract from the energy available in the incoming fluid, lowering the overall efficiency.

To analyze an applicability of the Betz law in practice, reference is now made to prior art FIG. 1k, a schematic illustration of a wind turbine 17.1 built-in into cylinder 17.2 having real sidewalls and open butt-ends. A constant cross-sectional area 17.3 is equal to the effective cross-sectional area covered by rotor's blades and equals A₄₁. Cylinder 17.2 is exposed to ambient fluid stream, which, when yet to be subjected to the influence of cylinder 17.2 supplied by wind turbine 17.1, has density ρ₄₀ and velocity u₄₀. When portion 17.40 of the fluid stream becomes subjected to a substantial influence of cylinder 17.2 supplied by wind turbine 17.1, it is considered as composed of sub-portions 17.41 and 17.42. Sub-portion 17.41 of the fluid stream enters cylinder 17.2 with a certain headway-motion velocity, indicated by u₄₁. Sub-portion 17.42 of the ambient fluid stream has a cross-sectional area, indicated by A₄₂, equal to the difference between cross-sectional area 17.6 and cross-sectional area 17.3, and flows outside cylinder 17.2 with headway-motion velocity, indicated by u₄₂. As the condition of mass conservation must be satisfied, then ρ₄₀(A₄₁+A₄₂)u₄₀=ρ₄₁A₄₁u₄₁+ρ₄₂A₄₂u₄₂, where P₄₁ and P₄₂ are densities of sub-portions 17.41 and 17.42, correspondingly. One expects that:
according to the mass conservation law, sub-portion 17.51 of the fluid stream outflows from cylinder 17.2 with the headway-motion velocity u₅₁, which is equal to the headway-motion velocity u₄₁ of entering sub-portion 17.41, while the fluid stream density change is negligible;
blades of wind turbine 17.1, being subjected to the stream action, are forcedly rotating and thereby generating an electrical power; and moreover,
outflowing sub-portion 17.51 gets also a certain rotational component of motion. I.e. the resulting kinetic energy of the outflowing sub-portion 17.51 becomes increased with respect to the kinetic energy of entering sub-portion 17.41, wherein, the kinetic energy increase is defined by a value proportional to the second power of the acquired rotational component of velocity.
   This intuitive expectation is paradoxical from the point of view of the Betz approach because one expects to harvest electrical power and observe accelerated or at least not retarded outflowing sub-portion 17.51 of the fluid stream simultaneously.

Some inventors have made claims of exceeding the Betz limit by using nozzles. Some examiners interpret it as misrepresenting the Betz limit by calculating only the area, covered by the rotor blades, and not the total input of air contributing to the wind energy extracted from the system. In other words, the idealized “actuator disk” is interpreted as wider than the cross-section, covered by the rotor blades; and the electrical power, produced by wind turbine 17.1, is harvested at the expense of the kinetic-power of fluid stream portion 17.40 as a whole.

Again, referring to prior art FIG. 1k, consider a hypothetically ideal wind turbine 17.1 exposed to an ambient fluid stream, having oncoming portion 17.40, wherein now, in general, cylinder 17.2 is either real or imaginary, i.e. sub-portions 17.41 and 17.51 may differ in velocity. For simplicity and without loss of reasoning, assume that outflowing sub-portion 17.51 does not get a rotational component of motion in the ideal case. The kinetic-power of fluid stream portion 17.50 as a whole, which being subjected to the influence of wind turbine 17.1, equals

$$( {W}_{51} + {W}_{52} ) = \frac{{ρ}_{51} {A}_{51} {u}_{51}^{3}}{2} + \frac{{ρ}_{52} {A}_{52} {u}_{52}^{3}}{2} ,$$

where indexes “51” and “52” indicate sub-portions 17.51 and 17.52 correspondingly, W₅₁ and W₅₂ are kinetic-powers, u₅₁ and u₅₂ are effective velocities, ρ₅₁ and ρ₅₂ are effective densities, and A₅₁ and A₅₂ are cross-sectional areas. The kinetic-power of fluid stream portion 17.40 as a whole, which being uniform and yet to be subjected to the influence of wind turbine 17.1, indicated by W₄₀, equals

$${W}_{40} = \frac{{ρ}_{40} ( {A}_{51} + {A}_{52} ) {u}_{40}^{3}}{2} ,$$

wherein u₄₀ and ρ₄₀ are correspondingly velocity and density of portion 17.40 as a whole. The velocity u₄₀ can be expressed via the effective velocities u₅₁ and u₅₂ in accordance with the mass conservation law as:

$${u}_{40} = \frac{{ρ}_{51} {A}_{51} {u}_{51} + {ρ}_{52} {A}_{52} {u}_{52}}{{ρ}_{40} ( {A}_{51} + {A}_{52} )} .$$

Comparing the kinetic-power of fluid stream portion 17.50 as a whole, equal to (W₅₁+W₅₂), with the kinetic-power of fluid stream portion 17.40 as a whole, equal to W₄₀, and, taking into account that the Betz approach assumes a hypothetically incompressible fluid i.e. ρ₄₀=ρ₅₁=ρ₅₂, one can derive that the kinetic-power difference (W₅₁+W₅₂)−W₄₀ is always a positive value. For instance, considering the case when the condition A₅₁=A₅₂ is satisfied, the difference is expressed as

$$( {W}_{51} + {W}_{52} ) - {W}_{40} = \frac{3 {ρ}_{40} {A}_{51}}{8} ( {u}_{51} + {u}_{52} ) {( {u}_{51} - {u}_{52} )}^{2} .$$

The positive value on the right side of the equation says that the kinetic-power of flow portion 17.50 subjected to the influence of wind turbine 17.1 is increased with respect to the kinetic-power of flow portion 17.40 yet to be subjected to the influence of wind turbine 17.1. This result is confusing-paradoxical from the point of view of the Betz approach, assuming that the electrical power produced by wind turbine 17.1 is harvested from (i.e. by reducing) the kinetic-power of fluid stream portion 17.40 as a whole. Therefore, the Betz approach is not suitable to describe this case as well.

Thereby, the approach, based on the interpretation of airflow or streaming water as a hypothetically incompressible fluid stream undergoing an isothermal process and wherein the control volume has uniform entry and exit velocities to apply Betz's law, is not adequate sufficiently and sometimes loses a practical sense.

There is therefore a need in the art for a method to provide a proper analysis of an aerodynamic system comprising a wind turbine, thereby allowing for an optimal design of an apparatus for stream energy use.

### Vortex Tube

Prior art FIG. 1l is a schematic illustration of a well-known “vortex tube” also known as the Ranque-Hilsch vortex tube. It is a mechanical device 190 that separates a compressed gas 19.0 into hot 19.1 and cold 19.2 streams. It has no moving parts. Pressurized gas 19.0 is injected tangentially into a swirl chamber 19.3 and accelerates to a high rate of rotation. Due to a conical nozzle 19.4 at the end of the tube 19.5, only the outer shell of the rotated gas 316 is allowed to escape at the butt-end outlet 19.7. As a result, this portion 19.1 of the gas is found to have been heated. The remainder of gas 19.6, which performs an inner vortex of reduced diameter within the outer vortex, is forced to exit through another outlet 19.8. As a result, this portion 19.2 of the gas is found to have been cooled. In an exemplary application, if the entering air is compressed to 6.9 bars at 21° C., the hot stream may be of 76° C. and the cool stream may be of −34° C. There are different explanations for the effect and there is a debate on which explanation is best or correct. However, the absence of a strong theory of the phenomenon makes it difficult to design an optimal shape of the vortex tube to reach a substantially more effective use of the phenomenon.

There is therefore a need in the art for a method and apparatus to provide a correct optimal design of the vortex-tube inner shape to reach the most efficient cooling flows.

### Phenomenon of Hydrophobicity and the Beverley Clock

Hydrophobicity is the physical property of a matter, frequently called a hydrophobic matter. The hydrophobic matter is composed of molecules which are seemingly repelled from a mass of water; and vice-versa, molecules of water are seemingly repelled from a mass of the hydrophobic matter. The reason for hydrophobic interaction is the large energy of the hydrogen bond [attraction] between water molecules, superior the energy of the interaction between the water molecules and molecules of the hydrophobic matter. Strictly speaking, there is no repulsive force involved; it is a lack of attraction between the inter-contacting water and hydrophobic matter. (In contrast, molecules of a so-called hydrophilic matter are attracted to water.)

If the hydrophobic matter and water, both are in the liquid state, the inter-repelling results in separating the hydrophobic matter and water by a boundary. On the one hand, the boundary is a hydrophobic surface repelling the water, and, on the other hand, the boundary is a water surface repelling the hydrophobic matter.

Reference is now made to FIG. 1m, a prior art schematic illustration of construction 15.0 representing the core mechanism of the well-known Beverley Clock, running, in principle, non-stop since 1864, despite never having been manually wound up. Construction 15.0 comprises tank 15.1 filled with water 15.2 and liquid hydrophobic oil 15.3. Because construction 15.0 is in the gravitational field of Earth and the density of liquid hydrophobic oil 15.3 is lower than the density of water 15.2, separating boundary 15.4 is horizontal and liquid hydrophobic oil 15.3 is above the separating horizontal boundary 15.4. Sinker 15.5 is floating nearby separating boundary 15.4 between hydrophobic oil 15.3 and water 15.2. The inter-contacting water 15.2 and liquid hydrophobic oil 15.3 are inter-repelling, i.e. molecules of both: water 15.2 and liquid hydrophobic oil 15.3 become subjected to the repellent action of separating boundary 15.4. The action causes the molecules, adjacent to separating boundary 15.4, to have a tendency to vector their velocities, resulting in an asymmetrisation of degrees of freedom of the molecules Brownian motion that is observed as acceleration of the molecules in a prevalent direction: upwards for hydrophobic oil 15.3 and downwards for water 15.2, thereby compressing distant layers of the liquids. In turn, when the degrees of freedom of the molecules Brownian motion are destabilized and changed, other molecules, at the moment belonging to the distant layers of the liquids, get a tendency to refill the freed niche of the degrees of freedom, i.e. the other molecules get an opposite asymmetrisation of their degrees of freedom. Thus, the Brownian motion of molecules becomes partially transformed into a convective motion, i.e. the molecules convective motion occurs at the expense of the degrees of freedom of the Brownian motion, i.e. at the expense of the liquids warmth. Thereby, the originated convective motion, consuming caloric from the liquids warmth, can be interpreted as a kind of jet-effect. The convection (accompanied by cooling, and so by changes of densities of the water and oil, and by associated changes in the Archimedes forces) moves sinker 15.5. The upwards and downwards swinging motion of sinker 15.5 wounds up the clock-mechanism 15.6, i.e. sets the Beverly clock going, while the consumed caloric is continuously refilled from the ambient air warmth.

Analogously (but without the obligatory presence of gravitation in a certain direction and without a sinker), two inter-contacting inter-repelling fluids are used in a modern well-known Atmos clock, which does not need to be wound up manually as well. Namely, a construction of the Atmos clock core mechanism [not shown here] has a hermetic box comprising an easily-evaporating ethyl chloride, being in the mixed aggregate state: saturated-gaseous and liquid. The Van der Waals attraction forces are maximal for the liquid aggregate state, intermediate for the saturated-gaseous aggregate state, and minimal between the liquid and saturated gas. This provides that the saturated-gaseous and liquid aggregate states of ethyl chloride play roles of the two inter-contacting inter-repelling fluids. The inter-repelling destabilizes the mixed state resulting in convection motion, dominantly, of the saturated gas. The convection motion occurs at the expense of the ethyl chloride warmth that is observed as self-cooling of the ethyl chloride. Again, the convective motion, consuming caloric from the fluids warmth, can be interpreted as a kind of jet-effect. The tendency to the convecting gas self-cooling is accompanied with a tendency to the convecting gas self-compression, according to the van der Waals law about the gas state. While the consumed caloric is continuously refilled from the ambient air warmth, the self-compression and decompression of gas set the Atmos clock going.

In view of the foregoing description of the Beverley Clock core mechanism (i.e. construction 15.0) referring to FIG. 1m, it will be evident to a person skilled in the art that the core mechanism comprises all the inherent attributes of a so-called heat-engine, open from the thermodynamics point of view, namely:
the liquid hydrophobic oil and water (when considered as matters exposed to ambient warmth either substantially-constant or varying), both playing the role of an inherent absorber of warmth from the ambient air;
the hydrophobic surface, repelling nearby molecules, i.e. triggering the jet-effect, i.e. triggering the convection motion, accompanied by cooling, and thereby, playing the role of an inherent so-called “cold silk”;
the moving sinker playing the role of an inherent so-called working body, wherein the sinker's motion is a result of the convective motion, accompanied by cooling, by changes of densities of water and oil, and by associated changes in the Archimedes forces; and
in the final analysis, the clock-mechanism, playing the role of an outer object consuming power to perform a useful work; wherein the energy acquired by the sinker (as working body) is further divided between the sinker swinging and the clock-mechanism wounding up.

In view of the foregoing description of the Atmos Clock core mechanism, it will be evident to a person skilled in the art that the aforementioned hermetic box can be filled with any easily-evaporating matter being in the mixed aggregate state: liquid and gaseous. In principle, water can play the role of such a matter.

In spite of the fact that the effect of convection motion, in the final analysis, occurring at the expense of ambient warmth, is used for autosetting the clock going, the effect remains unused in an enlarged scale in the world industry.

There is, therefore, a need in the art for a method and apparatus to provide a proper analysis and optimal design of a system implementing the kind of jet-effect providing the motion due to the hydrophobicity for a scalable use in industry.

### Model Simplifications in the Continuum Mechanics

In order to describe both the Venturi effect and the de Laval effect, the flowing fluid is modeled in the classical fluid dynamics theory as hypothetically consisting of many small volume portions. This approach is described in book “The Feynman Lectures on Physics”, volume 2, chapter 40 “Flow of Dry Water” by Richard P. Feynman, Robert B. Leighton, and Matthew Sands, where the term “dry water” is applied to stress the model simplifications, namely:
first, the assumption that there are no viscous forces between the fluid small volume portions;
second, the fluid small volume portions are connected spaces;
third, the fluid being studied is a continuum, i.e. it is infinitely divisible and not composed of particles such as atoms or molecules;
forth, the small volume portion boundaries are impermeable for the fluid matter and impenetrable for temperature; and
fifth, the assumption that the static pressure, acting on the small volume portions' boundaries and being the only reason of mechanical forces, is an abstraction having no molecular nature, and wherein the small portions' boundaries are hypothetically inert to the fluid's inter-molecular forces, i.e. are not phobic with repulsive forces and not sticking with attractive forces, as soon as the problem is formulated in frames of the continuum mechanics.
   In other words, the simplifications are inherent assumptions in the classical continuum mechanics theory, ignoring the molecular structure of fluid and ignoring the static pressure as a thermodynamic parameter interrelated with the fluid density and temperature in accordance with the van der Waals law of the fluid state. In this approach, the classical equations of fluid motion are derived. In a particular case of hypothetically inviscid flow, the classical equations of fluid motion, known also as the Euler equations, are applied. For viscous flow, to overcome said first simplification, the Navier-Stokes equations are used. The Navier-Stokes equations are the Euler equations modified by involving into the consideration the viscous forces between the fluid small volume portions. Again, the viscous forces are introduced irrelative to the viscosity effect physical nature. In 2000, the problem of the Navier-Stokes equation solution existence and smoothness became one of the Millennium Goals formulated by the Clay Mathematics Institute. It is noted in the “The Feynman Lectures on Physics” cited above, that even in the simplest case of no moving fluid, the equation of hydrostatics: −∇P−ρ∇φ=0, where ∇ is vector differential operator, P is the fluid static pressure, ρ is the fluid density, and φ is the stand for the potential-energy-per-unit-mass (for gravity, for instance, φ is just gz, where g is the gravitational acceleration and z is the height above the Earth's ocean surface level), in general, has no solution, as soon as both: the pressure P and the density ρ are spatially dependent and not interrelated in the mentioned simplified approach of the continuum mechanics theory. To facilitate a numerical analysis in practice and to overcome said second simplification, the Navier-Stokes equation further modifications (for example, the Spalart-Allmaras hypothetical model of turbulences), assuming that the chosen fluid portions could be dismembered into smaller connected spaces, are applied to computational fluid dynamics. However, the third, fourth and fifth simplifications remain inexact, making that the fluid model loses physical sense for thermodynamic and kinetic theory of matter and, as a result, the classical fluid model, on the one hand, has not exact solutions for compressible fluids, and on the other hand, leads to paradoxical solutions for incompressible and inviscid fluids. For example, the d'Alembert paradox, derived from the Euler equations, in particular, says that a body, moving in an incompressible fluid, does not experience a drag force as an impact effect. Describing this paradox, for example, “Encyclopedia of Fluid Mechanics” by J. D. Jacob, Department of Mechanical Engineering, University of Kentucky, Lexington, Ky. 40506-0108, comments that “in the 18^{th} century, it was at odds with both observation and intuition of flow about a body in motion”, and further defines the term “drag” as primarily related to a viscosity phenomenon, neglecting by the impact effect. The Navier-Stokes equation having introduced viscous forces makes the d'Alembert paradox as latent. To provide the principles of thermodynamics, one adds equations of gas laws to the Euler system of equations and further approximates the equations numerically.

There is therefore a need in the art for a method to provide a proper model of fluid motion to exclude paradoxical results and the paradoxical nonexistence of an exact solution relating thermodynamic parameters and velocity of fluid-flow.

One usually explains the Venturi effect by Bernoulli's principle, applied to a hypothetical incompressible fluid streaming within a pipe, having free-slip inner walls. In this case, Bernoulli's principle can be written in the following form:

$${ρ}_{c} \frac{{u}_{c}^{2}}{2} + {P}_{c} + {G}_{c} = {P}_{0} = Const , \qquad Eq . ( 1 a )$$

where, considering the fluid unit volume portion moving through a certain cross-section marked by index “c”, u_{c} is the fluid portion velocity that is inversely-proportional to the fluid portion's associated cross-sectional area A_{c}, P_{c} is the static pressure on the fluid portion's boundaries, ρ_{c} is the fluid portion density assumed to be identical for any cross-section, and G_{c} is the fluid unit volume portion potential energy stored in the gravitational field of the Earth. The potential energy G_{c} near the Earth ground can be well-approximated by z_{c}ρ_{c}g, where z_{c} is the effective height of the fluid portion above the Earth's ocean surface level, g is the is the gravitational acceleration near the Earth's ocean surface level, and P₀ is the stagnation pressure. P₀ is also called either the total pressure or the flow head, and it remains constant along the fluid motion direction.

To describe the de Laval effect phenomenon, the Euler equations are used as references to derive the differential equation:

$$\frac{dA}{A} = ( {M}^{2} - 1 ) \frac{du}{u} , \qquad Eq . ( 1 b )$$

where A is the flow cross-section area, u is the flow velocity corresponding to the cross-section area, and M is the flow M-velocity, i.e. the velocity measured in Mach numbers. As the speed of sound in a fluid depends on the fluid temperature, so the value M is temperature dependent. Equation (1b) says that if the flow is relatively slow (i.e. M<1), then the narrowing of the flow cross-section (i.e. negative dA) corresponds to acceleration of the flow (i.e. positive du); and if the flow is relatively fast (i.e. M>1), then the widening of the flow cross-section (i.e. positive dA) corresponds to acceleration of the flow (i.e. positive du). Computational fluid dynamics using the classical Euler equations provide numerical solutions for spatial distributions of the fluid velocity, static pressure, and temperature within the de Laval nozzle. The distributions are illustrated schematically in FIG. 1c. In FIG. 1c the fluid flow M-velocity 150 at the critical condition point 180 is given by M=1. On the one hand, equation (1b) says that utilizing a pipe having no a divergent part, the flow cannot be accelerated up to velocities higher than the velocity of sound, i.e. up to M>1. On the other hand, equation (1b) allows for the acceleration of the fluid flow in a converging nozzle up to the velocity of sound, i.e. M≦1.

In practice, firstly, the de Laval effect occurs on M-velocities substantially lower than M=1; and secondly, utilizing a pipe having no a divergent part, airflow cannot be accelerated up to velocities higher than approximately only half of the velocity of sound in the air. Thus, the two mentioned equations (1a) and (1b), derived from the mentioned approach, which assumes that the fluid consists of many small volume portions having neither permeable boundaries nor molecular structure, have certain restrictions of applicability.

To design a shape of a convergent-divergent jet-nozzle one applies the following equation:

$$\frac{A}{{A}_{*}} = {\frac{1}{M} [ \frac{1 + \frac{j - 1}{2} {M}^{2}}{1 + \frac{j - 1}{2}} ]}^{\frac{j + 1}{2 ( j - 1 )}} , \qquad Eq . ( 1 )$$

derived basing on equation (1b), where A_{*} is the minimal cross-sectional area at the critical condition point 180, and j is the gas adiabatic compressibility-constant.

To design a rocket jet-nozzle for fluid portion acceleration from slow speeds to high-subsonic speeds, and even up to speeds higher than the speed of sound, some designers use modern software for computational fluid dynamics analysis where the two equations: (1a) for the slow flow and (1b) for the fast flow, are programmed accordingly. The fact, that the two equations have restrictions of applicability at least because the equations allow for different ranges of the flow velocity, makes the analysis inappropriate to simulate the expected jet-effect properly. As a result, sometimes users are not satisfied by calculated solutions because the algorithm “may experience robustness problems for slightly compressible fluids”, as commented in the software help document: “CFX_PRE” Release 14.5-214 of ANSYS, Inc. and its subsidiaries and affiliates, Page 215, Lines 6-7.

Moreover, for a case of “slightly compressible” slow-flowing gas, the software help document recommends using “the Incompressible option” (“CFX_PRE”, Page 215, Line 7). However, a use of the Incompressible option for a slow-flowing gas, for which the static pressure re-distribution is allowed, is paradoxical, because an adiabatic process is described by the equation Pv^{j}=Const, where P is the gas portion's static pressure, v is the gas portion volume, and j is the gas adiabatic compressibility-constant, and so a relative change of the gas portion volume is of the same order of value as a relative change of the static pressure, namely,

$$\frac{dv}{v} = - \frac{1}{j} \frac{dP}{P} .$$

There is therefore a need in the art for a method and apparatus to provide a proper analysis and optimal design of the convergent-divergent jet-nozzle shape to reach the most efficient jet-effect.

Furthermore, to formalize the viscous forces influence, the Navier-Stokes equation of fluid motion is expressed via a tensor of viscosity coefficients characterizing the fluid. This formalization of fluid flowing around a body using such a tensor of viscosity coefficients is not completely adequate at least because:
the viscous forces influence is dependent on material of the body submerged in the flowing fluid (for instance, a hydrophobic or hydrophilic body submerged in moving water); and
the viscosity coefficients should be functions of the spatially distributed temperature of flow as the flow temperature is interrelated with the spatially distributed static pressure of flow, which, in turn, is interrelated with the spatially distributed velocity of flow.

There is therefore a need in the art for a proper equation of fluid motion, generalized in the frames of the kinetic theory of matter, taking into account kinds of the jet-effect (for instance, the Coanda-jet-effect and the phenomenon of hydrophobicity), and so adequately applicable to any flowing fluid and any material of a body submerged in the flowing fluid, for instance, to moving water flowing around a hydrophobic body.

### Bernoulli Theorem

In contrast to a popular description of Bernoulli's principle as a simplification of the Euler equation of momentum conservation originally allowed for an inviscid flow and further applied to an exclusively-incompressible fluid, as made, for example, in the “Encyclopedia of Fluid Mechanics” by J. D. Jacob cited above, “The Feynman Lectures on Physics”, also cited above, demonstrates the Bernoulli theorem proof basing on general assumptions thereby showing the Bernoulli theorem widened sense.

For the purposes of the present patent application, in contrast to the term “Bernoulli's principle”, applied to describe a hypothetical particular case of the Euler equations, the term “Bernoulli theorem” is applied to the proven interrelation of flow characteristics.

Prior art FIG. 2 is a schematic illustration of stationary fluid flow streamlines 20 forming walls 24 of an imaginary pipe. Consider a fragment 23 of the imaginary pipe that has open ends: inlet 21 and outlet 22. The imaginary pipe walls 24 by definition are impermeable, as soon as they are formed by streamlines 20; and the shape of walls 24 is not restricted regarding constriction or stretching. The fluid may be compressible-expandable and viscous as a real fluid; and, one assumes for simplicity that the fluid matter is subjected to neither chemical reactions nor phase changes within the pipe fragment 23. Inlet 21 area is A₁, where the fluid has inner-static-pressure P₁, density ρ₁, and velocity u₁. The area of outlet 22 is A₂, where the fluid has inner-static-pressure P₂, density ρ₂, and velocity u₂. After a short-time interval τ, a portion of the fluid entering inlet 21 has mass m₁ calculated as m=ρ₁A₁u₁τ. A mass m₂ leaves the pipe fragment 23 through outlet 22, i.e. m₂=ρ₂A₂u₂τ.

The law of flow mass conservation requires that m₁=m₂=m, thereby,

m=ρ₁A₁u₁τ=ρ₂A₂u₂τ Eq. (2a).

The equation of continuity, namely: ρ₁A₁u₁=ρ₂A₂u₂, follows from (2a).

Note that the entering mass has the gravitational potential energy, that near the ground of the Earth can be well-approximated by G₁=z₁ mg; while this mass leaving the pipe fragment 23 has the gravitational potential energy G₂=z₂mg, where z₁ and z₂ are correspondingly inlet 21 and outlet 22 cross-sections' effective heights above the Earth's ocean surface level.

On the other hand, one can calculate work, done by the fluid flow static pressure. The work at inlet 21 equals dW₁=P₁A₁u₁τ, meaning that the flow mass acquires the energy portion dW₁; and the work at outlet 22 equals dW₂=P₂A₂u₂τ, meaning that the flow mass losses the energy portion dW₂.

Add the work d_{W} to the potential and kinetic energies of the mass portion at inlet 21 in order to define the total energy of the entered mass portion, namely:

E₁=dW₁+G₁+mu₁²/2=P₁A₁u₁τ+z₁mg+mu₁²/2

Analogously, add the work dW₂ to the potential and kinetic energies of the mass portion at outlet 22 in order to define the total energy of the mass leaving portion, namely:

E₂=dW₂+G₂+mu₂²/2=P₂A₂u₂τ+z₂mg+mu₂²/2

Considering an adiabatic process, i.e. conservation of the total energy in the pipe fragment 23, one applies the energy conservation law requiring that the entering energy E₁ must be equal to the leaving energy E₂, i.e.

$${P}_{1} {A}_{1} {u}_{1} τ + {z}_{1} m g + m \frac{{u}_{1}^{2}}{2} = {P}_{2} {A}_{2} {u}_{2} τ + {z}_{2} m g + m \frac{{u}_{2}^{2}}{2} \qquad Eq . ( 2 b )$$

Dividing the components of the equation (2b) on the value of mass m defined in equation (2a), one obtains the following equation:

$$\frac{{P}_{1}}{{ρ}_{1}} + {z}_{1} g + \frac{{u}_{1}^{2}}{2} = \frac{{P}_{2}}{{ρ}_{2}} + {z}_{2} g + \frac{{u}_{2}^{2}}{2} , \qquad Eq . ( 2 c )$$

from which the well-known Bernoulli theorem formulation follows, namely: the value (Pᵢ/ρᵢ)+(zᵢg)+(uᵢ²/2) is constant along any streamline of a fluid flow, i.e.

$$\frac{{P}_{i}}{{ρ}_{i}} + {z}_{i} g + \frac{{u}_{i}^{2}}{2} = Const \qquad Eq . ( 2 )$$

The constant Const on the right side of equation (2) performs the total energy of the fluid portion unit mass moving along a streamline, wherein the items: Pᵢ/ρᵢ, zᵢg, and uᵢ²/2 define kinds of energy-per-unit-mass of the fluid portion, namely: Pᵢ/ρᵢ interrelates with the internal heat energy stored in molecular Brownian random motion and interactions, wherein, according to the kinetic theory of ideal gas, the ratio Pᵢ/ρᵢ is defined as proportional to the gas temperature, zᵢg defines the potential-energy-per-unit-mass stored in the Earth's gravitational field, and uᵢ²/2 defines the kinetic-energy-per-unit-mass. In hydrodynamics, one normally assumes that the liquid density ρ is not varying. In this hypothetical particular case, equation (2) can be rewritten in terms of pressure as: Pᵢ+ρzᵢg+ρuᵢ²/2=P₀, where P₀ is the total pressure or the flow head being constant along any streamline of the incompressible liquid, ρuᵢ²/2 is the partial dynamic pressure, P is the partial inner-static-pressure provided by the fluids molecules [note that the classical continuum mechanics theory, and in particular, the hydrodynamics does not refer to a molecular structure of matter], and ρzᵢg is the partial potential-static-pressure provided by the Earth's gravitational field.

Considering the ratio Pᵢ/ρᵢ as a measure of fluid's internal energy, the Bernoulli theorem proof is based on the laws of the energy conservation and matter continuity and has not especial demands on viscosity and compressibility-expandability of the considered fluid. The Bernoulli theorem proof is general and does not conflict with the thermodynamic and kinetic theory of fluid. Thus, the Bernoulli theorem, as a form of the energy conservation law, is applicable for any fluid that may be compressible-expandable and viscous as a real fluid. An important feature of the proof is the assumption that imaginary fragment 23 is a flow portion, but not a real pipe.

Prior art FIG. 3 shows a fragment of pipe 33, having real walls 34. When one ignores turbulences caused by walls 34 and the heat exchange between the walls and fluid, without loss of generality, fragment 23 of the imaginary pipe (FIG. 2) is built-in into real pipe 33. Nonetheless, real walls 34 being sticking for the fluid's molecules, causing, in general, an origination of turbulence and the heat exchange between the walls and fluid, such that the energy conservation, written as equation (2), becomes not perfectly exact; the Bernoulli theorem may play a role of a criterion of adequacy for the equation of fluid motion applied, in particular, to convergent-divergent jet-nozzle design and analysis as well as for a computational fluid dynamics numerical solution.

Equation (1a) is a particular case of the Bernoulli theorem applied to a hypothetical incompressible fluid flow. Also, only the particular case of the Bernoulli theorem applied to a hypothetical incompressible fluid flow can be derived from the Euler equations. In fact, the mentioned simplifications of continuum mechanics render the Euler and Navier-Stokes equations as having no exact solutions; and the Euler and Navier-Stokes equations numerical approximation, in the general case, conflicts with the Bernoulli theorem. Thus, the Euler and Navier-Stokes equations may be applicable to an ideal case, for which the effects of molecular interactions, at least such as diffusion and/or heat exchange between the fluid portions and/or the viscous fluid motion inherently accompanied by the diffusion, are negligible.

For the purposes of the present patent application, the term “Bernoulli theorem” is applied as more correct, to stress the proven interrelation expressed as equation (2), than the term “Bernoulli's principle”, assuming a hypothetical particular case of the Euler equations and expressed in the form of approximated equation (1a).

There is therefore a need in the art for a method and apparatus, corresponding to strongly proved criteria, applicable to slow as well as to fast flowing real compressible-expandable fluids, and providing a correct optimal design of the convergent-divergent jet-nozzle in order to reach the most efficient jet-effect.

### SUMMARY OF THE INVENTION

### Unit and Novelty of the Invention

Generally, the unity and the novelty of the invention are in a method providing for a specific shaping and covering of a body submerged in a moving fluid, wherein the specific shaping and covering enable an enhanced jet-effect.

More particularly, the unity and the novelty of the invention provide for the following.

The methodological unity of the present invention is in use of a novel method for computational fluid dynamics applied to a flowing fluid, composed of moving and interacting molecules, wherein, in contrast to the continuum mechanics approach, the fluid static pressure, temperature, density, and flow velocity are defined in terms of the kinetic theory of matter. The method provides for a numerical estimation of spatially distributed parameters: the three components of the velocity-vector, the temperature, the density, and the static pressure of the moving fluid; wherein, taking into the consideration a molecular structure of the fluid matter, the method allows for a designing of airfoil and, in particular, hydrophobic corpuses and corpuses comprising specifically shaped tunnels.

The phenomenological unity and novelty of the present invention is in a use of an enhanced jet-effect that is specified as an efficient transformation of the fluid internal heat energy, performed as kinetic energy of the molecules Brownian random motion, into the fluid jetstream kinetic energy, performed as kinetic energy of the molecules motion in a prevalent direction. The transformation is caused by the Coanda-jet-effect operation.

The implementation unity of the present invention is in the novel specific shaping of bodies submerged in the flowing fluid. Wherein, on the one hand, the mentioned properties of fluid matter contacting with the bodies' surfaces, and, on the other hand, the bodies' specific shapes defined and calculated according to the novel method, altogether are resulting in an enhanced jet-effect, observed as an effect of increased acceleration of a fluid portion at the expense of the fluid matter warmth. Namely, the specific shaping is such that the bodies' surfaces act on the flowing fluid portion according to the Coanda-jet-effect operation causing transformation of the fluid portion's internal heat energy into the fluid portion's additional acquired kinetic energy. In other words, the Coanda-effect operation transforms a part of the kinetic energy of the fluid molecules Brownian random motion [i.e. the heat energy], into the kinetic energy of the molecules motion in a prevalent direction [i.e. into the acquired kinetic energy of a jetstream]. In a more general case, when the fluid flow is turbulent, comprising whirling groups of molecules, the Coanda-effect operation results in partial aligning also of the turbulent motion of the whirling groups of molecules with the body's surfaces, that is observed as an increase of the effective velocity of the flow portion, accompanied by the portion's inner turbulence decrease, as the fluid portion passes nearby the body. Thus, this results in an increase of the fluid portion's kinetic energy also at the expense of the fluid portion's inner turbulent energy. In a case, wherein the fluid is water and the body's surface is hydrophobic, the water portions are subjected to an acceleration that can be utilized at least to reduce a skin-friction resistance; and in a case, wherein the fluid is a substantially compressible-expandable gas, such as air at high velocities, the specific shaping results in a convergent-divergent flowing, accompanied by an enhanced jet-effect, that can be utilized at least for an efficient harvesting of electricity using either a wind turbine, capable to transform mechanical motion of flow into electricity, and/or a Peltier element, capable to operate as a thermoelectric generator producing electricity from the temperature difference caused by the jet-effect.

### Primary Basic Features of the Present Invention

One of the primary features of the present invention is that, in contrast to the classical approach of continuum mechanics, the terms “fluid”, “flow velocity”, “temperature”, “static pressure”, and “density” are defined taking into the consideration a molecular structure of a substance according to the kinetic theory of matter. Namely, the term “fluid” is defined as a substance composed of moving and interacting molecules, the term “flow velocity” relates to a prevalent motion of molecules, the term “temperature” is defined by the molecules random motion as a measure proportional to the average molecular kinetic energy of the molecules Brownian random motion, the term “static pressure” is defined as a measure of the randomly moving molecules cumulative impact, and the term “density” is defined as a measure of the molecules concentration and mass, equal to said molecular fluid mass per unit volume.

Another primary feature of the present invention is that the specific M-velocity is defined as a characteristic of the molecular composition of the fluid.

Yet other one primary feature of the present invention is that an apparatus, shaped specifically, is defined as inherently submerged in a flowing fluid, having at least a specific so-called adiabatic compressibility parameter, and the definition of the specific shape of the apparatus's corpus is accompanied by the definition of the specific properties of the molecular fluid, altogether, allowing for an optimized implementation, in general, of the Coanda-effect, and, in particular, of the de Laval effect. Wherein the de Laval effect should be understood in a widened sense as comprising both: the de Laval jet-effect, defined as an effect of flow extra-acceleration, and the de Laval retarding-effect, defined as an effect of flow extra-slowing.

It is still a further feature of the present invention is that, in contrast to the classical approach of continuum mechanics, the terms “drag”, “skin-fiction”, “osmotic-like effect”, and “viscosity” are defined, referring to the kinetic theory of matter. Namely:
the drag is an effect of asymmetrical, disbalanced impact of molecules, observed when a shape of a fluid portion, flowing around a body corpus, is subjected to a deformation, such that the drag-effect is defined as a cumulative effect comprising stagnation-effects and the Coanda-effect;
the skin-friction is an effect of fluid molecules sticking to a nearby wall, resulting in a specific spatial distribution of moving-small-portions velocities, when the moving-small-portions flow in a boundary layer adjacent to the nearby wall;
the osmotic-like effect is defined as an effect of exchange of molecular matter and heat between moving-small-portions; and
the effect of viscosity is defined as a cumulative effect comprising the skin-friction effect and the osmotic-like effect;

### Principal Objects

Accordingly, it is a principal object of the present invention to overcome the limitations of existing methods and apparatuses for designing convergent-divergent jet-nozzles, and to provide improved methods and apparatus for efficient use of the desired jet-effect for either: increasing efficiency of vehicle jet-engines, and harvesting electrical energy from fluid warmth, and increasing efficiency of cooling flows, and water harvesting from air.

It is an object of the present invention to provide methods and apparatus for an enhanced jet-effect implementation at high-subsonic velocities avoiding the unwanted phenomenon of the Mach waves emission.

It is still a further object of the present invention to provide methods and apparatus for jet-effect use at high-subsonic velocities avoiding the phenomenon of shock sound-wave emission.

It is one further object of the present invention to provide methods and apparatus for jet-effect use in jet-boosters and rocket nozzles at low-subsonic, high-subsonic, transonic, supersonic, and hypersonic velocities.

It is yet another object of the present invention to provide methods and apparatus for design of an airfoil-wing, improved by jet-effect efficiency.

It is one more object of the present invention to provide methods and apparatus for design of a vortex tube, improved by cooling efficiency.

It is yet an object of the present invention to provide methods and apparatus for design of convergent-divergent jet-nozzles providing for a jet-effect applied to electricity producing from a fluid warmth using classic at least one of a wind-turbine, a hydro-generator, a turbo-generator, and a Peltier element [i.e. a thermoelectric generator] as well as using a modified improved wind-turbine, constructed according to the principles of the present invention to operate under a fast airflow.

It is yet another object of the present invention to provide methods and apparatus for design of hydrophobic jet-gears applied to electricity producing from water warmth using at least one of a hydro-generator and a Peltier element.

It is still a further object of the present invention to provide methods and apparatus for design of convergent-divergent jet-nozzles applied to water harvesting from air.

It is yet a further object of the present invention to provide methods and apparatus for design of a vehicle jet-engine, having an improved net-efficiency.

It is still another object of the present invention to provide methods and apparatus for more reliable design of airfoil bodies.

It is yet one object of the present invention to provide methods and apparatus for multi-stage cascading the Coanda-jet-effect operation by sequential cascading of airfoil bodies.

In one exemplary embodiment, a method is disclosed for computational fluid dynamics; wherein the method is based on generalized equations of fluid motion derived from conservation laws, and laws of thermodynamics and the kinetic theory of matter. The generalized equations of fluid motion have an exact solution, the adequacy of which is confirmed by both: the Bernoulli theorem and the van der Waals law of gas state. The method is proper for numerical simulations of fluid flows at low-subsonic, high-subsonic, transonic, supersonic, and hypersonic velocities and applicable to almost incompressible fluids as real liquids as well as to compressible-expandable fluids as real gases.

In another exemplary embodiment, a fluid-repellent jet-gear submerged in a fluid is disclosed. The fluid-repellent jet-gear has an asymmetrically shaped corpus comprising an outer layer contacting with the fluid, wherein the outer layer is made from a fluid-repellent material, triggering a phobic-repulsing jet-effect, thereby enabling motion at the expense of the internal heat energy of the fluid.

In one further exemplary embodiment, a convergent-divergent jet-nozzle is disclosed. The convergent-divergent jet-nozzle has a specifically shaped inner tunnel, providing linearly increasing the gas M-velocity along the line of gas motion; wherein the increase linearity at least in an essential M-velocity range comprising the specific M-velocity is a criterion of the convergent-divergent jet-nozzle tunnel shape optimization according to an exemplary embodiment of the present invention.

In yet one exemplary embodiment, a two-humped airfoil wing design is disclosed. The two-humped airfoil wing provides increased lift-effect at high-subsonic transonic, supersonic, and hypersonic velocities.

In one other exemplary embodiment, a flying capsule is disclosed, having a specifically shaped inner tunnel and airfoil outer profile; wherein when fast flying, the variable cross-sectional area of the tunnel results in an enhanced jet-effect.

In still another exemplary embodiment, an aggregation of circumferentially arranged elemental jet-boosters is disclosed, representing a vortex generator providing acceleration of sub-portions of circulating ambient-adjoining convergent-divergent jetstreams in a positive feedback loop, thereby resulting in that the sub-portions of circulating ambient-adjoining convergent-divergent jetstreams become moving with de Laval M-velocities triggering alternating both: the de Laval-like jet-effect and the de Laval-like retarding-effect, thereby stabilizing an effective M-velocity alternating above and below the specific M-velocity. The disclosed aggregation of circumferentially arranged elemental jet-boosters as vortex generator is further used as a principal component of the following disclosed derivative applications: an electricity generator of high efficiency, a humidity condenser of high intensity, as well as a flying-saucer of high mobility.

There has thus been outlined, rather broadly, the most important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

In order to understand the invention and to see how it may be carried out in practice, a preferred embodiment will now be described, by way of a non-limiting example only, with reference to the accompanying drawings, in the drawings:

FIG. 1a is a prior art schematic drawing of chiral molecules;

FIG. 1b is a prior art schematic drawing of the convergent-divergent Venturi tube;

FIG. 1c is a prior art schematic view of the convergent-divergent de Laval nozzle;

FIG. 1d is a prior art schematic-illustration graphics of gas velocity, static pressure, and temperature distributions within the de Laval convergent-divergent jet-nozzle;

FIG. 1e is a schematic drawing of a prior art ordinary blowing ventilator;

FIG. 1f is a prior art schematic drawing of a body blown by an airflow portion;

FIG. 1g is a schematic drawing of a classical prior art profile of an airplane wing;

FIG. 1h is a schematic drawing of considerable amounts of water-vapor condensing into water-aerosols and sublimating into micro-flakes-of-snow, which are observed behind the high-speed aircraft's wings;

FIG. 1i is a prior art schematic illustration of points of sail;

FIG. 1k is a prior art schematic illustration of a wind turbine, built-in into a cylinder;

FIG. 1l is a prior art schematic illustration of the Ranque-Hilsch vortex tube;

FIG. 1m is a prior art schematic illustration of the Beverley Clock;

FIG. 2 is a prior art schematic illustration of fluid motion in an imaginary flow tube;

FIG. 3 is a prior art schematic illustration of fluid motion in a real pipe;

FIG. 4 is a schematic illustration of a box having two modules;

FIG. 5a is a schematic illustration of a small portion of fluid;

FIG. 5b is a schematic illustration of a fluid small portion adjacent to a body;

FIG. 5c is a schematic illustration of a fish's squama surface fragment hypothetical interpretation, in accordance with the principles of the present invention;

FIG. 5d is a schematic illustration of a shaped body made from a hydrophobic material and submerged in water;

FIG. 5e is a schematic illustration of a convex-concave corpus.

FIG. 5f is a schematic illustration of a wheel-gear-like configured overall shape, having a sectional profile similar to a circle-saw, comprising fragments made from a hydrophobic material;

FIG. 5g is a schematic view of an exemplary aggregation comprising a set of many hydrophobic jet-gears;

FIG. 5h is a schematic isometry of a hydrophobic-propeller submerged in water surroundings;

FIG. 5i is a schematic illustration of a hydrophobic-spiral;

FIG. 5j is a schematic isometry of a pair of hydrophobic-propellers operating as hydrophobic-engine;

FIG. 5k is a schematic illustration of a pair of unbroken spirals;

FIG. 6a is a schematic illustration of an optimized convergent-divergent jet-nozzle, constructed according to the principles of the present invention;

FIG. 6b is a graphical representation of air velocity, static pressure, and temperature distributions along an optimized convergent-divergent jet-nozzle, constructed according to the principles of the present invention;

FIG. 6c is a schematic illustration of an exemplary profile of optimized tunnel;

FIG. 6d is a schematic illustration of an exemplary profile of optimized tunnel;

FIG. 6e is a schematic illustration of an exemplary profile of optimized tunnel;

FIG. 6f is a schematic illustration of an optimized inverse convergent-divergent jet-nozzle, constructed according to the principles of the present invention;

FIG. 6g is a graphical representation of air velocity, static pressure, and temperature distributions along an optimized inverse convergent-divergent jet-nozzle, constructed according to the principles of the present invention;

FIG. 6h is a schematic illustration of a two-stage convergent-divergent jet-nozzle, constructed according to the principles of the present invention;

FIG. 7a shows comparative graphs of the dependencies of the nozzle extension ratio vs. the airflow M-velocity, calculated by the classical and suggested models;

FIG. 7b is a schematic illustration of a compressor supplied by an optimized convergent-divergent jet-nozzle, constructed according to the principles of the present invention;

FIG. 7c is a schematic sectional view of a flying capsule, constructed according to the principles of the present invention;

FIG. 7d is a schematic sectional view of a flying capsule, constructed according to the principles of the present invention;

FIG. 7e is a schematic drawing of an improved blowing propeller, constructed according to the principles of the present invention;

FIG. 7f is a schematic drawing of an improved sucking propeller, constructed according to the principles of the present invention;

FIG. 8a is a schematic illustration of an airfoil-wing blown by wind;

FIG. 8b is a schematic illustration of a flying airfoil body;

FIG. 8c is a schematic illustration of a flying airfoil body;

FIG. 8d is a schematic illustration of flying arranged airfoil bodies;

FIG. 9a is a schematic illustration of a sequential cascade of airfoil bodies;

FIG. 9b is a schematic illustration of an in-line cascade of rings having airfoil walls;

FIG. 9c is a schematic illustration of two Archimedean screws having airfoil walls;

FIG. 9d is a schematic illustration of a circulating cascade of airfoil bodies;

FIG. 9e is a schematic illustration of airfoil rings, arranged circumferentially;

FIG. 9f is an adiabatic aerodynamic system comprising airfoil rings, arranged circumferentially, and wings, providing a lift-force;

FIG. 9g is a schematic drawing of an improved wind-turbine, constructed according to the principles of the present invention; and

FIG. 10 is a schematic illustration of a block-diagram of the suggested method according to the principles of the present invention.

All the above and other characteristics and advantages of the invention will be further understood through the following illustrative and non-limitative description of preferred embodiments thereof.

### DETAILED DESCRIPTION OF PREFERRED EMBODIMENTS

The principles and operation of a method and an apparatus according to the present invention may be better understood with reference to the drawings and the accompanying description, it being understood that these drawings are given for illustrative purposes only and are not meant to be limiting.

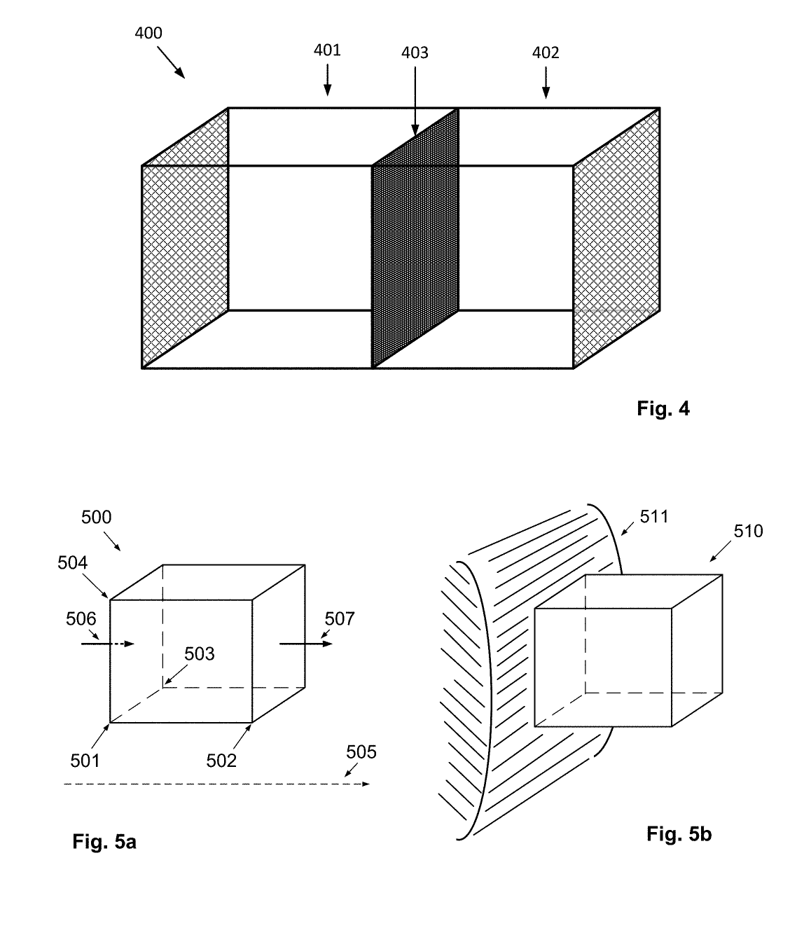

FIG. 4 is a schematic illustration of an ideal thermo-isolated box 400, having two modules 401 and 402, separated by an ideal wall 403 having no weight, being freely-movable and easily-deformable. Thus, wall 403 may freely change the shapes and volume proportions of modules 401 and 402. Modules 401 and 402 are filled with portions of the same gas, having the same static pressure P₄₀₁=ρ₄₀₂, but different densities ρ₄₀₁>ρ₄₀₂ and absolute temperatures T₄₀₁<T₄₀₂, such that satisfying the condition ρ₄₀₁T₄₀₁=ρ₄₀₂T₄₀₂. It is expected that separating wall 403 will not move and will be not deformed because the static pressures ρ₄₀₁ and ρ₄₀₂ on both sides of wall 403 are identical. However, if wall 403 is withdrawn, then diffusion will start. This imaginary experiment says that the presence or absence of isolating wall 403 changes the situation, and the two neighboring portions of gas could accelerate each other by osmotic-like pressures if the portions have the same static pressure and differ in density and temperature. Modelling a molecular fluid as aggregated from many stationary and moving small-portions, the described herein below interpretation of the molecular fluid portions' boundaries as sensitive to the temperature and density of surroundings as soon as the boundaries consist of the same molecular matter as the considered fluid, is one of the primary teachings of the present invention.

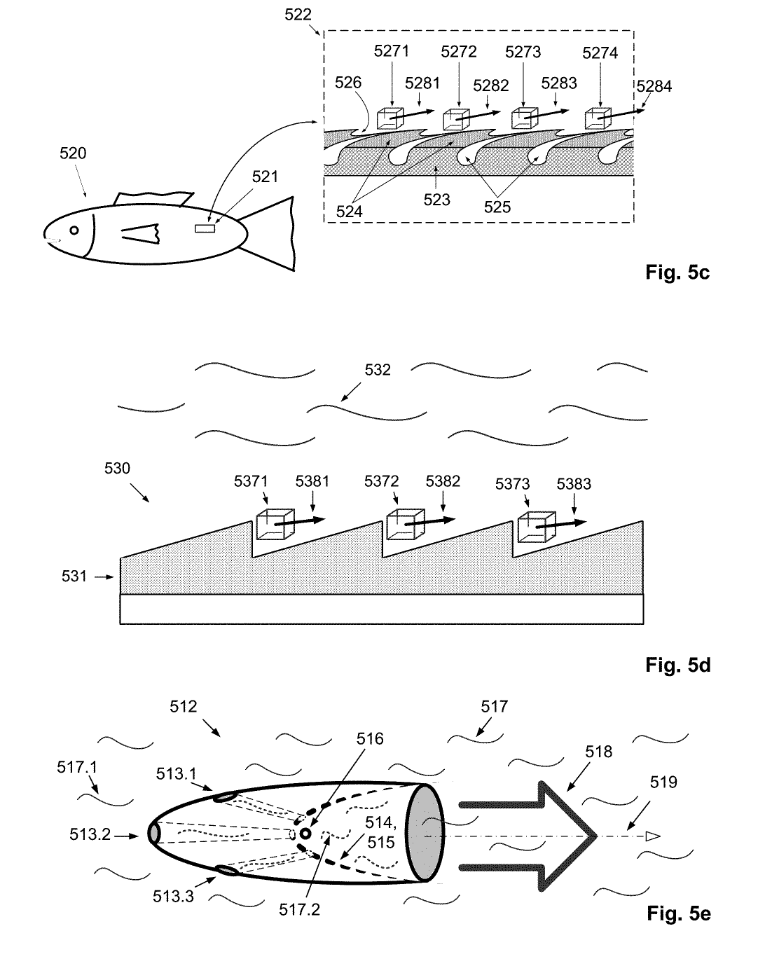

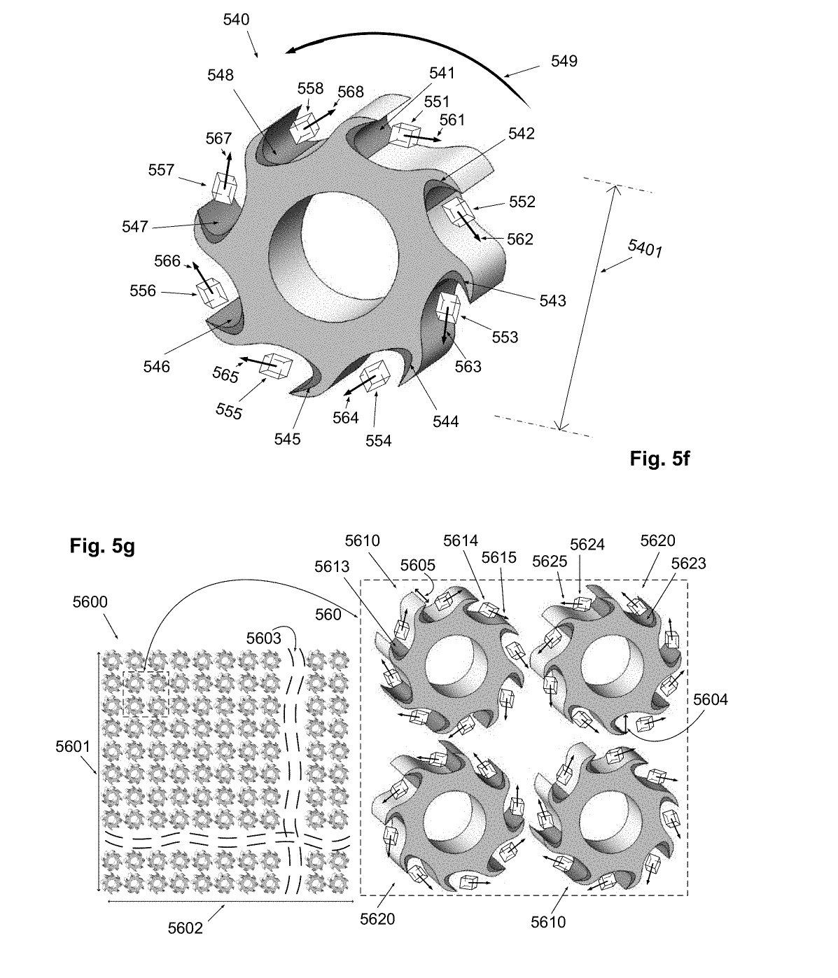

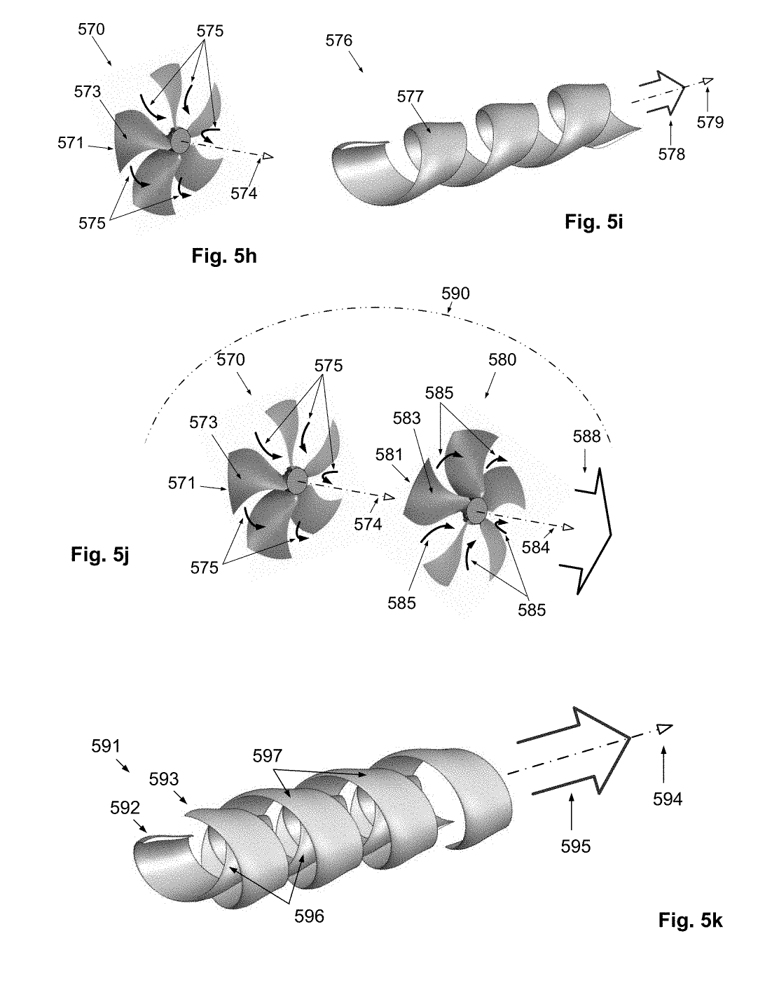

FIG. 5a is a schematic illustration of a small portion of molecular fluid, for simplicity, having the shape of a cubic portion 500. Cubic portion 500 occupies the space defined by point coordinates 501(x,y,z), 502(x+Δx,y,z), 503(x,y+Δy,z), and 504(x,y,z+Δz), where Δx, Δy, and Δz are the distances between points 501 and 502, 501 and 503, and 501 and 504 correspondingly. Small portion 500 is composed of molecules moving randomly and in a prevalent direction, i.e. portion 500 is small enough, such that having no a group of molecules whirling and making a complete rotating cycle within portion 500. Consider the cumulative force acting on portion 500. In the absence of gravitational forces, the fluid inner-static-pressure at any point of the fluid is the same in any direction; and the cumulative force on cubic portion 500, is defined by the fluid inner-static-pressure change from point to point. For simplicity, let the pressure change in the direction of the x-axis 505 only. The pressure on the left face, having points 501(x,y,z), 503(x,y+Δy,z), and 504(x,y,z+Δz), makes the force 506 equal to PᵢₙΔyΔz, where Pᵢₙ is the fluid inner-static-pressure at the left face from outside of cubic portion 500; and the fluid inner-static-pressure on the opposite right face makes the force 507 equal to −[Pᵢₙ+(∂Pᵢₙ/∂x)Δx]ΔyΔz. Therefore, the resulting force is −(∂Pᵢₙ/∂x)ΔxΔyΔz. If one also assumes that the fluid inner-static-pressure changes in the two remaining orthogonal directions, one can see that the pressure cumulative force per unit volume is −∇Pᵢₙ, where ∇ is the vector differential operator. The spatial change of the molecular fluid inner-static-pressure Pᵢₙ must be considered as interrelated with the molecular fluid density ρ and absolute temperature T variations in accordance with the thermodynamic and kinetic theory of matter.

A generalized method for modeling an equation of fluid motion, comprising consideration of momentum conservation, mass conservation, and energy conservation, wherein the fluid molecular structure is taken into the account, is a subject of the present invention.

### Inner Pressure and Momentum Conservation

Considering fluid portion 500, occupying a certain volume V, the Newton Second Law or the conservation of momentum says that the cumulative force acting on portion 500, i.e. the variation of the momentum in the volume, must be due to the inflow or outflow of momentum through the closed surface S of portion 500 plus the forces acting on portion 500 by the fluid surrounding:

$$\frac{\partial }{\partial t} \int ρ udV = - {∮}_{S} ρ uu \cdot ndS - {∮}_{S} PndS , \qquad Eq . ( 5.1 )$$

where dS is the surface differential, n is the unit vector normal to surface differential dS, and ρ, u, and P are functions of spatial coordinates; wherein ρ is the fluid portion 500 density, u is the fluid portion 500 velocity-vector having absolute value u, and P is the cumulative-inner-static-pressure acting on the boundaries of portion 500; wherein in contrast to the classical approach of continuum mechanics, the fluid portion 500's boundaries have molecular structure, and P is as a thermodynamic parameter interrelated with the fluid temperature, density, and gravity. The kinetic theory of ideal gases defines this relation for a stationary case in the absence of gravity as P_{ideal}=NkTₛ/Vₛ, where P_{ideal} is the static pressure of an ideal gas, Vₛ is the considered volume, N is the number of molecules in considered portion 500 of the ideal gas, k is the Boltzmann constant, and Tₛ is the absolute temperature of the stationary ideal gas. The interrelation between thermodynamic parameters in the case of a hypothetical ideal gas can also be represented by the Clapeyron-Mendeleev gas law: P_{ideal}=ρₛR₀Tₛ/μ, where ρₛ is the stationary ideal gas density, R₀ is the universal gas constant, and μ is the molar mass of the gas. Considering a real gas, the van der Waals approach bonds the static pressure of real gas P_{Waals} acting on a stationary wall with the static pressure P_{ideal} defined in the kinetic theory of ideal gas, namely:

$${P}_{ideal} = ( {P}_{Waals} + \frac{a}{{V}_{s}^{2}} ) \frac{( {V}_{s} - b )}{{V}_{s}} , \qquad Eq . ( 5.2 a )$$

where P_{Waals} is the van der Waals static pressure of real gas, acting on a stationary wall; constant b has the physical sense of excluded volume because of the presence of the particles in the volume; and constant a defines the attraction forces between the real gas molecules. So, the van der Waals equation of state for real gas is written as:

$$( {P}_{Waals} + \frac{a}{{V}_{s}^{2}} ) \frac{( {V}_{s} - b )}{{V}_{s}} = \frac{{ρ}_{s} {R}_{0} {T}_{s}}{μ} , \qquad Eq . ( 5.2 b )$$

The general enough theory of molecular fluid by van der Waals is qualitatively reasonable for the liquids as well. For the purposes of the present patent application, the van der Waals equation (5.2b) should be understood in a wider sense, allowing for the van der Waals parameters a and b to be variable, thereby making the equation (5.2b) appropriate for rigorous quantitative calculations applied to both: real gases and liquids, and thereby, generalizing the van der Waals equation of state for a molecular fluid.

In contrast to the defined pressure P_{Waals} acting on a stationary wall, being hypothetically inert to the fluid's molecules forces, i.e. being not phobic with repulsive forces and not sticking with attractive forces, the cumulative-inner-static-pressure P in equation (5.1) is acting on the fluid portion 500's boundaries, which, on the one hand, have the same inter-molecular attraction properties as the surrounding matter, and, on the other hand, may be not stationary, but be subjected to deformations and acceleration.

First, consider a static case in the absence of gravitational forces, when portion 500 is far enough from a body having real walls. In this particular case, when portion 500, as stationary-small-portion, is not subjected to any acceleration and is affected by a stationary-effect only, the static pressure in equation (5.1) has the meaning of the inner-stationary-static-pressure defined for the static case. This pressure, indicated by Pₛ, as a measure of the fluid molecules cumulative stationary-impact on imaginary boundaries of stationary-small-portion 500, is expressed as the following stationary equation:

$${P}_{s} = {P}_{Waals} + \frac{a}{{V}^{2}} . \qquad Eq . ( 5.2 c )$$

Taking into the account equation (5.2c), the van der Waals equation (5.2b), written in the form expressing the inner-stationary-static-pressure, takes the following form:

$${P}_{s} = \frac{{ρ}_{s} {r}_{s} {R}_{0} {T}_{s}}{μ} , \qquad Eq . ( 5.2 d )$$

where rₛ is the compression ratio Vₛ/(Vₛ−b), which represents how much the real fluid is compressed in comparison with a hypothetical ideal gas. For example, the assumption that the parameter b, quantifying the excluded volume, equals Vₛ leads to the infinite compression ratio rₛ that corresponds to a hypothetical absolutely incompressible liquid. Equation (5.2d) allows considering the real fluid's inner-stationary-static-pressure Pₛ as the static pressure of the ideal-like gas having specific fluid constant Rₛ defined as Rₛ=rₛR₀/μ.

Taking into the consideration the definitions of the inner-stationary-static-pressure Pₛ, compression ratio rₛ, and real molecular fluid as the ideal-like gas having specific fluid constant Rₛ, the van der Waals equation of state for a molecular fluid, written in the form expressing the inner-stationary-static-pressure, gets the form, similar to the Clapeyron-Mendeleev gas law, namely:

Pₛ=ρₛRₛTₛ Eq. (5.2e).

In the case of an ideal gas, the sense of stationary equation (5.2e) becomes identical with the Clapeyron-Mendeleev gas law.

The value RₛTₛ has the physical sense of the characteristic heat portion per unit mass, indicated by Qₛ, stored in fluid stationary-small-portion 500's molecular Brownian random motion, related to degrees of freedom causing the fluid molecules cumulative stationary-impact defining the inner-stationary-static-pressure Pₛ, and satisfying equation (5.2e), namely: Qₛ=RₛTₛ=Pₛ/ρₛ, and Pₛ=ρₛQₛ.

The defined pressure Pₛ can be decomposed into the following three components: the static pressure P_{ideal} defined in the kinetic theory of ideal gas, and two additive partial components defining the molecular fluid compression depending on the van der Waals parameters a and b. The two additive partial components are: compression pressure-“a”, indicated by Pₐ, and compression pressure-“b”, indicated by P_{b}. The indexes “a” and “b” are associated with the van der Waals parameters a and b correspondingly. I.e. pressure Pₛ is expressed as:

Pₛ=P_{ideal}+Pₐ+P_{b} Eq. (5.2f).

The partial compression pressure-“b” P_{b} is defined as a measure of a compression-impact-effect, caused because of increased density of the molecular fluid, sufficient to take into account the compression ratio rₛ=Vₛ/(Vₛ−b). This is a pressure deforming the shape of fluid portion 500.

The partial compression pressure-“a” Pₐ is defined as a measure of a further deep-compression-effect, arisen because of increased density of the molecular fluid, sufficient to have to take into account the inter-molecular forces defined by the van der Waals parameter a, defining the potential energy of the inter-molecular attraction. The partial compression pressure-“a” Pₐ interrelates with the potential energy of the inter-molecular attraction as:

$$U = \frac{{P}_{a}}{{ρ}_{s}} , \qquad Eq . ( 5.2 g )$$

where U is the internal inter-molecular potential-energy-per-unit-mass.

Thereby:
U while the molecular fluid is as an ideal gas, both: the partial compression pressure-“a” and the partial compression pressure-“b” equal zero: Pₐ=0 and P_{b}=0;
if the molecular fluid is as a solid-gas with the compression ratio rₛ noticeably greater than 1 and with a minor influence of the inter-molecular attractive forces, the partial compression pressure-“a” is marginal: Pₐ=0; and
if the molecular fluid is as liquid, the partial compression pressure-“a” decisively defines potential energy of the inter-molecular attraction.

The fluid's density, on the one hand, has the sense of a measure of the fluid molecules concentration and mass and, on the one hand, has the gravitational sense. The potential gravitational energy stored in the fluid portion unit mass in the Earth's gravitational field is G=zg, where z is the effective height of the fluid's portion above the Earth's ocean surface level. Thus, the partial potential-static-pressure P distributed on height and provided by the Earth's gravitational field is added, namely:

P_{z}=zμg=ρG Eq. (5.2),

where ρ is the fluid density that in the stationary case is ρₛ satisfying stationary equation (5.2e).

Reference is now made to FIG. 5b, a schematic illustration of a fluid portion 510 as a generalized case of fluid portion 500 of FIG. 5a such that having boundaries adjacent to the stationary walls of body 511. The approach described referring to FIG. 5a can be further adapted to an imaginary boundary layer, comprising fluid portion 510, moving near the real walls of body 511 and being subjected to deformations and acceleration.

The adaptation involves a definition of the inner-static-pressure Pᵢₙ provided by the fluid molecules interactions as comprising two items: Pᵢₙ=Pₛ+P_{boundary}, where P_{boundary} is the partial inner-boundary-layer-static-pressure. On the one hand, the partial inner-boundary-layer-static-pressure P_{boundary} enforces the movement to be in alignment with the adjacent stationary walls of body 511, i.e. acting as a drag, and on the other hand, it results in the fluid's specific velocity distribution in an imaginary boundary layer, i.e. acting as a partial pressure relating to a viscous skin-friction effect. This is formalized as

P_{boundary}=P_{drag}+P_{viscous} Eq. (5.3a),

where P_{drag} is the partial drag-static-pressure acting on moving-small-portion 510, defined as the partial pressure, which arises when fluid portion 510 gets a convective acceleration redirecting moving-small-portion 510, sliding in alignment with the curvature of the real walls; and P_{viscous} is the partial viscous-static-pressure acting on moving-small-portion 510, defined as the partial pressure, which results in that the velocity of moving-small-portion 510 is subjected to a specific spatial distribution in the imaginary boundary layer adjacent to the real walls of body 511. Here and further on, it is assumed that the interaction between the walls and fluid occurs without the heat energy exchange between the walls and fluid, so moving-small-portion 510 is undergoing a reversible adiabatic process.

The partial drag-static-pressure P_{drag} represents either phobic, i.e. fluid-repellent pressure, interrelated with phobic-repulsive forces directed inward fluid portion 510, or sticking pressure, related with attractive forces directed outward fluid portion 510, when the motion trajectory of fluid portion 510 is aligned with the wall's curvature or, more generally, with the trajectory of the adjusted portions of the moving fluid. The partial drag-static-pressure P_{drag} defines the arisen boundary level effect arising due to the curvature of the walls. The partial drag-static-pressure P_{drag} relates to the two mechanisms of fluid portion 510 acceleration: on the one hand, the partial drag-static-pressure P_{drag} acts as a compressor-expander stagnating fluid portion 510; and on the other hand, the partial drag-static-pressure P_{drag} acts to change the cross-sectional area of moving-small-portion 510.

The effect of fluid portion 510 stagnating is formalized by the sum of the partial stagnation pressures: stagnation pressure-“b”, indicated by δP_{b}, and of the deep-stagnation pressure-“a”, indicated by δPₐ. The indexes “a” and “b” are associated with relative variations of the van der Waals parameters a and b correspondingly.

The partial stagnation pressure-“b” δP_{b} is defined as a measure of a stagnation-impact-effect, i.e. of an effect of a cumulative stagnation-impact of the molecules on the imaginary boundaries of fluid portion 510. This is a pressure deforming the shape of fluid portion 510. The partial stagnation pressure-“b” δP_{b} is interrelated with a change of the moving-small-portion 510's volume V and, thereby, of the compression ratio r defined as V/(V−b), while retaining the same inter-molecular forces defined by van der Waals parameter a. The value r, now differing from the value rₛ defined for a stationary case, specifies the partial stagnation pressure-“b”δP_{b}.

The partial deep-stagnation pressure-“a” δPₐ is defined as a measure of a further deep-stagnation-effect, observed as further deformation of the shape of fluid portion 510, such that resulting in quantitative changes of the inter-molecular forces defined by the van der Waals parameter a, allowed to be variable. If the van der Waals parameter a is associated with the stationary-small-portion 500, subjected to the deep-compression-effect and yet to be subjected to the deep-stagnation-effect, then, considering the moving-small-portion 510, the variation, indicated by δa, is added, such that the van der Waals parameter a+δa corresponds to the moving-small-portion, subjected to the deep-stagnation-effect.

For example, while the molecular fluid is as an ideal gas, both: the partial deep-stagnation pressure-“a” and the partial stagnation pressure-“b” equal zero: δPₐ=0 and δP_{b}=0; if the molecular fluid is as a solid-gas with the variable compression ratio r and with minor variations of the inter-molecular attractive forces, the partial deep-stagnation pressure-“a” is marginal: δPₐ=0; and by contrast, if the molecular fluid is as liquid, the partial stagnation pressure-“b” is negligible: δP_{b}=0.

The aspect of the partial drag-static-pressure P_{drag}, associated with the change of the cross-sectional area of moving-small-portion 510 thereby providing fluid portion 510's sliding motion in alignment with the stationary walls curvature, is formalized as the partial pressure-“c” indicated by δP_{c}. The partial pressure-“c” δP_{c} interrelates with the Coanda-effect and is a measure of the cumulative aligning-impact of the fluid molecules on the imaginary boundaries of fluid portion 510 moving in the imaginary boundary layer adjacent to stationary walls of body 511.

Thus, a drag-effect is the cumulative effect comprising:
the stagnation-impact-effect providing the partial stagnation pressure-“b”,
the deep-stagnation-effect providing the partial stagnation pressure-“a”, and
the Coanda-effect providing the partial pressure-“c”;
   such that the partial drag-static-pressure P_{drag} is quantified as equal to the sum, comprising three items, as expressed by:

P_{drag}=δPₐ+δP_{b}+δP_{c} Eq. (5.3b).

The mentioned mechanisms, related to the partial pressures “b” and “c”, provide reversible adiabatic conversion of the kinetic energy of the fluid's molecules Brownian random motion into the kinetic energy of fluid portion 510's aligned motion, and vice-versa.

The mentioned mechanism, related to the partial deep-stagnation pressure-“a”, changes the internal inter-molecular potential-energy-per-unit-mass by a value equal to

$$δ U = \frac{δ {P}_{a}}{ρ} \qquad Eq . ( 5.3 )$$

distributed in space.

The partial viscous-static-pressure P_{viscous} relates to the two mechanisms of fluid portion 510 acceleration: on the one hand, it is a skin-friction effect observed as an effect of the moving fluid's molecules sticking to the real walls; and on the other hand, it is an osmotic-like effect, which arises between the fluid's adjacent portions differing in either density or temperature.

The partial skin-friction static-pressure Pₛₖᵢₙ is a measure, how much the walls are sticky for the molecular fluid motion. This can be formalized as

$${P}_{skin} = \frac{{a}_{w} - a - δ a}{{V}^{2}} \times {F}_{skin} ( u , a + δ a , {y}_{w} ) , \qquad Eq . ( 5.4 a )$$

where δa is the van der Waals parameter variation relative to the van der Waals parameter a associated with the stationary-small-portion yet to be subjected to the deep-stagnation-effect, V is the volume of moving-small-portion 510, a_{w} is the parameter similar to the van der Waals parameter a, but describing inter-attraction forces between the walls and molecules of the fluid, i.e. the wall-fluid molecular interaction forces; y_{w} is the distance between moving-small-portion 510 and the walls; and Fₛₖᵢₙ(u,a+δa, y_{w}) is a function of u, a+δa, and y_{w}. If the distance y_{w} is big enough, the viscosity influence of the walls becomes negligible. The difference (a_{w}−a−δa) defines the effect of viscosity. When the attractive forces between the walls and molecules of the fluid are stronger than the fluid's inter-molecular forces, i.e. (a_{w}−a−δa)>0, the fluid's molecules are “sticking” to the walls, and the fluid develops viscous properties causing the wall-fluid molecular interaction forces cumulative action against fluid portion 510's motion direction accompanied by a dissipation of the kinetic energy of fluid portion 510 into the fluid portion 510's heat energy; and when the attractive forces between the walls and molecules of the fluid are weaker than the fluid's inter-molecular forces, i.e. (a_{w}−a−δa)<0, the walls develop phobic repellent properties. A so-called “free-slip” motion condition, corresponds to the case, when the attractive forces between the walls and molecules of the fluid compensate the fluid's inter-molecular forces, i.e. (a_{w}−a−δa)=0.

The partial osmotic-like static-pressure P_{osmotic} defines the osmotic-like effect triggered by the gradients of density and temperature. This can be formalized as

P_{osmotic}=F_{osmotic}(a+δa,∇ρ,∇T) Eq. (5.4b),

where F_{osmotic}(a+δa,∇p,∇T) is a function of the van der Waals parameter a allowed to be varied and of the gradients ∇ρ and ∇T. The gradients ∇ρ and ∇T depend on the gradient of the velocity-vector ∇u. If all the gradients equal zero, the osmotic-like effect becomes as the diffusion caused by the Brownian random motion of the fluid's molecules.

Thus, the partial viscous-static-pressure P_{viscous} is represented as the sum of two items, namely:

P_{viscous}=Pₛₖᵢₙ+P_{osmotic} Eq. (5.4c).

So, considering the general case of fluid portion 510 of FIG. 5b that may move either within or out of the imaginary boundary layer, the cumulative-inner-static-pressure P is interpreted as comprising the mentioned items:

P=Pᵢₙ+P_{z}=Pₛ+P_{drag}+P_{viscous}+P_{z} Eq. (5.4d),

which can be further decomposed as the following:

P=Pₛ+(δPₐ+δP_{b}+δP_{c})+(Pₛₖᵢₙ+P_{osmotic})+P_{z} Eq. (5.4e)

The characteristic heat portion per unit mass, indicated by Q, stored in fluid moving-small-portion 510's molecular Brownian random motion, related to degrees of freedom causing the fluid molecules cumulative impact defining the inner-static-pressure Pᵢₙ, equals

$$Q = RT = \frac{{P}_{in}}{ρ} , \qquad Eq . ( 5.4 )$$

where T is the fluid moving-small-portion 510 absolute temperature that, in general, differs from the temperature Tₛ of the stationary case satisfying the stationary equation (5.2e), and the generalized specific fluid constant R is defined for moving-small-portion 510 as R=rR₀/μ, where r=V/(V−b). Combining equations (5.2), (5.3) and (5.4), one can derive that

$$Q + G = \frac{P}{ρ} , \qquad Eq . ( 5.5 )$$

when an adiabatic case is considered.

In a particular case, when the effect of the gravitational influence is negligible, the cumulative-inner-static-pressure P is identical with the inner-static-pressure Pᵢₙ, and the equation of a moving molecular fluid state is derived from the equation (5.5) as:

P=Pᵢₙ=ρQ=ρRT, if P_{z}=0 Eq. (5.5a).

Taking into account equation (5.5), one can rewrite integral equation (5.1) as:

$$\frac{\partial }{\partial t} \int ρ udV = - {∮}_{S} ρ uu \cdot ndS - {∮}_{S} ρ ( Q + G ) ndS . \qquad Eq . ( 5.6 a )$$

Applying Gauss's theorem to the integrals of the right part, one can specify this as:

$$\frac{\partial }{\partial t} \int ρ udV = - \int ∇ ρ uudV - \int ∇ ρ ( Q + G ) dV , \qquad Eq . ( 5.6 b )$$

or, in differential form:

$$\frac{\partial }{\partial t} u = - ∇ ( uu ) - ∇ ( Q + G ) , \qquad Eq . ( 5.6 )$$

where ∇ is the vector differential operator.

The momentum conservation equation in form (5.6) is applicable to viscous fluid flow being either almost incompressible as liquid or compressible-expandable as gas. Noticing that the inner-static-pressure, in the general case, equals Pᵢₙ=Pₛ+P_{drag}+P_{viscous}, the exact solution of (5.6) for a steady-state flow is the Bernoulli theorem: (Pᵢₙ/φ+(zg)+(u²/2)=Const that confirms adequateness of equation (5.6).

### Mass Conservation or Equation of Continuity

The conservation of mass says that the variation of the mass in a volume must be entirely due to the inflow or outflow of mass through a closed surface [symbol] of that volume, namely:

$$\frac{\partial }{\partial t} \int ρ dV = - {∮}_{S} ρ u \cdot ndS . \qquad Eq . ( 5.7 a )$$

Using Gauss's theorem, one can specify this as:

$$\frac{\partial }{\partial t} \int ρ dV = - \int ∇ \cdot ( ρ u ) \cdot dV , \qquad Eq . ( 5.7 b )$$

and so in differential form:

$$\frac{\partial }{\partial t} ρ + ∇ \cdot ( ρ u ) = 0. \qquad Eq . ( 5.7 )$$

The solution of (5.7) for a stationary case can be written as the equation of continuity: ρAu=Const, where A is the fluid flow cross-section area.

### Generalized Adiabatic Compressibility Parameter

The mathematical equation for a hypothetical ideal gas undergoing a reversible adiabatic process is

P_{ideal}V^{j}=Const Eq. (5.8a),

where j is the adiabatic compressibility-constant, defined for the hypothetical ideal gas as j=1+R₀/C_{V}=1+2/f, where C_{V} is the specific heat capacity for constant volume, and f is the number of degrees of freedom per molecule of gas and f depends on a configuration of the hypothetical ideal gas molecules.

One can spread the logic of the kinetic theory of gas to define a so-called adiabatic compressibility parameter γ, now generalized for a real fluid, specifying factors reducing the degrees of freedom of the fluid's molecules. These are the compression ratio r=V/(V—b) and an involved function φ(a) of the van der Waals parameter a+δa. The involved function φ(a+δa) has a sense of an influence of the internal inter-molecular potential-energy-per-unit-mass on the degrees of freedom of the fluid's molecules and is expressed as:

$$φ ( a + δ a ) = \frac{{P}_{i n}}{{P}_{i n} - {P}_{a} - δ {P}_{a}} = \frac{ρ RT}{ρ RT - U - δ U} . \qquad Eq . ( 5.8 b )$$

Therefore, one can define the generalized adiabatic compressibility parameter γ as

γ=1+rφ(a+δa)R₀/C_{V}=1+2rφ(a+δa)/f, i.e.

γ=1+rφ(a+δa)(j−1) Eq. (5.8c),

where j now has the sense of the adiabatic compressibility parameter, defined for the real fluid, but imagined as a hypothetical ideal gas composed of the same molecules in the assumption that the conditions a+δa=0 and b=0 are satisfied and are interrelated to the conditions φ(a+δa)=1 and r=1 correspondingly. The condition γ>>1 is satisfied for liquids and ionized gases (i.e. plasma), so the following simplified equation becomes relevant:

$$\{ \begin{matrix}γ = j & for hypothetical ideal gases \\ γ = 1 + r ( j - 1 ) & for real gases \\ γ >> 1 & for real liquids and plasma \\ γ \to ∞ & for incompressible liquids\end{matrix} . \qquad Eq . ( 5.8 d )$$

The definition of the generalized adiabatic compressibility parameter γ allows to derive an equation for the real fluid undergoing a reversible adiabatic process as:

PᵢₙV^{γ}=Const Eq. (5.8).

In a particular case, when the effect of the gravitational influence is negligible, the cumulative-inner-static-pressure P becomes identical with the inner-static-pressure Pᵢₙ, and the equation (5.8) for the real fluid undergoing a reversible adiabatic process can be specified as:

PV^{γ}=PᵢₙV^{γ}=Const, if P_{z}=0 Eq. (5.8e).

For a hypothetical ideal gas, the conditions r=1 and φ(a)=1 are satisfied, and equations (5.8) and (5.8e) revert to equation (5.8a).

### Energy Conservation

The conservation of energy says that the variation of the energy in a volume must be entirely due to the inflow or outflow of energy through a closed surface S of that volume. Energy exists in many forms. In the case, wherein portion 510 is small enough, such that having no whirling groups of molecules, making a complete rotating cycle within portion 510, i.e. having no inner turbulent motions, considering a unit mass of fluid portion 510, one can take into account the following forms of the energy:
kinetic energy K=u²/2, defined by cumulative kinetic-energy-per-unit-mass of fluid molecules motion in a prevalent direction;
potential gravitational energy G=zg, stored in the unit mass in the gravitational field of the Earth;
total heat Qₜₒₜ as the cumulative kinetic energy per unit mass stored in a fluid molecular Brownian random motion that for a van der Waals gas is defined as Qₜₒₜ=RT/(r(j−1)), where R=rR₀/μ, wherein the reduced degrees of freedom of the fluid's molecules caused because of the internal inter-molecular potential-energy-per-unit-mass U+δU is taken into the consideration via the definition of generalized adiabatic compressibility parameter γ, such that the total internal energy per unit mass, indicated by Eᵢₙ, is quantified as Eᵢₙ=Qₜₒₜ+U+δU=RT/(γ−1), and wherein the characteristic heat portion per unit mass Q=RT, stored in a fluid molecular Brownian random motion, is related to degrees of freedom causing the fluid molecules cumulative impact on the boundary surfaces of moving-small-portion 510.

Thereby, the total cumulative energy is the volume integral of ρ(K+G+Eᵢₙ), and the advection of energy through the control volume surface is the surface integral of ρ(K+G+Q)u·n. Thus the conservation equation of energy is

$$\frac{\partial }{\partial t} \int ρ ( K + G + {E}_{in} ) dV = - {∮}_{S} ρ ( K + G + Q ) u \cdot ndS . \qquad Eq . ( 5.9 a )$$

Using Gauss theorem one gets:

$$\frac{\partial }{\partial t} \int ρ ( K + G + {E}_{in} ) dV = - \int ∇ [ ρ ( K + G + Q ) u ] dV . \qquad Eq . ( 5.9 b )$$

Since this must be valid for all control volumes V, one gets the differential form of the energy conservation equation:

$$\frac{\partial }{\partial t} ρ ( K + G + \frac{Q}{( γ - 1 )} ) + ∇ [ ρ ( K + G + Q ) u ] = 0 , \qquad Eq . ( 5.9 c )$$

or, substituting the defined expressions for the kinds of energy, it can be written as:

$$\frac{\partial }{\partial t} ρ ( \frac{{u}^{2}}{2} + zg + \frac{RT}{( γ - 1 )} ) = - ∇ [ ( ρ u ) ( \frac{{u}^{2}}{2} + zg + RT ) ] . \qquad Eq . ( 5.9 )$$

In a stationary case, equation (5.9) can be simplified as:

$$∇ [ ( ρ u ) ( \frac{{u}^{2}}{2} + zg + RT ) ] = 0 \qquad Eq . ( 5.10 a )$$

Comparing (5.10a) with mass conservation equation (5.7), one can conclude that

$$\frac{{u}^{2}}{2} + zg + RT = Const \qquad Eq . ( 5.10 b )$$

Taking into the account that RT=Pᵢₙ/ρ, one obtains the Bernoulli theorem for stationary flow:

$$\frac{{u}^{2}}{2} + zg + \frac{{P}_{in}}{ρ} = Const , \qquad Eq . ( 5.10 )$$

as was predicted.

The set of specified equations (5.2), (5.3), (5.4), (5.5), (5.6), (5.7), (5.8), and (5.9) represents the generalized equations of molecular fluid motion, the adequacy of which is confirmed by the Bernoulli theorem, equation (5.10). A method for computational fluid dynamics comprising the momentum conservation equation (5.6) expressed via gradient of the characteristic heat portion ∇Q is a subject of the present invention.

In view of the foregoing description with reference to FIG. 5b, it will be evident to a person skilled in the art that, in contrast to the continuum mechanics approach based on the introduction of viscosity constants, the description of the drag and viscosity effects by molecular interactions defined in frames of the kinetic theory of matter is one of the primary principles of the present invention.

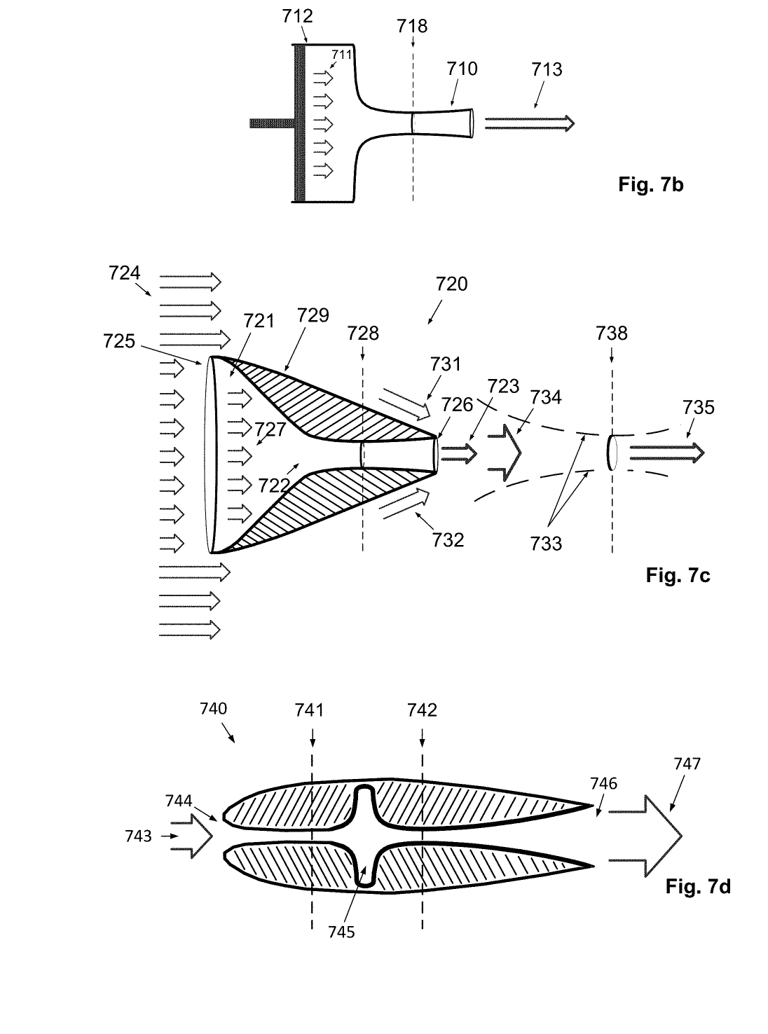

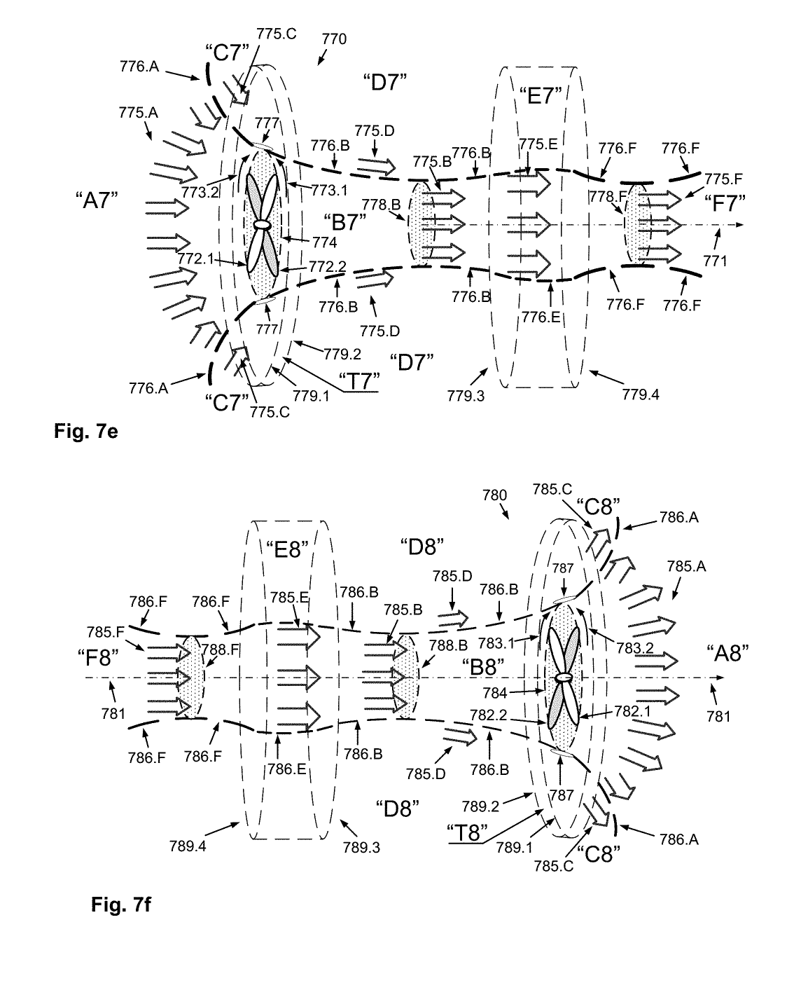

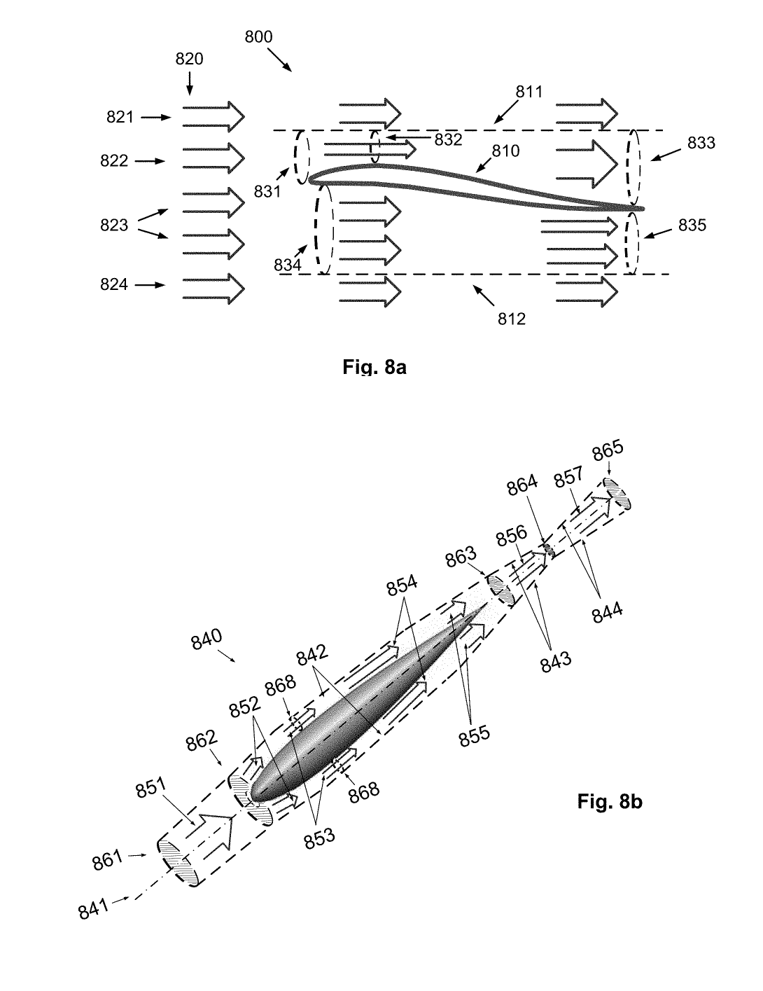

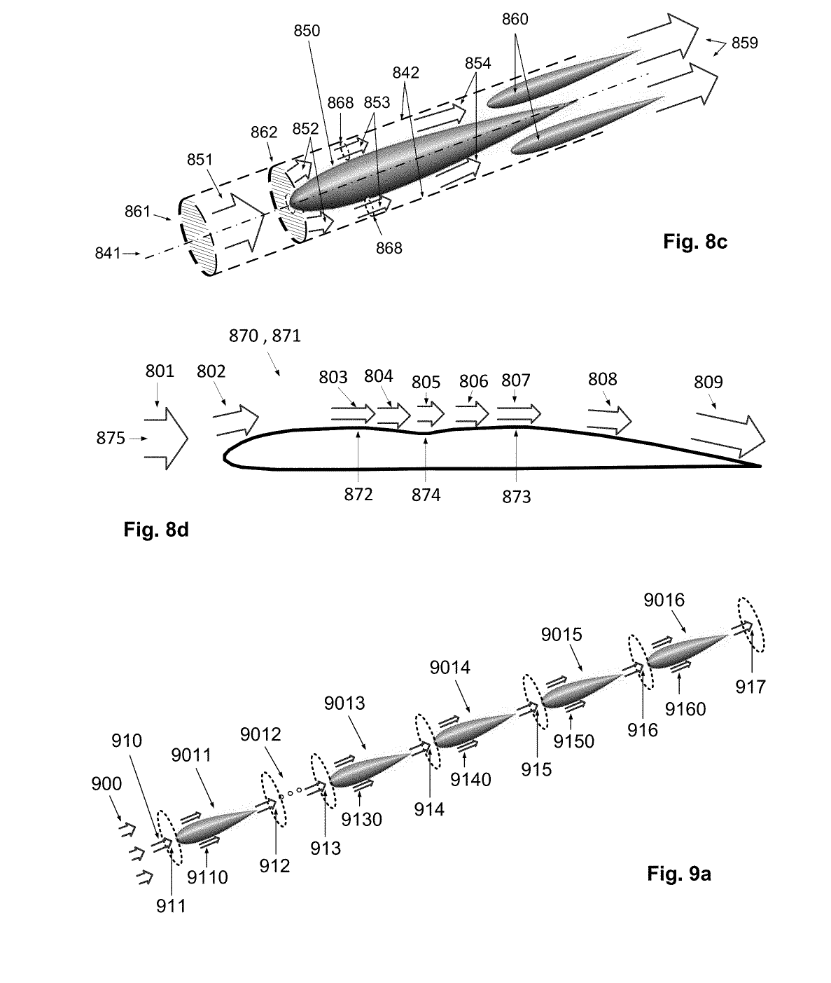

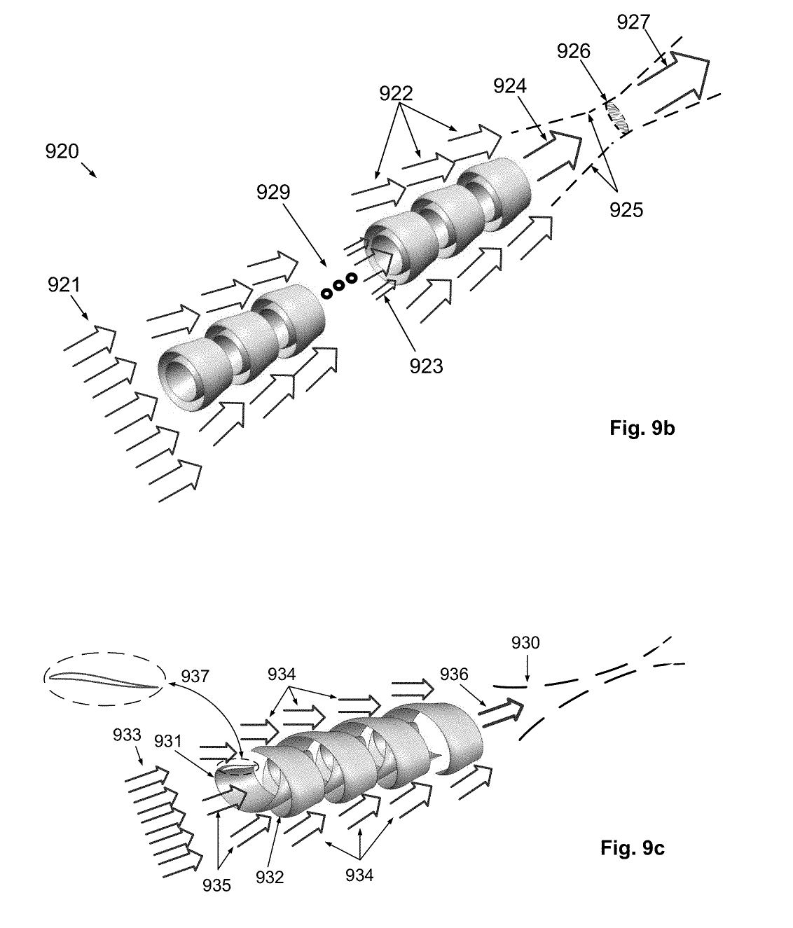

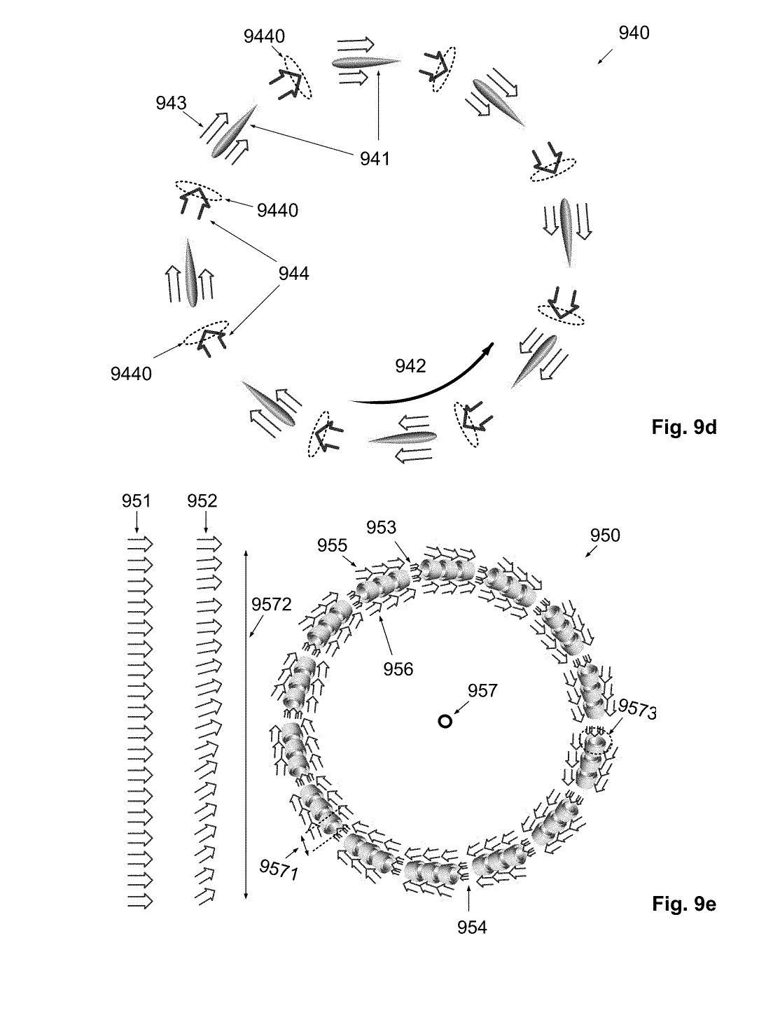

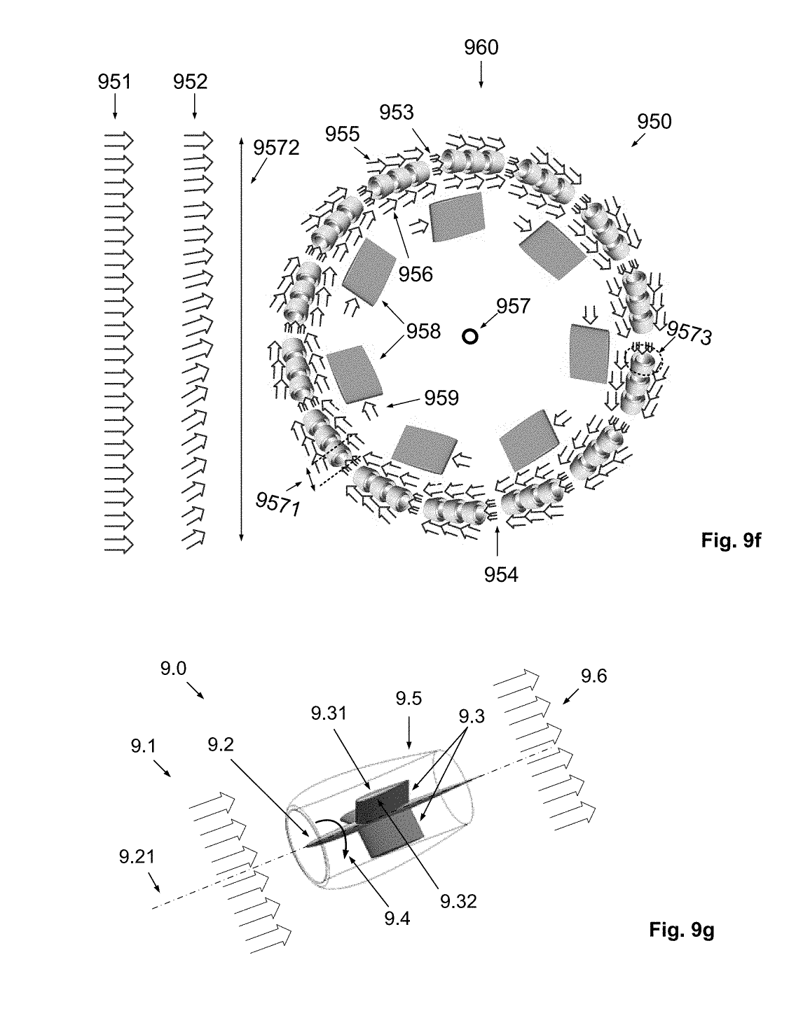

In view of the foregoing description with reference to FIG. 5b, it will be evident to a person skilled in the art that the described approach, being adapted to fluid portion 510 moving near real walls of body 511, excludes the d'Alembert paradox formulated in frames of the classical continuum mechanics, because of either repellent or sticking properties of the arisen partial drag-static-pressure P_{drag} depending on a direction of the motion velocity of fluid portion 510 and the walls' curvatures. This follows also from the kinetic theory of gas, where the term “pressure” is defined as a measure of the random moving molecules' impact effect acting on a wall. So, considering a moving body, for simplicity, having a spherical shape, the relative mean velocity-vector of the impacting molecules random motion depends on the body's velocity value and direction, according to Galilean relativity. Thus, the difference between the impact effects, acting on the forward and rear sides of the moving body, defines the non-zero cumulative partial drag-static-pressure P_{drag}. Furthermore, considering a moving body, having an airfoil wing-like shape triggering the Coanda-effect, the partial pressure-“c” δP_{c}, as a component of the partial drag-static-pressure P_{drag}, provides a jet-effect and, in a certain condition, triggers the de Laval effect as described below with reference to FIG. 7c as well as with references to FIGS. 8a, 8b, 8c, 8d, 9a, 9b, 9c, 9d, 9e, and 9f.

In view of the foregoing description with reference to FIG. 5b, it will be evident to a person skilled in the art that the partial viscous-static-pressure P_{viscous}, comprising the partial skin-fiction static-pressure Pₛₖᵢₙ and osmotic-like static-pressure P_{osmotic}, depends on the fluid temperature. In particular, for gases, higher temperature results in a dominant increase of the partial osmotic-like static-pressure P_{osmotic}; and for liquids, higher temperature results in a decrease of the van der Waals parameter a accompanied by the skin-friction static-pressure Pₛₖᵢₙ decrease, primary defining the partial viscous-static-pressure P_{viscous} decrease.

In view of the foregoing description with reference to FIG. 5a, it will be evident to a person skilled in the art that, considering a molecular fluid in frames of the van der Waals approach, without loss of generality, one can apply a modification of the van der Waals equation of state for a molecular fluid. It may be either the Redlich-Kwong equation, and/or the Berthelot model, and/or the Dieterici model, and/or the Clausius model, and/or the Virial equation, and/or the Peng-Robinson equation of state, and/or the Wohl equation, and/or the Beattie-Bridgman model, and/or Benedict-Webb-Rubin equation as well as further generalizing modifications.

In view of the foregoing description with reference to FIGS. 5a and 5b, it will be evident to a person skilled in the art that, applying a certain resolution size of fluid portion 510 to a discrete approximation in the computational fluid dynamics, some whirling groups of molecules, i.e. some turbulent motions of fluid, become hidden within the resolution. In other words, considering a large enough fluid portion 510 as a cell of the discrete approximation in the computational fluid dynamics, the hidden turbulent motion of the groups of molecules, whirling within fluid portion 510, is interpreted as the molecules Brownian random motion. This means that the temperature of fluid portion 510, involved into equation (5.9), should be understood in a widened sense as a measure proportional to the average molecular kinetic energy of both: the molecules Brownian random motion and the hidden turbulent motion of the whirling groups of molecules.

### Fluid-Repellent Structured Surface

For the purposes of the present patent application, the term “corpus”, specified as a space-portion, bordered by a closed solid shell contacting with ambient fluid, should be understood as a configurational aspect of a body submerged in the fluid.

For the purposes of the present patent application, the introduced term “fluid-repellent” should be understood in a wide sense as a property of a material to repel the fluid. In particular, a fluid-repellent material is either:
hydrophobic, i.e. water-repellent; or
oleophobic, i.e. oil-repellent; or
so-called “omniphobic”, i.e. repelling all known liquids such as water-based, oil-based, and alcohol-based [in particular, a hotter surface is omniphobic]; or
ion-repellent, i.e. having a charged surface repulsing an ionized gas or liquid.

In view of the foregoing description with reference to FIG. 5b, it will be evident to a person skilled in the art that the partial skin-friction static-pressure Pₛₖᵢₙ and, hence, the partial viscous-static-pressure P_{viscous} can be controlled by choosing the body walls' material and constructing the walls porosity, sponginess, and structure providing reduced difference (a_{w}−a−δa). For example, a bird's body is covered by fibrous feathers and fuzz. The fibrous feathers and fuzz, making an outer surface layer constructed substantially from the air, provide that, on the one hand, the fibrous structure improves an airflow streamlining and, on the other hand, the outer surface layer has the effective parameter a_{w} close to the van der Waals parameter a of air (normally, the air is associated with the condition for ideal gas a+δa=0). The minimized difference (a_{w}−a−δa) minimizes the viscosity effect of an imaginary boundary layer, and therefore, an improved aerodynamic property of the bird's body is expected. Furthermore, the feathers and fuzz are hydrophobic, thereby preventing the porosity from filling by water condensed from the natural humid air. Thereby, to weaken an undesired skin-friction effect, one can use a natural or artificial hydrophobic material, having a fibrous and porous structure comprising many small concavities similar to feathers and fuzz or sponge, covering a surface, contacting with humid airflow. Another example is that the greased feathers of a duck are water-repellent, i.e. hydrophobic, providing a free-slip condition for swimming.

FIG. 5c is a schematic illustration of yet another example of a constructive solution, hypothetically interpreted in accordance with the principles of the present invention, providing compensation of skin-friction resistance. A squama surface fragment 521 of fish 520 is shown also as an enlarged sectional view 522. Fish 520's skin 523 secretes hydrophobic mucus 524 retained by fish-scales 525, having a sectional profile of curved cogs. First, hydrophobic mucus 524 covers the surfaces of fish-scales 525, forming a hydrophobic outer layer as an inherent attribute of the fish body 520's hydrodynamic-surface, wherein the condition (a_{w}−a−δa)<0 provides for a free-slip motion. Moreover, protruding fish-scales 525 are configured and arranged such that hydrophobic mucus 524 repels a surrounding water portions 5271, 5272, 5273, and 5274 with repulsive forces 5281, 5282, 5283, and 5284, correspondingly, wherein repulsive forces 5281, 5282, 5283, and 5284 act cumulatively in unison along an airfoil orientation. This cumulative action, dominantly, in the backward downstream direction provides a repulsing tendency as a kind of jet-effect.

For the purposes of the present patent application, the term “phobic-repulsing jet-effect” and, in particular, the term “hydrophobic jet-effect” should be understood as the described kind of jet-effect. A parabolic profile of mucus 524's surface fragment 526 provides for an enhanced hydrophobic jet-effect. Thus, both the hydrophobic outer layer and the scaly structure provide the improved hydrodynamic property of fish 520's body.

Reference is now made to FIG. 5d, showing schematically a sectional view of a shaped wall 530, without loss of generality, oriented horizontally. Shaped wall 530 comprises a relief-structured outer layer 531, contacting with ambient water 532. Layer 531, made from a hydrophobic material, has a form of a bar with a series of teeth-like sharp and asymmetrical protrusions, thereby constituting a saw-like relief.

In view of the foregoing description with reference to FIG. 5c, it will be evident to a person skilled in the art that relief-structured outer layer 531 repels adjacent portions 5371, 5372, and 5373 of surrounding water 532 with forces 5381, 5382, and 5383 correspondingly, wherein forces 5381, 5382, and 5383 are directed dominantly horizontally. This provides a hydrophobic jet-effect that can be useful for motion in the water surrounding. In the case, wherein wall 530 is stationary, the motion of nearby portions 5371, 5372, and 5373 in the prevalent direction [in the case, dominantly horizontal], arises at the expense of the repulsing interactions between the hydrophobic material and the adjacent water portions. This means that, in the final analysis, the water portions motion in the prevalent direction occurs at the expense of the internal heat energy [warmth] of the nearby water portions.

It will be evident to a person skilled in the art that a shape of relief-structured outer layer 531, contacting with surrounding water and having an asymmetrically saw-like configured relief, can be used for transportation of water portions 5371, 5372, and 5373 along the asymmetrically saw-like configured relief, for example, the water transportation along relief-structured inner walls within a capillary tube, where originating a useful hydrophobic jet-effect in addition to so-called “capillarity effect”.

FIG. 5e is a schematic illustration of a transparent-like body having convex-concave corpus 512. Convex-concave corpus 512 has a rounded airfoil outer convex side, and concave side 514, both contacting with ambient fluid 517. A multiplicity of holes [three shown] 513.1, 513.2, and 513.3 links together both: outside portions 517.1 of the ambient fluid 517 and the ambient fluid 517's portions 517.2 contacting with concave side 514. The concavity of side 514 has a parabolic profile with focal point 516. Focal point 516 comprises a heating element [not shown here], powered at the expense of either burned fuel or electricity. Thereby, hotter focal point 516 becomes omniphobic, repelling nearby ambient fluid portions 517.2 by omniphobic-repulsive van der Waals forces. The ambient fluid molecules, subjected to the omniphobic-repulsive van der Waals forces action, acquire a prevalent component of motion directed radially from the heating element at focal point 516 toward concave parabolic side 514. When concave parabolic side 514 reflects the prevalent radial component of the molecules motion, the molecules prevalent motion component becomes collimated collinearly with sagittal axis 519, thereby forming outflowing jetstream 518. The headway motion of outflowing jetstream 518 provides for a jet-thrust. Furthermore, preferably, concave side 514 has outer layer 515 contacting with ambient fluid 517.2. The layer 515 is either heated and/or implemented from a fluid-repellent material. The parabolic profile 514 of fluid-repellent outer layer 515, further acting on the fluid molecules by phobic-repulsive van der Waals forces, partially converts the Brownian random component of the fluid molecules motion into a motion of the molecules in a prevalent direction toward sagittal axis 519, thereby, focusing [i.e. converging] and more accelerating outflowing jetstream 518, in addition to the aforementioned motion collimation.

In particular, it will be evident to a person skilled in the art that the body having convex-concave corpus 512, supplied with a heating element arranged at focal point 516, when submerged in water 517, operates as a hydrophobic-engine or hydrophobic jet-gear providing a jet-thrust, wherein one can control the jet-thrust by the heating intensity. A net-efficiency of such a hydrophobic-engine, having a configured convex-concave corpus 512, is defined by the ratio of power consumed by the heating element to the useful kinetic power of outflowing jetstream 518 headway motion. The net-efficiency may come close to 100% if a dominant headway motion of outflowing jetstream 518 is obtained by convex-concave corpus 512 shape optimization. Moreover, water portions 517.2, yet to be accumulated into outflowing jetstream 518, are also subjected to a hydrophobic jet-effect, originated by parabolic fluid-repellent layer 515, resulting in an increase of the outflowing jetstream 518 headway motion kinetic power at the expense of the water warms and thereby, in principle, allowing for the net-efficiency to become even higher than 100%. Furthermore, outflowing jetstream 518 can be further subjected to a convergence by a convergent funnel [not shown here], and thereby, become further accelerated and cooled. Thus, again, the net efficiency can exceed 100% at the expense of the water warmth.

FIG. 5f is a schematic isometry of a body 540 having a wheel-gear-like configured corpus with an overall shape, having a sectional profile similar to a circle-saw, constructed in accordance with an exemplary embodiment of the present invention. Body 540 is submerged in a fluid. The configured corpus of body 540 comprises asymmetrical teeth or teeth-like fins having concave sides, which have outer layers 541, 542, 543, 544, 545, 546, 547 and 548, made from a fluid-repellent material. For simplicity, the fluid is water, and the material is hydrophobic. The hydrophobic sides 541, 542, 543, 544, 545, 546, 547 and 548 of teeth repel the water portions 551, 552, 553, 554, 555, 556, 557 and 558 with phobic-repulsive van der Waals forces 561, 562, 563, 564, 565, 566, 567 and 568 correspondingly, wherein phobic-repulsive van der Waals forces 561, 562, 563, 564, 565, 566, 567 and 568 are directed clockwise, along a substantially-airfoil orientation of wheel-gear-like configured corpus 540. If a hydrophobicity of the teeth sides' material is strong enough, a phobic-repulsing jet-effect, caused by phobic-repulsive van der Waals forces repelling the fluid portions, is observed. The phobic-repulsing jet-effect provides a self-rotation of body 540 in the water surrounding in the inverse-clockwise direction 549 at the expense of the ambient water warmth. Thus, configured corpus 540 provides a hydrophobic jet-effect, accompanied by cooling of the ambient water. Moreover, if the effective diameter 5401 of wheel-gear-like configured corpus 540 is big enough, the momentum of the rotating forces becomes perceptible, according to the Archimedes' theory of lever.

For the purposes of the present patent application, the term “fluid-repellent jet-gear”, having a widened sense, is introduced as relating to a body submerged in a fluid, wherein the body corpus has an asymmetrically configured relief having an airfoil orientation and a layer contacting with the ambient fluid, wherein the layer is either made from a fluid-repellent material and/or comprising a heating element making the layer omniphobic, and wherein the configured relief of the “fluid-repellent jet-gear” corpus comprises asymmetrical protrusions, for example, teeth-like fins, or humps, or screwed blades, or convex-concave elements. The asymmetrical corpus is oriented such that the protrusions' fluid-repellent sides repel the fluid portions in a prevalent direction along the corpus airfoil orientation. In a particular case, the fluid is water, the fluid-repellent material is hydrophobic, and the term “hydrophobic jet-gear” or “hydrophobic-engine” is used.

In view of the foregoing description with reference to FIGS. 5c, 5d, 5e, and 5f, it will be evident to a person skilled in the art that the described specifically constructed outer layer of a fluid-repellent jet-gear corpus, contacting with the ambient fluid, is characterized by the following principle features: the outer layer comprises at least one fragment, being fluid-repellent, and that the fluid-repellent fragment's shape is asymmetrical relative to the direction of fluid motion, such that the fluid-repellent fragment repels the fluid portions in a prevalent direction along an airfoil orientation of the corpus. In the case wherein the prevalent direction is dominantly the same as the direction of the fluid motion, such a constructive solution compensates a skin-friction resistance. As well, it will be evident to a person skilled in the art that the described phobic-repulsing jet-effect is more powerful, if either the repulsive forces of the fluid-repellent material are stronger, and/or the fluid-repellent fragments of the fluid-repellent jet-gear's outer layer occupy a bigger area contacting with the ambient fluid, and/or the fluid-repellent fragment shapes are optimized to enhance the prevalent directivity of the phobic repelling. Thereby, constructive solutions, providing developed surface of fluid-repellent fragments resulting in an increased phobic-repulsing jet-effect, can provide that the increased phobic-repulsing jet-effect becomes stronger than a skin-friction resistance effect and, thereby, enables the fluid-repellent jet-gear motion at the expense of the nearby surrounding fluid matter warmth only, i.e. in an adiabatic process, the fluid portions, adjacent to the fluid-repellent jet-gear, become colder than the fluid portions, yet to be subjected to the phobic-repulsing jet-effect.

In view of the foregoing description with reference to FIG. 5f, it will be evident to a person skilled in the art that a so-called Peltier-element can be adapted to operate as a thermoelectric generator producing electricity at the expense of the temperature difference between water portions subjected and not-subjected to the described hydrophobic jet-effect.

In view of the foregoing description with reference to FIG. 5f, it will be evident to a person skilled in the art that if the ambient fluid is plasma, i.e. an ionized gas or liquid, then an electrically charged surface, repulsing ions of the ionized fluid by electrostatic forces, functions as a fluid-repellent material. In another example, a surface, being hotter than ambient fluid, functions as a fluid-repellent material.

FIG. 5g is a schematic top view of an exemplary aggregation 5600 comprising a set of many hydrophobic jet-gears submerged in water. The hydrophobic jet-gears, similar to body 540, described hereinbefore with reference to FIG. 5f, arranged in-lines and in-columns, without loss of generality, in a horizontal plane. In a more general case, also, aggregation 5600 comprises several such horizontal layers, one above the other, that are not shown here. Aggregation 5600, occupying length 5601 and width 5602, for simplicity, each equal to L, and height, equal to H and comprising several horizontal layers. Dashed curves 5603 symbolize that a number of the lines and columns is substantially greater than shown. A fragment of aggregation 5600 is shown also as an enlarged view 560, where neighbor opposite hydrophobic jet-gears 5610 and 5620 differ in directivity of corpuses' overall airfoil orientation and, in particular, in directivity of asymmetrical teeth having hydrophobic outer layers 5613 and 5623 correspondingly. Hydrophobic jet-gears 5610 repel water portions 5614 with forces 5615, directed clockwise, and hydrophobic jet-gears 5620 repel water portions 5624 with forces 5625, directed inverse-clockwise. Thereby, the neighbor opposite hydrophobic jet-gears 5610 and 5620 repel adjacent portions of surrounding water in unison. Aggregation 5600, comprising the multiplicity of relatively small hydrophobic jet-gears 5610 and 5620, provides increased cumulative area of hydrophobic outer layers 5613 and 5623 contacting with water. Thereby, the hydrophobic jet-gears 5610 and 5620 of aggregation 5600 are subjected to a cumulative phobic-repulsing jet-effect that can be estimated for the exemplary arrangement as the following. An exemplary hydrophobicity of a hydrophobic material is characterized by a hydrophobic pressure of Pₕ=50 Pa. Imaging a practically implementable hydrophobic jet-gears 5610 and 5620 having an effective diameter of D=1 cm, and comprising 8 teeth, each of gap 5604 d=1.25 mm, and thickness 5605 equal to h=2 mm, one estimates that the hydrophobic-repulsive force per one hydrophobic jet-gear 5610 or 5620 equals Fₕ=Pₕ×8×d×h=50×8×1.25×10⁻³×2×10⁻³=10⁻³ N. On the other hand, one defines the fluid resistance force, indicated by F_{drag}*, in the frames of continuum mechanics as F_{drag}*=(6πη×r)uₜ, where r is so-called Stokes's radius, uₜ is the velocity of a body relative to the considered viscous fluid, and η is the dynamic viscosity of fluid. The dynamic viscosity of water at 20° C. is approximately of 7=10⁻³ Pa×sec. In the case of rotating hydrophobic jet-gears 5610 and 5620, the value r is estimated approximately, as r≈h/2, thus, the fluid resistance force F_{drag} per one hydrophobic jet-gear 5610 or 5620 is estimated as F_{drag}≈2×10⁻⁵uₜ, wherein the velocity uₜ means the effective tangential velocity of rotating teeth 5613 and 5623. The condition Fₕ=F_{drag}* defines the reachable effective tangential velocity uₜ for the case of no-loaded rotation. So, the hydrophobic-repulsive force Fₕ=10⁻³ N can provide a relatively fast no-load rotation of hydrophobic jet-gears 5610 and 5620 corresponding to the effective tangential velocity of teeth 5613 and 5623, equal to uₜ=Fₕ/(2×10⁻⁵)≈50 m/sec.

Consider an electricity generator producing useful electricity from the surrounding water warmth, wherein a subset, composed of hydrophobic jet-gears 5610, plays the role of a stator and a subset, composed of hydrophobic jet-gears 5620, powers a rotor of the electricity generator. If the rotation of hydrophobic jet-gears 5610 and/or 5620 is loaded by the electricity generator resulting in the loaded rotation corresponding to the effective tangential velocity of teeth 5613 and/or 5623 equal to uₕ=1 m/sec, then the rotation power Wₕ, produced by the hydrophobic-repulsive force Fₕ, is of about Wₕ=(Fₕ−F_{drag})×uₕ≈10⁻³ W.

A parallelepiped having the horizontal area L×L of 10×10=100 m², and the vertical height of H=1000×h=2 m, can comprise about n=10⁹ hydrophobic jet-gears 5610 and 5620 producing the cumulative hydrophobic power of about n×Wₕ=1 MW. Thereby, such a relatively compact aggregation occupying a volume of 200 m³ can produce an industrial amount of electricity from permanently refreshed warm water.

In view of the foregoing description with reference to FIG. 5g, it will be evident to a person skilled in the art that one could implement an electricity generator comprising an aggregation of fluid-repellent jet-gears and Peltier-elements operating as thermoelectric generators producing electricity at the expense of the temperature differences caused by the phobic-repulsing jet-effect.

In view of the foregoing description with reference to FIG. 5g, it will be evident to a person skilled in the art that an electricity generator, turbo-electric or thermoelectric, comprising an aggregation of hydrophobic jet-gears could operate efficiently if the surrounding warm water is permanently either refreshed and/or consuming caloric.

FIG. 5h is a schematic isometry of a fluid-repellent propeller 570 submerged in the fluid. For simplicity and without loss of generality, describe fluid-repellent propeller 570 submerged in the fluid as hydrophobic-propeller 570 submerged in water surroundings. Hydrophobic-propeller 570 has asymmetrically screwed and oriented airfoil blades 571. For simplicity, consider a case, when asymmetrical airfoil blades 571 forcedly remain stationary. One of the primary features of hydrophobic-propeller 570 is that asymmetrically screwed and oriented airfoil blades 571, constructed in accordance with an exemplary embodiment of the present invention, have at least one side, without loss of generality, frontal side 573, having a layer, made from a strongly-hydrophobic material. As described hereinabove referring to FIGS. 5c, 5d, and 5f, this feature triggers a hydrophobic jet-effect and, thereby, originates a motion of the water sub-portions forming sub-streams 575 having the motion headway component, co-directed with sagittal axis 574, and a whirling component, caused by airfoil blades 571 asymmetries. To reduce distortions and micro-turbulences of sub-streams 575, another side of asymmetrical airfoil blades 571, hidden in FIG. 5h, is made from a weakly-hydrophobic material and/or has a fibrous and porous layer, making the layer as composed of micro-portions of water held in the pores, thereby, minimizing the difference (a_{w}−a−δa) and, hence, reducing the skin-friction resistance. Assuming an exemplary hydrophobicity of the strongly-hydrophobic material, characterized by a hydrophobic pressure of Pₕₚ=50 Pa, and considering an implementable small size of hydrophobic-propeller 570, namely, the effective diameter Dₕₚ=1 cm, one can estimate approximately that:
on the one hand, the hydrophobic-repulsive force per one hydrophobic-propeller 570, indicated by Fₕₚ, equals Fₕₚ=Pₕₚ×0.25π×Dₕₚ²=1.25π×10⁻³ N; and
on the other hand, the fluid resistance force per one hydrophobic-propeller 570, indicated by F_{drag}**, is estimated in frames of the classical hydrodynamics as F_{drag}**=(6πη×rₕₚ)uₕₚ, where rₕₚ is so-called Stokes's radius, chosen for the case as rₕₚ=Dₕₚ/2, uₕₚ is the effective local tangential velocity of sub-streams 575 relative to blades 571, and η is the dynamic viscosity of fluid. The dynamic viscosity of water at 20° C. is approximately of η=10⁻³ Pa×sec.
   The condition Fₕₚ=F_{drag}** defines the reachable effective velocity uₕₚ. So, the hydrophobic-repulsive force Fₕₚ can provide a relatively fast motion of sub-streams 575 with the effective local tangential velocity uₕₚ, equal to uₕₚ=Fₕₚ/(6πη×rₕₚ)≈42 m/sec. One can translate the effective local tangential velocity uₕₚ, into the effective velocity u₅₇₄ of sub-streams 575 headway motion along sagittal axis 574. The translation depends on the effective angle βₕₚ of asymmetrically screwed and oriented blades 571 slope relative to sagittal axis 574. The interrelation is u₅₇₄=uₕₚ Cos(βₕₚ). For instance, u₅₇₄≈5 m/sec for βₕₚ=83°. The headway motion velocity u₅₇₄ defines the hydrophobic headway repelling power per one small hydrophobic-propeller 570 as Wₕₚ=Fₕₚu₅₇₄, estimated approximately as Wₕₚ≈2×10⁻² W.

In view of the foregoing description with reference to FIG. 5h, it will be evident to a person skilled in the art that the described logic, applied to hydrophobic-propeller 570 submerged in water and thereby launching water sub-streams 575, is applicable to a propeller, similar to hydrophobic-propeller 570, but having frontal surfaces 573 comprising an outer layer, being electrically charged instead of hydrophobic, and being submerged in an ionized gas, and thereby functioning making sub-streams 575 of the ionized gas.

FIG. 5i is a schematic illustration of a stationary spiral 576 submerged in a fluid. Spiral 576 has helically coiled airfoil-profiled walls, constructed in accordance with an exemplary embodiment of the present invention. The outer surface 577 of spiral 576, is covered by a fluid-repellent material. Without loss of generality, the fluid is water and the material, covering outer surface 577, is hydrophobic, and so, spiral 576 is hydrophobic as well. Such a configuration, acting on the water surroundings by phobic-repulsive van der Waals forces, creates a helically outflowing water jetstream 578, i.e. having two components of motion, namely: headway along sagittal axis 579 and whirling. The motion occurs at the expense of the internal heat energy of water. The stationary hydrophobic spiral 576 can be interpreted as a hydrophobic-engine lunching jetstream 578.

In view of the foregoing description with reference to FIGS. 5c, 5d, 5f, 5g, 5h, and 5i, it will be evident to a person skilled in the art that hydrophobic-propeller 570 and hydrophobic spiral 576 can be interpreted as kinds of a fluid-repellent jet-gear, where asymmetrically screwed and oriented airfoil blades are used instead of primitive teeth-like fins.

In view of the foregoing description with reference to FIGS. 5c, 5d, 5f, 5g, 5h, and 5i, it will be evident to a person skilled in the art that one can implement fluid-repellent jet-gears of various configurations, for example, having an overall shape in a form of either a saw, or a circle-saw, or a spiral staircase, or a propeller, or a screw of Archimedes.

### Rational Explanation of Origin of Life

In view of the foregoing description with reference to FIG. 5i, where an asymmetrical spiral, having a form of the Archimedean screw and having a hydrophobic surface, originates a helical motion of fluid, one expects that, contrariwise, if the asymmetrical spiral, having a hydrophobic surface, is decomposed into many separate chiral particles having a hydrophobic side and being submerged in water, where being arranged and oriented randomly, like a suspended matter, then the water, forcedly and certainly helically-flowing around the separate chiral particles, has a predominance to organize the chiral particles into the mentioned asymmetrical spiral in the form of the Archimedean screw, while other particles, geometries of which are not in a conformance with the water motion, remain not organized into a spiral. Thus, in accordance with the principles of the present invention, a mechanism, providing a regularized aggregation of separate left-handed stereoisomers of amino acids into a coiled sequence thereby forming a ribonucleic acid (RNA) molecule, hypothetically, can be specified and implemented artificially. Furthermore, a certain, forced spatial distribution of water flow velocities can provide for that right-handed stereoisomers of amino acids become aggregated in an orderly manner into a nonexistent inversely-screwed right-chiral molecule, which is mirror-symmetrical to a natural RNA.

Reference is now made to FIG. 5j, a schematic illustration of a pair of hydrophobic-propellers: 570 and 580. Hydrophobic-propeller 570 is the same as shown and described hereinabove referring to FIG. 5h. All reference numerals 571, 573, 574, and 575 are the same as described referring to FIG. 5h. Hydrophobic-propeller 580 has stationary airfoil blades 581, asymmetrically screwed and oriented relative to sagittal axis 584. An imaginary compound of blades 571 and sagittal axis 574 is mirror-symmetrical to an imaginary compound of blades 581 and sagittal axis 584. The chiral compounds are arranged sequentially such that sagittal axes 574 and 584 are collinear. Analogous to the case of blades 571, frontal side 583 of blades 581 is covered with a layer, made from a strongly-hydrophobic material; while, to reduce distortions and micro-turbulences of sub-streams 585, another side of asymmetrical airfoil blades 581, hidden in FIG. 5h, is made from a weakly-hydrophobic material and/or has a fibrous and porous layer, making the layer, contacting with ambient water, as composed of micro-portions of water held in the pores, thereby, minimizing the difference (a_{w}−a−δa) and, hence, reducing the skin-friction resistance. Airfoil blades 581, triggering a hydrophobic jet-effect, accelerate the water sub-portions forming sub-streams 585 having the motion headway component, co-directed with sagittal axis 584, and a whirling component. As asymmetrical blades 571 and 581 are mirror-symmetrical, the whirls of sub-portions 575 and 585 are in mutually-opposite directions; and as sub-streams 585 are the downstream-continuations of sub-streams 575, the whirls of sub-streams 575 and 585 become mutually-suppressed. Thus, the chiral compounds, being mutually complemental and pushing water forward, create resulting jetstream 588, having dominant headway motion originated by the blades frontal sides hydrophobicity and at the expense of the water warmth. The pair of chiral hydrophobic-propellers 570 and 580 can be considered as a whole and be interpreted as a hydrophobic-engine 590 lunching jetstream 588. Wherein the power, indicated by W₅₈₈, of jetstream 588, launched by small hydrophobic-engine 590, having the effective diameter D=1 cm, is higher than 2Wₕₚ, because the mutually-suppressed and therefore reduced power of sub-streams 575 and 585 whirls is at least partially transformed into the power of jetstream 588 headway motion.

FIG. 5k is a schematic illustration of a stationary pair of unbroken chiral spirals having shapes of the Archimedean screws, briefly, screws 592 and 593 having helically coiled airfoil-profiled walls, constructed in accordance with an exemplary embodiment of the present invention. Screws 592 and 593 have a common sagittal axis 594 and differ in direction of coiling: clockwise and inverse-clockwise from a frontal point of view. Chiral screws 592 and 593 are submerged in a fluid. The outer surfaces 596 and 597 of chiral screws 592 and 593, correspondingly, are covered by a fluid-repellent material. Without loss of generality, the fluid is water and the material, covering outer surfaces 596 and 597, is hydrophobic. Such a configuration, acting on the water surroundings by phobic-repulsive van der Waals forces, creates an outflowing water jetstream 595 moving dominantly along sagittal axis 594, wherein the whirling component of the motion is suppressed. Again, the motion occurs at the expense of the water warmth. The stationary pair of chiral screws 592 and 593 can be considered as a whole and be interpreted as a hydrophobic-engine 591 lunching jetstream 595.

In view of the foregoing description with reference to FIGS. 5h, 5i, 5j, and 5k, it will be evident to a person skilled in the art that hydrophobic-engines 590 and/or 591 can be supplied with a Peltier element, capable of operating as a thermoelectric generator producing electricity from the temperature difference caused by the hydrophobic jet-effect. As well, if asymmetrical airfoil blades 571 and/or 581 and/or 592 and/or 593 are capable of rotation, then the hydrophobic-repulsive force Fₕₚ results in rotations of the asymmetrical airfoil blades, and hydrophobic-propellers 570 and 580, as well as hydrophobic-engines 590 and/or 591 can be applied to electricity generation using a turbine-generator.

In view of the foregoing description with reference to FIGS. 5e, 5h, 5i, 5j, and 5k, it will be evident to a person skilled in the art that hydrophobic-engines 512 and/or 590 and/or 591 can be cascaded sequentially and in-parallel, and a big submarine can be supplied with an aggregated jet-engine, composed of many small hydrophobic-engines 512 and/or 590 and/or 591 and thereby providing a substantial cumulative jet-thrust.

### Aerodynamic and Hydrodynamic Effects

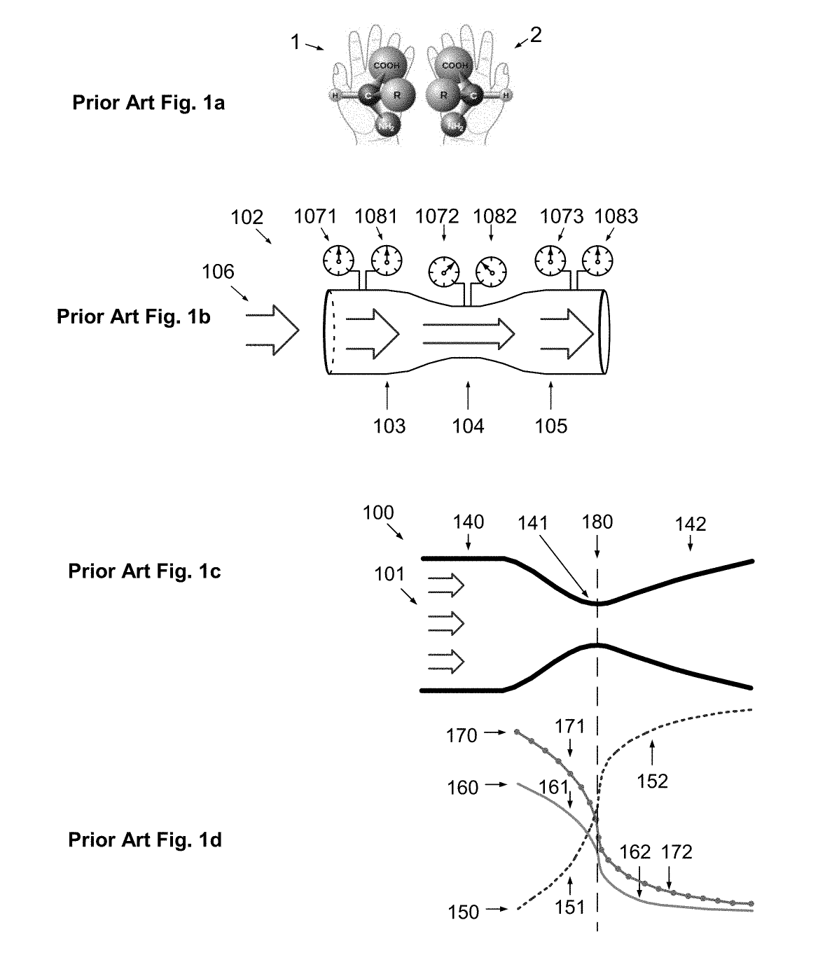

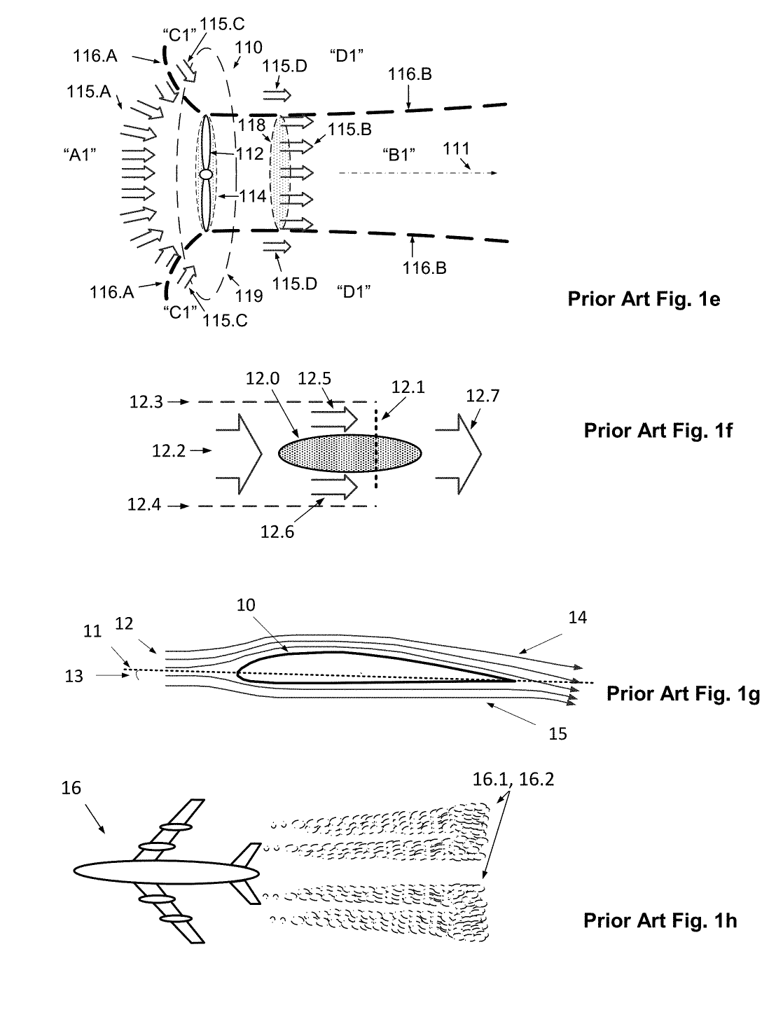

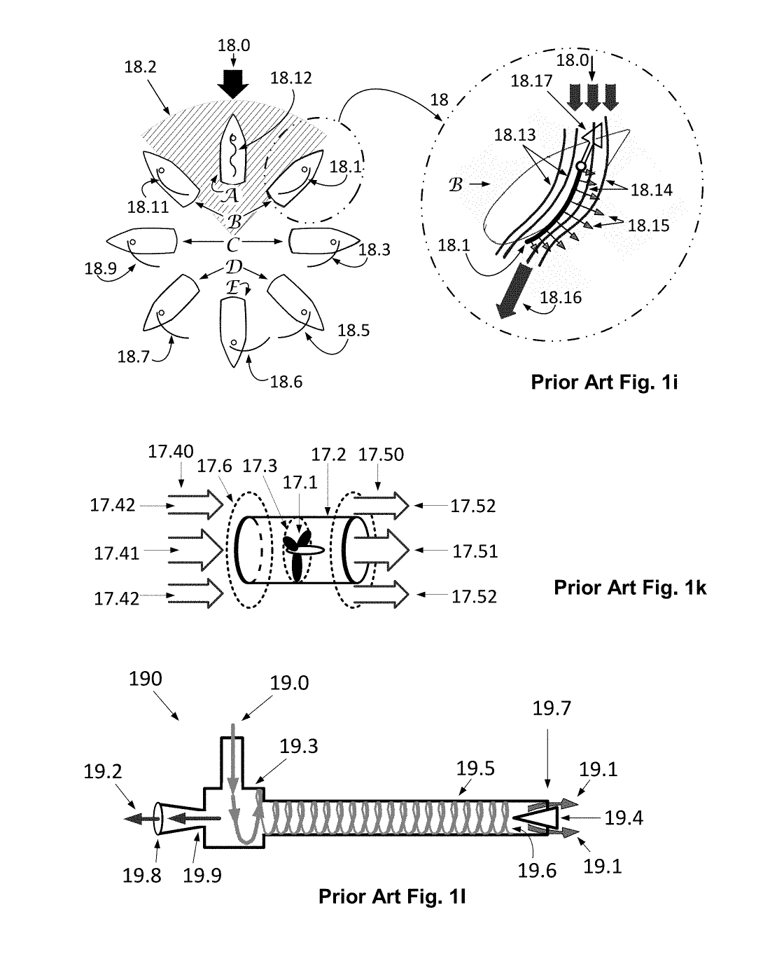

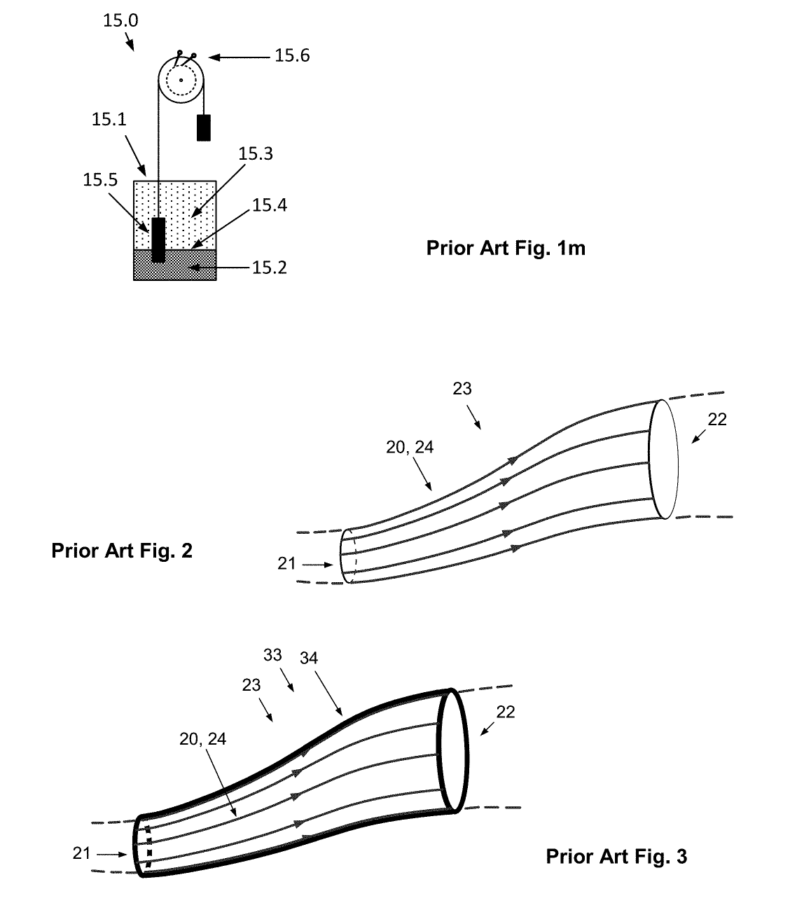

In view of the foregoing description with reference to FIGS. 4, 5a, 5b, 5c, 5d, 5e, 5h, 5i, 5j, and 5k, it will be evident to a person skilled in the art that, considering flow as moving molecular fluid, when a flow portion is flowing around a body, the flow portion and body become subjected to the following main aerodynamic and hydrodynamic effects, differing in mechanism of originating:
stagnation of the flow portion impacting the body resulting in drag of the body;
sticking of the flow portion to the body resulting in skin-friction;
attracting and thereby redirecting of the flow portion to a smoothly curved body surface, i.e. the Coanda-effect as a kind of jet-effect, resulting in a lift-force acting on the body;
convective (i.e. jet-effect) self-acceleration, resulting in thrust acting on the body, wherein the thrust is vectored against the flow portion acceleration and hence, against the flow portion headway motion;
an adiabatic compression and/or extension acting on the body by the static pressure and temperature variations, both changing adiabatically;
the turbulence of the flow portion, swirling and vibrating the body and ambient surroundings;
diffusion, interrelated with the osmotic-like partial pressure, resulting in penetrating the flow portion into the ambient molecular fluid and, vice-versa, in entrapping the ambient molecular fluid by the flow portion (this effect is also frequently called the Coanda-effect); and
hydrophobicity of the body, resulting in repelling the flow portion and thereby originating the hydrophobic jet-effect.
   All the effects contribute in the cumulative-inner-static-pressure acting on the boundaries of the flow portion. As the effects differ in mechanism of originating, the proportion of the mentioned effects action intensity may vary, depending on both: a geometry of the body and a velocity of the flow. In a certain situation, when the body has an airfoil shape, the component of thrust may exceed the drag and skin-friction, thereby providing a positive net thrust against the flow, as it occurs, for example, with a sailboat, when a point of sail belongs to the “close-hauled” group “ [symbol] ”, as described hereinabove with reference to FIG. 1i.

### Convergent-Divergent Jet-Nozzle

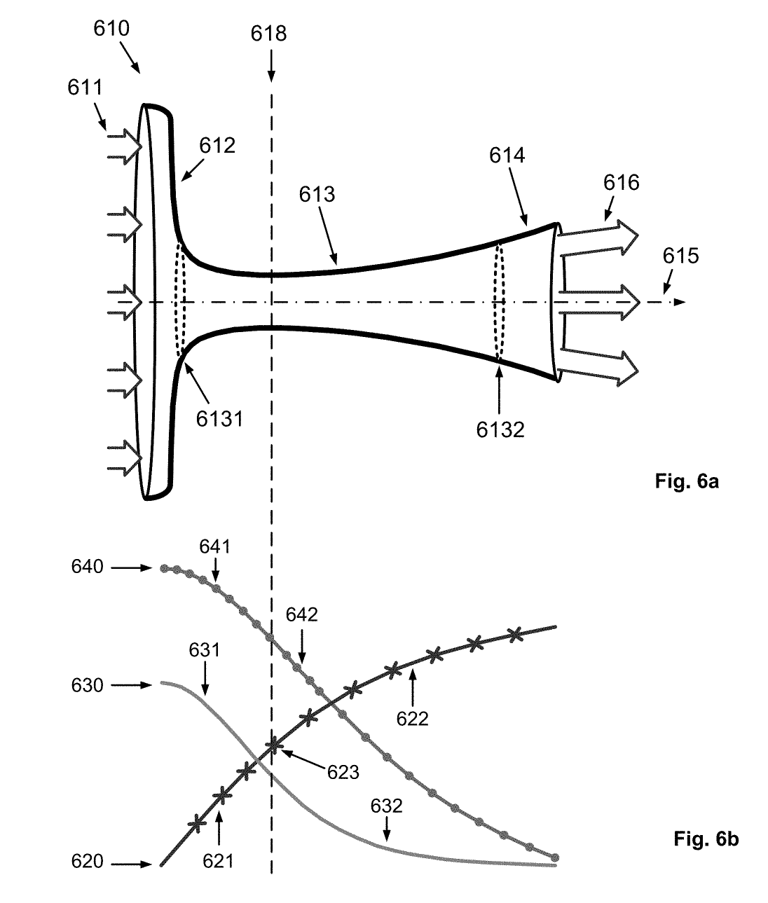

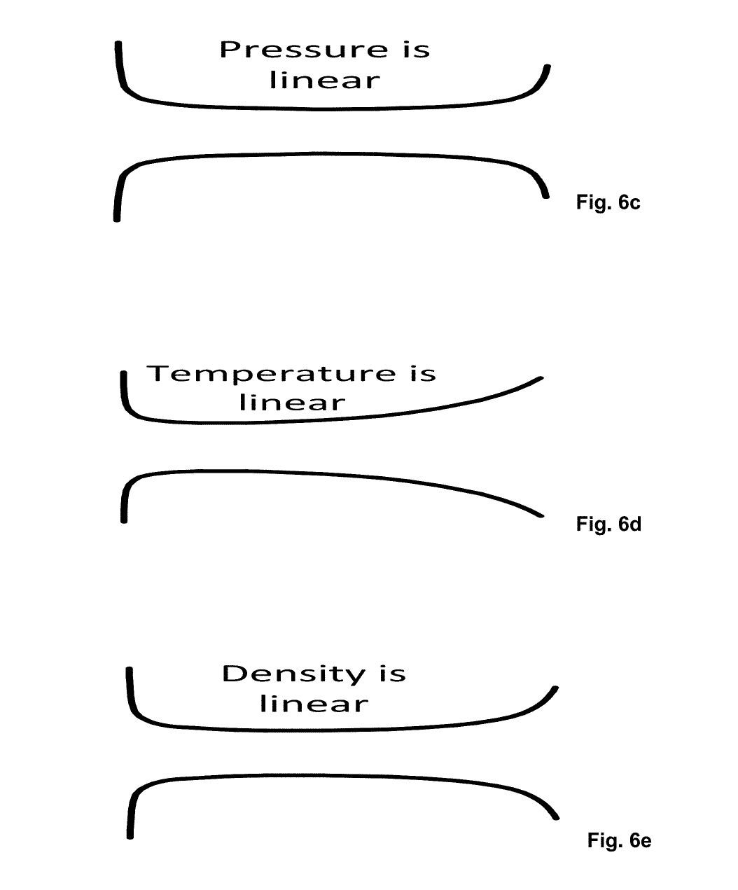

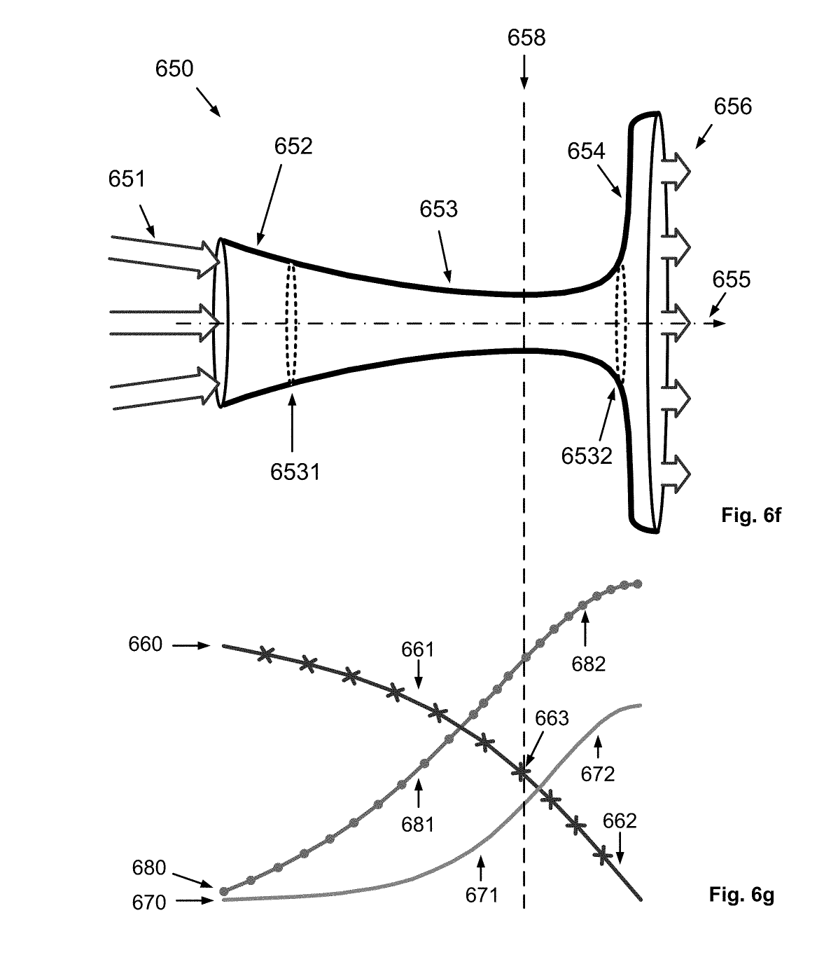

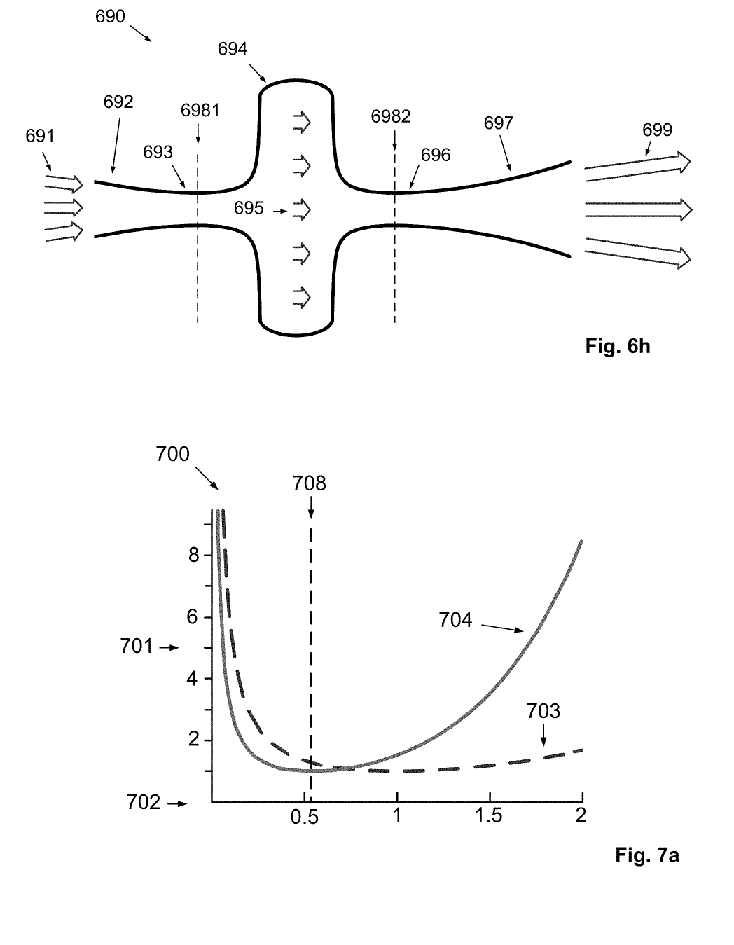

FIG. 6a is a schematic illustration of a convergent-divergent jet-nozzle 610, pipe-section in a sagittal plane. Convergent-divergent jet-nozzle 610 is applied to accelerate a compressed and hot air stream, or more general, a laminarly flowing compressed and hot compressible-expandable fluid 611. Convergent-divergent jet-nozzle 610 has the inner tunnel opposite walls shaped, for simplicity, axis-symmetrically around an imaginary sagittal x-axis 615, as a convergent funnel 612 having open inlet, narrow throat 613 comprising point 618 of the narrowest cross-section, and divergent exhaust tailpipe 614 having open outlet, constructed according to an exemplary embodiment of the present invention providing the improved de Laval jet-effect. For simplicity, compressed and hot fluid stream 611 has a uniform front at the inlet.

For the purposes of the present patent application, the de Laval effect should be understood in a wide sense as comprising both: the de Laval jet-effect, defined as an effect of flow extra-acceleration, and the de Laval retarding-effect, defined as an effect of flow extra-slowing. Thus, the de Laval jet-effect is a particular case of the de Laval effect.

The specifically shaped tunnel, comprising the three major successive constituents: convergent funnel 612 having an open inlet, narrow throat 613, and divergent exhaust tailpipe 614 having an open outlet, has not real separation features between the constituents. For the purpose of the present patent application, narrow throat 613 is specified as a fragment of the inner tunnel located between imaginary inlet 6131 and outlet 6132. For the purposes of the present patent application, the term “principal interval” of the x-axis is introduced as corresponding to the interval occupied by the specifically shaped tunnel, i.e. at least comprising narrow throat 613.

Fluid stream 611 is subjected to the Coanda-effect, observed as aligning of fluid stream 611 with the curvature of specifically shaped walls of the inner tunnel. The Coanda-effect is defined by a non-zero partial pressure-“c” P_{c} arising when the shape of a fluid portion is varying as the fluid portion moves along the shaped inner tunnel of convergent-divergent jet-nozzle 610. Looking ahead, point out that the specific shape of tunnel, constructed according to the principles of the present invention, prevents disturbances of the fluid motion. This stipulation corresponds to the case when the cumulative-inner-static-pressure P of streaming fluid 611 is varying gradually and the velocity of streaming fluid 611 is varying linearly as the fluid 611 moves within the shaped tunnel along imaginary sagittal x-axis 615.

For simplicity, imaginary sagittal x-axis 615 is horizontal, i.e. moving fluid 611 does not change its effective height above the Earth's ocean surface level. Thus, equations (5.6) and (5.7) for a stationary laminar flow can be written as (6.1) and (6.2) correspondingly:

udu+dQ=a Eq. (6.1),

uρA=C=Const Eq. (6.2),

where C is a constant associated with the considered fluid portion, and values A, u, and ρ are associated with the flow cross-section: A is the flow cross-section area, u is the flow velocity, and ρ is the fluid density. Introduce value of volume of unit mass v, defined as v=1/ρ.

The fluid characteristic heat portion per unit mass is defined as Q=P/ρ=Pv, so dQ=vdP+Pdv, where P=Pᵢₙ=Pₛ+P_{drag}+P_{viscous}. Therefore, equation (6.1) can be represented as

udu+vdP+Pdv=0 Eq. (6.3a).

Dividing (6.3a) by Pv, one obtains:

$$\frac{udu}{P v} + \frac{dP}{P} + \frac{dv}{v} = 0 , \qquad Eq . ( 6.3 b )$$

and so,

$$\frac{dv}{v} = - \frac{udu}{Pv} - \frac{dP}{P} . \qquad Eq . ( 6.3 )$$

Rewrite equation (6.2) as:

uA=Cv Eq. (6.4a).

and further in differential form as:

Adu+udA=Cdv Eq. (6.4b).

Divide the left and right sides of (6.4b) by the left and right sides of (6.4a) correspondingly:

$$\frac{du}{u} + \frac{dA}{A} = \frac{dv}{v} . \qquad Eq . ( 6.4 )$$

Referring to equation (5.8a) for a real molecular fluid undergoing a reversible adiabatic process, one can write: Pv^{γ}=Const, or in differential form:

v^{γ}dP+γPv^{γ-1}dv=0 Eq. (6.5a).

Dividing (6.5a) by γPv^{γ}, one obtains:

$$\frac{dv}{v} = - \frac{dP}{γ P} . \qquad Eq . ( 6.5 )$$

Comparing (6.5) and (6.3), one can write:

$$- \frac{udu}{Pv} - \frac{dP}{P} = - \frac{dP}{γ P} , \qquad Eq . ( 6.6 a )$$

i.e.

$$- \frac{udu}{Pv} \frac{γ u}{γ u} = - \frac{dP}{γ P} + \frac{γ}{γ} \frac{dP}{P} . \qquad Eq . ( 6.6 b )$$

The denominator of the left side of (6.6b) comprises value (γPv) that defines velocity of sound via equation u_{sound}=\sqrt{γPv}, so (6.6b) can be rewritten as:

$$- \frac{γ {u}^{2}}{{u}_{sound}^{2}} \frac{du}{u} = \frac{( γ - 1 ) d P}{γ P} . \qquad Eq . ( 6.6 c )$$

Introducing the value M=u/u_{sound} having the meaning of the fluid portion velocity measured in Mach numbers, i.e. M-velocity, (6.6c) can be written as:

$$- γ {M}^{2} \frac{du}{u} = \frac{( γ - 1 ) dP}{γ P} . \qquad Eq . ( 6.6 )$$

Now comparing (6.5) and (6.4), one gets:

$$\frac{dP}{γ P} = - \frac{d A}{A} - \frac{du}{u} . \qquad Eq . ( 6.7 )$$

Substituting the expression for dP/γP from (6.7) into (6.6), one obtains:

$$- γ {M}^{2} \frac{du}{u} = ( γ - 1 ) ( - \frac{dA}{A} - \frac{du}{u} )$$

and after simple algebraic transformations one formulates:

$$\frac{dA}{A} = ( \frac{γ}{γ - 1} {M}^{2} - 1 ) \frac{du}{u} . \qquad Eq . ( 6.8 )$$

Equation (6.8) comprises the term M²γ/(γ−1) characterizing the effect of the gas compressibility and expandability. Equation (6.8) differs from equation (1b) derived from the Euler equations applied to an ideal fluid defined in frames of the continuum mechanics. In particular, equation (6.8) says that: if the horizontally moving flow is relatively slow (i.e. M<\sqrt{(γ−1)/γ}), then the narrowing of the flow cross-section (i.e. negative dA) corresponds to acceleration of the flow (i.e. positive du); and if the flow is relatively fast (i.e. M>\sqrt{(γ−1)/γ}), then just the widening of the flow cross-section (i.e. positive dA) corresponds to acceleration of the flow (i.e. positive du). This means, in particular, that at so-called “critical condition” point 680 defined for the narrowest throat of the de Laval nozzle, the flow specific M-velocity equals

M_{*}=\sqrt{(γ−1)/γ} Eq. (6.9).

For the purposes of the present patent application, here and further, the lower index “*” is applied to an M-velocity, geometrical and thermodynamic parameters in a critical condition point.

For air as a diatomic molecular gas, the generalized adiabatic compressibility parameter γ equals γ=7/5=1.4, and M_{*}=\sqrt{(γ−1)/γ}≈0.5345 Mach but not 1 Mach as follows from (1b). For a gas composed of multi-atomic molecules, the generalized adiabatic compressibility parameter γ is closer to 1, and so the de Laval jet-effect is expected at lower M-velocities. In a particular case of an almost incompressible liquid, the generalized adiabatic compressibility parameter γ is extremely great and equation (6.8) comes close to classical equation (1 b), for which M_{*}=1 Mach.

In many actual and imaginary applications the phenomenon of shock sound-wave emission, that arises at M-velocities near 1 Mach, is undesirable or unacceptable. Therefore, the conclusion of resulting equation (6.8), that the de Laval jet-effect begins from the velocity being substantially lower than the speed of sound, becomes important to provide for a utilization of this useful effect avoiding the phenomenon of shock sound-wave emission.

Now consider the case where a compressed and/or heated gas, defined by the stagnation parameters: pressure P₀, density ρ₀, and temperature T₀, is launching into a convergent-divergent jet-nozzle. Let the stagnation pressure P₀, temperature T₀, and density ρ₀ be much high to provide the specific M-velocity M_{*}=\sqrt{(γ−1)/γ} at the narrowest cross-section of the throat. The gas characteristic heat portion per unit mass, expressed in terms of the gas temperature, is: Q=RT. Substitution of this expression into (6.1) gives:

$${T}_{0} = T + \frac{{u}^{2}}{2 R} = T ( 1 + {M}^{2} \frac{γ}{2} ) \qquad Eq . ( 6.10 )$$

where T₀ is the stagnation temperature; T is the gas portion current temperature; u_{sound}=\sqrt{γPv}=\sqrt{γRT}, and M=u/u_{sound}=u/\sqrt{γRT}. Though the normalized value M depends on temperature, one retains the form of equation (6.10) expressed via M, because the value of M=1 Mach has the physical sense of the shock sound-wave emission condition. Taking into account relations between thermodynamic parameters in an adiabatic process, equation (6.10) can be rewritten as:

$$\frac{{T}_{0}}{T} = {( \frac{{P}_{0}}{P} )}^{\frac{γ - 1}{γ}} = {( \frac{{ρ}_{0}}{ρ} )}^{γ - 1} = 1 + {M}^{2} \frac{γ}{2} \qquad Eq . ( 6.11 )$$

where P and ρ are the current static pressure and density correspondingly.

It is important to introduce the ratio A/A_{*}, where A_{*} is the narrowest cross-sectional area of the nozzle throat, i.e. is the critical condition area corresponding to the critical condition point, and A is the current cross-sectional area. It follows from (6.2) that

$$\frac{A}{{A}_{*}} = \frac{{ρ}_{*}}{ρ} \frac{{u}_{*}}{u} \qquad Eq . ( 6.12 )$$

Taking into account (6.11) and that the specific M-velocity equals M_{*}=\sqrt{(γ−1)/γ}, the ratio A/A_{*} can be expressed via M-velocity:

$$\frac{A}{{A}_{*}} = \frac{1}{M} {( \frac{γ - 1}{γ} )}^{\frac{1}{2}} {( \frac{2 + γ {M}^{2}}{γ + 1} )}^{\frac{γ + 1}{2 ( γ - 1 )}} \qquad Eq . ( 6.13 )$$

Equation (6.13) is the equation of principle, bonding the generalized adiabatic compressibility parameter γ, M-velocity M, and ratio A/A_{*} of the molecular fluid, fast and laminarly flowing through the de Laval nozzle, oriented horizontally. Equation (6.13) differs from equation (1) derived basing on the Euler equations applied to an ideal fluid defined in frames of the continuum mechanics. Equation (6.13), as one of the primary teachings of the present invention, says that to accelerate a warmed and compressed air portion up to 1 Mach, one must apply a convergent-divergent jet-nozzle and provide the nozzle inner tunnel divergent part expansion up to the ratio of A/A_{*}≈1.5197. Considering an essential M-velocity range, specified as an M-velocity range comprising M-velocities corresponding to the flow passing through the principal interval, equation (6.13) can be applied to make an ideal shape of the nozzle to provide for a laminar motion and thereby optimize the acceleration of the streaming fluid at least in the essential M-velocity range, i.e. at least within the specifically shaped tunnel. In contrast to the prior art concept of rapid expansion and acceleration of the gas, described hereinbefore with reference to FIGS. 1c and 1d, that causes the arising of undesired Mach waves, the substantially gradual (or linear) increase of the M-velocity downstream along the gas motion accompanied by the interrelated gradual (or linear) change of fluid thermodynamic parameters, is a criterion of the nozzle inner tunnel shape optimization preventing turbulences and, in particular, providing suppression of the undesired Mach waves, according to an exemplary embodiment of the present invention.

Further, for the purposes of the present patent application, a use of the equation of principle (6.13) assumes an inherent condition of a gradual change of the fluid thermodynamic parameters. So, axis-symmetrical convergent-divergent jet-nozzle 610, comprising specifically shaped convergent funnel 612 having an open inlet, narrow throat 613, and divergent exhaust tailpipe 614 having an open outlet, is designed according to equation (6.13), where the value M corresponds to x-coordinates along imaginary x-axis 615 as a smooth function M(x). In particular, a linear function M̅(x) was chosen as a desired for M(x), i.e.

M(x)=M̅(x)=M_{*}+α_{M}(x−x_{*}), where x is the x-coordinate at x-axis 615, and α_{M} is a positive constant defining a scale factor and having a sense of constant gradient of M-velocity spatial distribution, i.e. α_{M}=∂M̅(x)/∂x. Such a relationship enables a substantially smoothed increase of M-velocity as the fluid moves through the specifically shaped tunnel of convergent-divergent jet-nozzle 610. The linear increase of M-velocity prevents substantially the arising of streaming fluid 611 motion disturbances, accompanied by shock waves.

In contrast to a jump-like sharp slope, the gradual change of the M-velocity and so of all the interrelated thermodynamic parameters is one of the primary features of the de Laval jet-effect improvement.

For the purposes of the present patent application, the term “de Laval enhanced jet-effect” or briefly: “enhanced jet-effect” is introduced as relating to the modified de Laval jet-effect, occurring in a convergent-divergent tunnel having a specifically revised shape according to the principles of the present invention, such that the modified de Laval jet-effect becomes improved by smoothing of the fluid thermodynamic parameters spatial distribution, providing the following beneficial features:
smoothing of the flowing fluid M-velocity, providing suppression of the undesired flow disturbances accompanied by shock waves;
smoothing of the flowing fluid static pressure, providing suppression of the undesired Mach waves and, thereby, suppression of nearby body vibrations;
smoothing of the flowing fluid temperature, providing suppression of adjacent surface tensions; and smoothing of the flowing fluid density, providing suppression of shock waves.
   Also, the term “de Laval-like jet-effect” should be understood in a wider, sense including a case when an enhanced jet-effect occurs in an open space imaginarily bordered by the flow streamlines, wherein the imaginary borders constitute a convergent-divergent shape, i.e. similar to a de Laval nozzle.

If the exhaust tailpipe 614's outlet area is Aₑ, the ratio Aₑ/A_{*} defines the nozzle expansion ratio that can be optimized in accordance with the estimations described herein below with reference to FIGS. 7a, 7b, 7c.

Thereby, a convergent-divergent jet-nozzle, constructed applying equation (6.13) according to an exemplary embodiment of the present invention, allows a use of the de Laval enhanced jet-effect to accelerate incoming compressed and hot airstream 611 moving with low M-velocities to obtain outflowing accelerated and cooled jetstream 616, reaching high M-velocities [i.e. M-velocities, higher than the specific M-velocity M_{*}=\sqrt{(γ−1)/γ}], in particular, high-subsonic velocities.

FIG. 6b, in conjunction with FIG. 6a, is a schematic graphic illustration of the distribution of the flowing fluid 611's three parameters: velocity 620, static pressure 630, and temperature 640 along the length of nozzle 610, constructed according to the principles of a preferred embodiment of the present invention. The narrowest cross-section of the throat 613 (FIG. 6a) provides the “critical condition” point 618. Compressed and hot fluid 611 flows through throat 613, where the velocity picks up 621 such that M-velocity reaches the specific M-velocity M_{*}=\sqrt{(γ−1)/γ} 623 at the critical condition point 618. Ahead of the critical condition point 618, the pressure and temperature fall, correspondingly 631 and 641. Hot flowing fluid 611 crosses the critical condition point 618 and enters the widening stage of throat 613 and further divergent exhaust tailpipe 614 having an open outlet. Flowing fluid 611 expands there, and this expansion is optimized such that the extra-increase of M-velocity 622 is substantially smoothed; and the pressure and temperature extra-decrease, 632 and 642, correspondingly, are substantially smoothed as well, in contrast to that at the critical condition point 180 with reference to the classic prior art rocket nozzle 100 of FIGS. 1c, 1d. The smoothed change of static pressure 630 provides a suppression of unwanted Mach waves. In practice, the suppression of Mach waves provides a suppression of undesired vibrations that, in particular, especially important for fast accelerating vehicles.

In view of the foregoing description referring to FIG. 6a, it will be evident to a person skilled in the art that one can use different criteria of a gradualness of M(x) for different preferred optimizations of the convergent-divergent shape of a tunnel. Namely:
if suppression of Mach waves and of body vibrations are the most preferable, then M(x) should be given as the function
   M(x)={square root over (2{[P₀/P̅(x)]^{(γ-1)/γ}−1}/γ)}, where P̅(x) is a linear function of the static pressure vs. x-coordinate: P̅(x)=P_{*}+α_{P}(x−x_{*}), P_{*} is the static pressure of the flowing fluid at the critical condition point x_{*}, and α_{P}=∂P̅(x)/∂x is a constant gradient of the static pressure distributed along the x-axis within a specially shaped tunnel; and FIG. 6c is a schematic illustration of an exemplary profile of an optimized specifically shaped tunnel providing a linear change of the flowing fluid static pressure corresponding to the essential M-velocity range comprising M-velocities from 0.02 up to 2 Mach;
if the suppression of temperature jumps is the most preferable, then M(x) should be given as the function
   M(x)=\sqrt{2{[T₀/T̅(x)]−1}/γ}, where T̅(x) is a linear function of the fluid temperature vs. x-coordinate: T̅(x)=T₀+α_{T}(x−x_{*}), T_{*} is the temperature of the flowing fluid at the critical condition point x_{*}, and α_{T}=∂T̅(x)/∂x is a constant gradient of the fluid temperature distributed along the x-axis within a specially shaped tunnel; and FIG. 6d is a schematic illustration of an exemplary profile of an optimized specifically shaped tunnel providing a linear change of the flowing fluid temperature corresponding to the essential M-velocity range comprising M-velocities from 0.02 up to 2 Mach; and
if a trade-off between suppressions of Mach waves and temperature jumps is preferable, then M(x) should be given as the function
   M(x)={square root over (2{[ρ₀/ρ̅(x)]^{(γ-1)}−1}/γ)}, where ρ̅(x) is a linear function of the fluid density vs. x-coordinate: ρ̅(x)=ρ₀+α_{ρ}(x−x_{*}), ρ_{*} is the density of said flowing fluid at the critical condition point x_{*}, and α_{ρ}=∂ρ̅(x)/∂x is a constant gradient of the fluid density distributed along the x-axis within a specially shaped tunnel; and FIG. 6e is a schematic illustration of an exemplary profile of an optimized specifically shaped tunnel providing a linear change of the flowing fluid density corresponding to the essential M-velocity range comprising M-velocities from 0.02 up to 2 Mach.

Furthermore, it will be evident to a person skilled in the art that one can optimize the specifically shaped tunnel of convergent-divergent jet-nozzle 610 providing such a conformity of the cross-sectional area of the open inlet with the M-velocity of flowing fluid crossing the open inlet, that the flowing fluid M-velocity is substantially smooth at the entering the open inlet. Moreover, one can control the cross-sectional area of the open inlet, according to the equation of principle, providing conformity of the open inlet cross-sectional area with the variable M-velocity of the entering flowing fluid afore-and-nearby the open inlet. This may become important, for example, to suppress vibrations of a fast accelerating vehicle.

Moreover, it will be evident to a person skilled in the art that, as soon as the de Laval effect occurs in an adiabatic process, the condition of fluid stream 611 motion through the narrowest cross-section of throat 613 at critical condition point 618 with the specific M-velocity M_{*}=\sqrt{(γ−1)/γ} 623, accompanied by thermodynamic parameters: static pressure P_{*}, temperature T_{*}, and fluid density ρ_{*}, interrelates with a condition of fluid stream 611 motion with an M-velocity and accompanied thermodynamic parameters static pressure P, temperature T, and fluid density ρ at any cross-section of convergent-divergent jet-nozzle 610's inner tunnel, wherein the conditions interrelation depends on the tunnel geometry only. In other words, if a hypothetic propeller pushing an hypothetic inviscid fluid provides the inviscid fluid laminar flow with the specific M-velocity M_{*}=\sqrt{(γ−1)/γ} at the critical condition point of a de Laval nozzle, then the de Laval effect becomes triggered in the de Laval nozzle, wherein the thermodynamic parameters of the moving inviscid fluid portions are interrelated as in an adiabatic process. In this case, the hypothetic propeller triggering the de Laval effect expends power for the launching of accompanying shock and/or Mach waves only.

In view of the foregoing description referring to FIG. 6a, it will be evident to a person skilled in the art that, in a more general case, when imaginary sagittal axis 615 is oriented at least partially in the vertical direction in the Earth's gravitational field, the equation of principle should be corrected becoming different from equation (6.13) by a component depending on the gravitational acceleration g, namely:

$$\frac{A}{{A}_{*}} = \frac{{M}_{*}}{M} {( \frac{1 + \frac{γ}{2} {M}^{2} + \frac{g}{RT} Δ z}{1 + \frac{γ}{2} {M}_{*}^{2}} )}^{\frac{γ + 1}{2 ( γ - 1 )}} , \qquad Eq . ( 6.14 )$$

where Δz is a change of the flow effective height with respect to the critical condition point. It will be further evident to a person skilled in the art that, when the considered temperatures and M-velocities are sufficiently high to provide for the conditions: gΔh/RT<<1 and gΔh/RT<<γM²/2 to be satisfied, a use of the equation of principle in the form of equation (6.13) becomes justified.

In view of the foregoing description referring to FIG. 6a, it will be evident to a person skilled in the art that, taking into account molecular interactions for flowing liquid or plasma, for which changes of the partial deep-stagnation pressure-“a” δPₐ become at least noticeably distributed in space, the generalized adiabatic compressibility parameter γ in the equation of principle (6.13) is not a constant, but varies with the changes of the partial deep-stagnation pressure-“a” δPₐ, in a conformance with equations (5.8b) and (5.8c).

In view of the foregoing description referring to FIGS. 5a, 5b, and 6a, it will be evident to a person skilled in the art that, according to the kinetic theory of matter, a hypothetical absolutely incompressible molecular fluid, characterized by not changeable thermodynamic parameters: density, temperature, and inner-static-pressure and characterized by the infinitely great generalized adiabatic compressibility parameter γ→∞, cannot change its cross-sectional area, and so, according to equation (6.13), cannot flow laminarly through a horizontal tunnel having a varying cross-sectional area. This is a theoretically important teaching of the present invention.

In view of the foregoing description referring to FIG. 6a, it will be evident to a person skilled in the art that, if the flowing molecular fluid is an ionized gas, i.e. plasma, controlled by an external magnetic field, then the specifically shaped walls of tunnel can be imaginary, formed by streamlines of the flowing plasma subjected to and controlled by an action of the magnetic field.

### De Laval Retarding-Effect

FIG. 6f is a schematic illustration of an inverse convergent-divergent jet-nozzle 650, pipe-section in a sagittal plane. Convergent-divergent jet-nozzle 650, constructed according to the principles of a preferred embodiment of the present invention, as inverse de Laval nozzle, applied to retard a fast fluid-flow 651, streaming with a high M-velocity M₆₅₁, higher than the specific M-velocity M_{*}=\sqrt{(γ−1)/γ}. Convergent-divergent jet-nozzle 650 has the sectional shape mirror-symmetrically congruent to the sectional shape of convergent-divergent jet-nozzle 610, shown in FIG. 6a, and oriented to oncoming fluid-flow 651 in the back direction. Namely, the shape is axis-symmetrical around an imaginary sagittal axis 655; convergent funnel 652 having open inlet is as inverse divergent exhaust tailpipe 614; narrow throat 653 comprises point 658 of the narrowest cross-section; and divergent exhaust tailpipe 654 is as inverse convergent funnel 612. Convergent funnel 652, narrow throat 653, and divergent exhaust tailpipe 654 have not real separation features between them. For the purpose of the present patent application narrow throat 653 is specified as a fragment of the inner tunnel having imaginary inlet 6531 and outlet 6532, wherein the term “principal interval” of x-axis has a sense as corresponding to the interval occupied by the specifically shaped tunnel, i.e. at least comprising narrow throat 653.

FIG. 6g, in conjunction with FIG. 6f, is a schematic graphic illustration of the distribution of the fluid 651's three parameters: velocity 660, static pressure 670, and temperature 680 along the length of nozzle 650 calculated according to equations (6.11) and (6.13).

The narrowest cross-section of the throat 653 (FIG. 6f) provides the “critical condition” point 658, triggering the inverse de Laval jet-effect, according to equation (6.13), that is observed as an effect of flow slowing, when the flow moves along convergent funnel 652, and further slowing, when the flow moves through the divergent stage of convergent-divergent jet-nozzle 650 downstream-behind the critical condition point 658. For the purposes of the present patent application, the term “de Laval retarding-effect” is introduced as relating to the inverse de Laval jet-effect. Fast fluid-flow 651 moves along convergent funnel 652, where, ahead of the critical condition point 658 of narrow throat 653, the velocity falls 661, and the pressure and temperature pick up, correspondingly 671 and 681. The velocity falls 661 such that M-velocity M₆₆₃, corresponding to marker 663, reaches the specific M-velocity M_{*}=\sqrt{(γ−1)/γ} at the critical condition point 658. Fluid-flow 651 exits throat 653 and enters the widening divergent exhaust tailpipe 654, where fluid-flow 651 is subjected to increase of cross-sectional area, and this action is optimized such that the decrease of M-velocity 662 is accompanied by a substantially smoothed increase of the pressure and temperature, 672 and 682, correspondingly.

Slow hot and compressed fluid at position 656 outflows from wide exhaust tailpipe 654. Again, the smoothed change of static pressure 670 provides a suppression of unwanted Mach waves. In practice, the suppression of Mach waves provides a suppression of undesired vibrations that, in particular, especially important for a fast decelerating flying vehicle.

In view of the foregoing description referring to FIGS. 6f and 6g, it will be evident to a person skilled in the art that, on the one hand, to trigger the de Laval retarding-effect the high M-velocity M₆₅₁ must be low enough to reach the specific M-velocity M_{*} while slowing in convergent funnel 652 and the convergent stage of throat 653. On the other hand, taking into account that, in practice, for the case wherein fluid-flow 651 is an airflow, the M-velocity is distributed in the direction normal to an adjacent surface such that decreases almost down to zero at the surfaces of convergent-divergent jet-nozzle 650's walls. Thus, a certain portion of fast fluid-flow 651 at the critical condition point 658 moves with the effective M-velocity equal to the specific M-velocity M_{*} and is subjected to a convergent-divergent reshaping in throat 653, thereby, the conditions for the de Laval retarding-effect triggering is satisfied for any high M-velocity M₆₅₁, higher than the specific M-velocity M_{*}.

In view of the foregoing description referring to FIGS. 6a, 6b, 6f and 6g and derivation of equations (6.8) and (6.9), the de Laval jet-effect and the de Laval retarding-effect, both observed in the case of a converging flow, are specified as the following. The de Laval jet-effect is specified as an effect of a convergent flow portion convective acceleration, occurring, when the convergent flow portion moves with M-velocities lower than the specific M-velocity upstream-afore the critical condition point, reaches the specific M-velocity at the critical condition point, and moves with M-velocities higher than the specific M-velocity downstream-behind the critical condition point; and the de Laval retarding-effect is specified as an effect of a convergent flow portion warming and slowing, occurring, when the convergent flow portion moves with M-velocities higher than the specific M-velocity upstream-afore the critical condition point, reaches the specific M-velocity at the critical condition point, and moves with M-velocities lower than the specific M-velocity downstream-behind the critical condition point.

For the purposes of the present patent application, the terms “de Laval M-velocity”, “de Laval low M-velocity”, and “de Laval high M-velocity” should be understood as the following:
a de Laval low M-velocity is defined as an M-velocity lower than the specific M-velocity M_{*} and high enough to reach the specific M-velocity M_{*} at the critical condition point x_{*};
a de Laval high M-velocity is defined as an M-velocity higher than the specific M-velocity M_{*} and low enough to reach the specific M-velocity M_{*} at the critical condition point x_{*}; and
a de Laval M-velocity is at least one of the de Laval low M-velocity and the de Laval high M-velocity.

In view of the foregoing description referring to FIGS. 6f and 6g, it will be evident to a person skilled in the art that one can optimize the specifically shaped tunnel of convergent-divergent jet-nozzle 650 providing such a conformity of the cross-sectional area of the open inlet with the de Laval high M-velocity of flowing fluid crossing the open inlet, that the flowing fluid M-velocity is substantially smooth at the entering the open inlet. Furthermore, one can control the cross-sectional area of open inlet, according to the equation of principle, providing conformity of the open inlet cross-sectional area with the variable M-velocity of the entering flowing fluid. This may become important, for example, to suppress vibrations of a fast slowing vehicle.

### Two-Stage Convergent-Divergent Jet-Nozzle

FIG. 6h is a schematic illustration of a two-stage convergent-divergent jet-nozzle 690 exposed to an incoming fast fluid-flow 691, streaming with a high M-velocity M₆₉₁, higher than the specific M-velocity M_{*}=\sqrt{(γ−1)/γ}, i.e. with a de Laval high M-velocity. Two-stage convergent-divergent jet-nozzle 690, constructed according to the principles of a preferred embodiment of the present invention, has an inner tunnel comprising the first and second convergent-divergent stages, separated by widened reservoir 694. The first convergent-divergent stage performs the first-stage convergent inlet-funnel 692 gradually turning into the first-stage narrow convergent-divergent throat 693 having a local narrowest cross-section providing the first critical condition point 6981 and having an inverse-funnel shaped pipe leading to widened reservoir 694. The second convergent-divergent stage comprises the second-stage narrow throat 696, having a local narrowest cross-section providing the second critical condition point 6982, and the second-stage divergent exhaust tailpipe 697.

Incoming fast fluid-flow 691 is gradually slowing down, becoming warmer and more thickened and compressed as moving along the first convergent-divergent stage to widened reservoir 694 as described hereinbefore with reference to FIGS. 6f and 6g. Slow, hot and compressed fluid 695 further movies through the second convergent-divergent stage. The fluid flow is accelerating as moving through throat 696, where exceeds the specific M-velocity M_{*}=\sqrt{(γ−1)/γ} downstream-behind the second critical condition point 6982. Jetstream 699 outflowing through divergent exhaust tailpipe 697, is faster and colder than slow, hot and compressed fluid 695, yet to be entered into the second convergent-divergent stage, as described hereinbefore tracing after incoming compressed and hot airstream 611 with reference to FIGS. 6a and 6b. Fast outflowing jetstream 699 has a cross-section wider than incoming fast fluid-flow 691 at the input of convergent inlet-funnel 692. So, the M-velocity M₆₉₉ of fast outflowing jetstream 699 is higher than the M-velocity M₆₉₁ of fast fluid-flow 691, according to equation (6.13).

Thereby, two-stage convergent-divergent jet-nozzle 690 operates as a jet-booster based on the de Laval enhanced jet-effect launching outflowing jetstream 699, which is faster than fast fluid-flow 691 incoming with the de Laval high M-velocity M₆₉₁, i.e. higher than the specific M-velocity M_{*}=\sqrt{(γ−1)/γ}. This is one more teaching of the present invention.

### Optimal Implementation of Convergent-Divergent Jet-Nozzle

FIG. 7a shows comparative graphs 700 for the dependencies of the nozzle tunnel extension ratio vs. the airflow M-velocity, calculated by the classical and suggested models, namely, curves 703 and 704 correspondingly; wherein the vertical axis 701 is the ratio A/A_{*}, and the horizontal axis 702 is the airflow M-velocity measured in temperature dependent Mach numbers. The dashed curve 703 is the convergent-divergent cross-sectional area ratio A/A_{*} profile vs. the airflow M-velocity, calculated using equation (1) derived from the Euler equations of fluid motion. The solid curve 704 is the convergent-divergent cross-sectional area ratio A/A_{*} profile vs. the airflow M-velocity, calculated using suggested equation (6.13) derived from the generalized equations of fluid motion. The critical condition point 708 corresponds to the specific M-velocity M_{*}=\sqrt{(γ−1)/γ}≈0.5345. Comparative graphs 700 show that one needs in a substantially extra-widened nozzle tunnel 704 to reach the airflow M-velocities substantially higher than 1 Mach.

Therefore, a convergent-divergent jet-nozzle, constructed according to an exemplary embodiment of the present invention, allows increased efficiency of the jet-effect for use at high-subsonic, transonic, supersonic, and hypersonic velocities that can be applied to rocket nozzle design.

Taking into account relation (6.11), one can derive equations bonding the exhaust-nozzle outlet M-velocity Mₑ with the ratios P₀/Pₑ and T₀/Tₑ, where Pₑ and Tₑ are correspondingly the static pressure and temperature at the exhaust-nozzle tunnel outlet:

$$\begin{matrix}{M}_{e} = \sqrt{( \frac{2}{γ} )} \sqrt{{( \frac{{P}_{o}}{{P}_{e}} )}^{\frac{( γ - 1 )}{γ}} - 1} & Eq . ( 7.1 a ) \\ \frac{{P}_{o}}{{P}_{e}} = {( \frac{2 + γ {M}_{e}^{2}}{2} )}^{\frac{γ}{γ - 1}} & Eq . ( 7.1 b ) \\ \frac{{T}_{o}}{{T}_{e}} = ( \frac{2 + γ {M}_{e}^{2}}{2} ) & Eq . ( 7.1 c ) \\ \frac{{ρ}_{o}}{{ρ}_{e}} = {( \frac{2 + γ {M}_{e}^{2}}{2} )}^{\frac{1}{γ - 1}} & Eq . ( 7.1 d )\end{matrix}$$

In contrast to the classical theory, saying that both: the de Laval jet-effect and the velocity of sound are reachable when the ratio P₀/Pₑ is of 1.893, equation (7.1b) shows that, on the one hand, to obtain the de Laval jet-effect [i.e. condition Mₑ≧M_{*}] for air using a nozzle tunnel having an optimal convergent-divergent shape, one must provide the ratio P₀/P_{*} at least of 1.893, and, on the other hand, to accelerate an air portion up to the velocity of sound [i.e. Mₑ=1], one must provide the ratio P₀/Pₑ at least of 6.406. Equation (7.1c) says that, on the one hand, to obtain the de Laval jet-effect for air utilizing a nozzle tunnel having optimal convergent-divergent shape, one must provide the ratio T₀/T_{*} at least of 1.2; and, on the other hand, to accelerate an air portion up to the velocity of sound, one must provide the ratio T₀/Tₑ at least of 1.7. So, the principle condition either 1.893<P₀/Pₑ<6.406 or/and 1.2<T₀/Tₑ<1.7 may provide the de Laval jet-effect occurring without the phenomenon of shock sound-wave emission that is one of the primary principles of the present invention.

Thus, a convergent-divergent jet-nozzle tunnel, constructed according to an exemplary embodiment of the present invention and exploited in accordance with the principle conditions, allows an optimal implementation and efficient use of an enhanced jet-effect at de Laval M-velocities.

### Vortex Tube as Convergent-Divergent Jet-Nozzle

Reference is now made again to prior art FIG. 1l, showing vortex-tube 190, and FIG. 6a, showing convergent-divergent jet-nozzle 610 constructed according to an exemplary embodiment of the present invention.

Point out that the vortex tube 190's exhaust tunnels to outlets 317 and 318 can be considered as converging and convergent-divergent jet-nozzles correspondingly at heating and cooling ends. Consider, for simplicity, the nozzle effect only at outlet 19.8. Apply estimations (7.1a,b,c) to an ideal construction of vortex tube 190 and take into account the aforementioned conditions of exploitation. Namely, entering air 310 has the pressure of P=6.9 bar, while the value Pₑ is about 1 bar such that P₀/Pₑ is substantially higher than 1.893 that provides M-velocity of M_{*}=\sqrt{(γ−1)/γ} into the “throat” 19.9. Moreover, the estimated ratio P₀/Pₑ˜6.4 says that if the widening exhaust tunnel, having outlet 19.8 diameter greater than inner diameter 19.9 would be constructed in accordance with an exemplary embodiment of the present invention similar to convergent-divergent jet-nozzle 610 (FIG. 6a) such that Aₑ/A_{*}≈1.5197, then outlet 19.8 M-velocity is expected to be approximately of Mₑ≈1. In this case, it follows from (7.1c) that the reachable temperature ratio is T₀/Tₑ=1.7. I.e., if T₀=21 C=294.14K, then Tₑ≈173K≈−100 C. This estimation shows that:
first, the novel explanation of the well-known vortex-tube effect by the dominant phenomenon occurred in the de Laval convergent-divergent jet-nozzle is confirmed by calculations based on equations (7.1a,b,c); and
second, a cooling temperature, substantially lower than the aforementioned “−34° C.”, is reachable by optimizing the mentioned outlet convergent-divergent tunnel shape.

Thus, a convergent-divergent jet-nozzle, constructed and exploited according to an exemplary embodiment of the present invention, allows optimizing the efficiency of an enhanced jet-effect use to launch an extra-cooled gas outflow.

### Compressor Supplied by Convergent-Divergent Jet-Nozzle

FIG. 7b is a schematic illustration of a hypothetically optimal convergent-divergent jet-nozzle 710 with the critical condition point 718 applied to accelerate air portion 711, constructed according to the principles of the present invention. Air portion 711 is compressed and heated in a reservoir 712. To compress air portion 711 up to pressure P₀=6.4 Bar one needs to consume the energy E₀ estimated as (P₀−Pₑ)V₀, where V₀ is the volume of the gas reservoir 712. For V₀=1 m³, the energy E₀ is estimated as E₀=5.4×10⁵ J=540 kJ. The volume V₀ is composed of approximately n≈(P₀/Pₑ)×1000/22.4=286 moles of gas. When air portion 711 is accelerated and expanded in de Laval-like nozzle 710, it acquires kinetic energy at the expense of thermodynamically related pressure and temperature decrease; wherein the pressure decreases from P₀ to Pₑ and the temperature decreases from T₀ to Tₑ. Let air portion 711 accelerate in hypothetically optimal convergent-divergent jet-nozzle 710 such that the velocity of the outflowing stream 713 is almost as the speed of sound, i.e. the exhaust M-velocity is of Mₑ≈1. Then T₀/Tₑ=1.7 and T₀−Tₑ=T₀(1−1/1.7)=0.412T₀. In this case, the acquired kinetic energy equals K=n×(T₀−Tₑ)R that is estimated as:

K=n×0.412T₀R≈286×0.412×298×278≈9,761,674 J=9,762 kJ.

This estimation shows that the acquired kinetic energy K may exceed the consumed energy E₀ at least at subsonic velocities by a factor of 18 times. The acquired kinetic energy can be applied to a vehicle motion or to an engine for electricity generation with positive net-efficiency. On the other hand, the acquiring of kinetic energy is accompanied by the air temperature decrease, therefore, such a convergent-divergent jet-nozzle can be applied to cooling of a vehicle engine as well as be used either for electricity harvesting by means of a Peltier element operating as thermoelectric generator and/or as an effective condenser of vapor to water.

### Flying Capsule Having a Convergent-Divergent Tunnel

FIG. 7c is a schematic sectional view of a flying capsule corpus 720 in a sagittal plane. Capsule corpus 720, constructed according to the principles of the present invention, has outer airfoil side 729 and comprises an inner converging reservoir 721 having an open inlet 725 exposed to ambient wind 724 and further having a hypothetically optimal convergent-divergent tunnel 722 with a narrow throat comprising a critical condition point 728 and divergent exhaust tailpipe having an open outlet 726 of area Aₑ. The velocity of ambient air 724 relative to capsule 720 is uₐ which is substantially lower than the critical condition velocity u_{*}, corresponded to the specific M-velocity M_{*}=\sqrt{(γ−1)/γ}. The wind portion 727 enters the inner converging reservoir 721 with the velocity equal to uᵢₙ. The area Aᵢₙ of inlet 725 is substantially wider than the area A_{*} of the throat's cross-section at the critical condition point 728 such that air portion 727 crosses the area A_{*} at the critical condition point 728 with the maximal reachable M-velocity equal to the specific M-velocity M_{*}=\sqrt{(γ−1)/γ}, and so the de Laval enhanced jet-effect is expected in the divergent exhaust tailpipe having outlet 726, where the velocity of outflowing jetstream 723 reaches a value uₑ higher than the velocity u_{*} corresponding to the critical condition point 728. In an exemplary embodiment of the present invention, an optimal shape of tunnel 722 provides that the value uₑ is lower than the speed of sound u_{sound}. Outflowing jetstream 723 brings the kinetic power acquired at the expense of the flow warmth. The acquired kinetic power of outflowing jetstream 723 may be high as or even become higher than the power consumed to compensate drag, defined by a drag coefficient corresponding to a concave shape of the inner converging reservoir 721, and thereby to maintain the flying velocity uₐ of capsule 720.

Outer airfoil side 729 of capsule corpus 720 provides laminar-like flowing of wind outer sub-portions 731 and 732, moving adjacent to outer airfoil side 729 and being subjected to the Coanda-effect operation and, thereby, attracted to the nearby surfaces of outer airfoil side 729. Outflowing jetstream 723 having the decreased static pressure sucks outer sub-portions 731 and 732. The cumulative confluence of sub-portions 731, 732, and 723 constitutes cumulative jetstream 734, associated with the airfoil corpus of capsule 720. In general, the formed cumulative jetstream 734, composed of sub-portions 731, 732, and 723, is turbulent; however, in an optimal case, the turbulence can be suppressed substantially. For simplicity, consider a case of a laminar-like cumulative jetstream 734, “bordered” by streamlines 733. On the one hand, the velocities of outer sub-portions 731 and 732, being lower than the critical condition velocity u_{*}, are increasing as the attracted outer sub-portions enter the space of cumulative jetstream 734, where the velocities increase is accompanied by a constriction of outer sub-portions 731 and 732, in accordance with equation (6.13). On the other hand, at outlet 726, the velocity of inner sub-portion 723 is of value uₑ higher than the critical condition velocity u_{*}. According to equation (6.13), the velocity of inner sub-portion 723 is decreasing as the sub-portion enters the space of cumulative jetstream 734, where inner sub-portion 723 is constricting as well. If the case is optimized such that the both constrictions are identical, cumulative jetstream 734 is expected to be laminar-like indeed. Bordering streamlines 733 constitute an imaginary convergent-divergent jet-nozzle comprising a narrow throat having the minimal cross-sectional area at the outer critical condition point 738, where the effective M-velocity of cumulative jetstream 734 reaches the specific value M_{*}=\sqrt{(γ−1)/γ}. If, upstream-afore the outer critical condition point 738, the effective M-velocity of cumulative jetstream 734 is lower than the specific M-velocity M_{*}, then the M-velocity of cumulative jetstream 734 is increasing as cumulative jetstream 734 moves such that outflowing divergent portion 735 has M-velocity higher than M_{*}, downstream-behind the outer critical condition point 738; and vice versa, if, upstream-afore the outer critical condition point 738, the effective M-velocity of cumulative jetstream 734 is higher than the specific M-velocity M_{*}, then the M-velocity of cumulative jetstream 734 is decreasing as cumulative jetstream 734 moves such that outflowing divergent portion 735 has the M-velocity lower than the specific M-velocity M_{*}.

In view of the foregoing description referring to FIG. 7c, it will be evident to a person skilled in the art that the shape of tunnel 722 can be optimized to provide that the velocity value uₑ of outflowing jetstream 723 becomes higher than the speed of sound u_{sound}. As well, it will be evident to a person skilled in the art that the shape of tunnel 722 and outer airfoil side 729 of capsule 720 can be optimized to provide that outflowing divergent portion 735 has increasing M-velocity reaching values higher than the specific M-velocity M_{*}.

In view of the foregoing description referring to FIG. 7c, it will be evident to a person skilled in the art that supplying a flying vehicle or helicopter's propeller blades by nozzles similar to capsule 720 operating as jet-booster, one could save fuel consumption substantially and even provide a stable motion against a drag and skin-friction resistance entirely with no fuel burning at all. As well, it will be evident to a person skilled in the art that this is not a so-called “Perpetuum mobile”, but a use of ambient fluid heat to produce useful motion, strongly according to the Energy Conservation Law. Furthermore, looking ahead referring to FIGS. 9d, 9e, and 9f described hereinafter, point out that an even number of such jet-boosters, attached to the even number of blades of a helicopter's propeller, result in stabilization of the effective velocities of incoming and outflowing jetstreams associated with the jet-boosters. The predictably equalized velocities enable easier controllable lift-forces when the helicopter is flying speedily.

In view of the foregoing description referring to FIG. 7c, it will also be evident to a person skilled in the art that the described airfoil capsule can be stationary exposed to oncoming wind (either natural or artificial) and thereby become applicable to an efficient harvesting of electricity providing a positive net-efficiency.

In view of the foregoing description referring to FIGS. 7b and 7c, it will also be evident to a person skilled in the art that that one can further aggregate the open outlet of a specifically shaped convergent-divergent tunnel with an engine using the enhanced jet-effect providing an extra-accelerated and extra-cooled jetstream outflowing through the open outlet; wherein the engine is either a jet-engine, and/or a turbo-jet engine, and/or a motor applied to a vehicle, and/or a generator of electricity, and/or a cooler, and/or a Peltier element operating as thermoelectric generator, and/or vapor-into-water condenser.

FIG. 7d is a schematic sectional view of a flying capsule 740, constructed according to the principles of the present invention. Flying capsule 740's profile in a sagittal plane has an airfoil outer contour and a contour of a specifically shaped two-stage inner tunnel. In contrast to flying capsule 720 illustrated hereinbefore referring to FIG. 7c, capsule 740 flies with a de Laval high M-velocity, i.e. higher than the specific M-velocity M_{*}=\sqrt{(γ−1)/γ}, and the two-stage inner tunnel is shaped similar to the tunnel of two-stage convergent-divergent jet-nozzle 690, described above with reference to FIG. 6h. Namely, the two-stage inner tunnel comprises two narrow throats providing for two associated critical condition points 741 and 742. The oncoming fast flow 743 enters the open inlet 744 of the inner tunnel with a de Laval high M-velocity, higher than the specific M-velocity M_{*}. Then flow 743 is gradually slowing down, becoming warmer and more compressed as moving to critical condition point 741 where reaching the specific M-velocity M_{*}, further, is gradually extra-slowing, extra-warming and extra-compressing as moving to reservoir 745, according to equation (6.13), further, is gradually accelerating, cooling, and becoming decompressed as moving to critical condition point 742 where again reaching the specific M-velocity M_{*}, and further, is gradually extra-accelerating, extra-cooling, and extra-decompressing as moving to outlet 746, as described hereinbefore with references to FIGS. 6a, 6b, 6f, 6g, and 6h.

The cross-section of outlet 746 is wider than the cross-section of inlet 744, thereby providing for that capsule 740 operates as a jet-booster launching a widened and cooled outflowing jetstream 747 with a high M-velocity, higher than the de Laval high M-velocity of oncoming fast flow 743.

### Improved Propeller and Ventilator

FIG. 7e is a schematic drawing of improved blowing propeller or ventilator 770, constructed according to the principles of the present invention, to operate in fluid surroundings. For simplicity and without loss of the description generality, consider improved blowing ventilator 770 operating in an open air space. Improved blowing ventilator 770, defined by the main functionality to launch a jetstream characterized by the flow headway-motion kinetic-power, has an inherent engine, which is not shown here, consuming either a power of burned fuel or an electrical power and operating in a steady-state mode. Improved blowing ventilator 770 comprises airfoil blades: first-airfoil-blades 772.1 and second-airfoil-blades 772.2, shown here schematically, each, when compounded with imaginary sagittal axis 771, having a chiral asymmetrical shape, wherein, preferably, the shape of first-airfoil-blades 772.1 is substantially mirror-symmetrical relative to the shape of second-airfoil-blades 772.2. First-airfoil-blades 772.1 and second-airfoil-blades 772.2 are forcedly rotating in transitional space “T7”, marked schematically as a cylindrical space portion between frontal planes 779.1 and 779.2. Mutually complemental first-airfoil-blades 772.1 and second-airfoil-blades 772.2 are forcedly rotating in mutually-opposite directions, indicated by curved arrows marked by reference numerals 773.1 and 773.2, correspondingly. Forcedly mutually-opposite rotating first-airfoil-blades 772.1 and second-airfoil-blades 772.2 cover effective cross-section 774, and, thereby, entrap and suck air portions 775.A from space “A7”, which is located upstream-afore effective cross-section 774, and convert flowing air portions 775.A into accelerated jetstream 775.B entering space “B7”, which is located downstream-behind effective cross-section 774. Space “A7”, comprising airflow portions 775.A subjected to the sucking and motion through effective cross-section 774, is bordered by streamlines of airflow 775.A, forming imaginable contours 776.A. The imaginary contours 776.A separate space “A7” from space “C7”, comprising air portions 775.C, drawn by airflow 775.A and flowing toward transitional space “T7” out of effective cross-section 774. Space “B7”, comprising jetstream 775.B, is bordered by streamlines, forming imaginable contours 776.B. The imaginary contours 776.B separate space “B7” from space “D7”, comprising air portions 775.D, drawn by jetstream 775.B and flowing downstream-behind transitional space “T7”. In contrast to the general case, when a complicated motion of air portions 775.A, 775.B, 775.C, and 775.D comprises both: a headway-motion, i.e. a laminar component of motion aligned with the imaginary contours 776.A and 776.B having a prevalent direction along imaginary sagittal axis 771, and a whirling-motion, i.e. a turbulent component of motion, dominantly, whirling around imaginary sagittal axis 771; the forcedly mutually-opposite rotating first-airfoil-blades 772.1 and second-airfoil-blades 772.2 are optimized to prevent the power-consuming whirling motion and provide the desired dominant headway-motion of air portions 775.A, 775.B, 775.C, and 775.D, as one of the primary features of improved blowing ventilator 770. For simplicity, further describing the optimized case, minor effects caused by the whirling turbulence will be ignored. In the optimized case, the power, consumed by the inherent engine of improved blowing ventilator 770, dominantly, is expended for:
the headway-motion of air portions 775.A, which then are transformed into jetstream 775.B;
the directional motion of air portions 775.C, which then are transformed into moving air portions 775.D;
the overcoming of air viscous-resistance; and
the compensation of inner resistance of the inherent engine.
   Wherein the part of the power consumption, expended on the overcoming of air viscous-resistance and compensation of inner resistance of the inherent engine, dissipates in the acquired warmth of outflowing air portions 775.B and 775.D. Mutually-opposite rotating first-airfoil-blades 772.1 and second-airfoil-blades 772.2 have optimized shapes, in addition providing a certain focusing of jetstream 775.B, such that streamlines 776.A and 776.B constitute an imaginary convergent-divergent tunnel. Furthermore, the speeds of first-airfoil-blades 772.1 and second-airfoil-blades 772.2 mutually-opposite rotations are optimized such that jetstream 775.B moves through cross-section 778.B of the minimal area with the specific M-velocity M_{*}=\sqrt{(γ−1)/γ}, thereby making the imaginary convergent-divergent tunnel, constituted by streamlines 776.A and 776.B, in principle, similar to the specifically shaped tunnel of convergent-divergent jet-nozzle 610 shown in FIG. 6a, wherein imaginary sagittal axis 771 and imaginary sagittal x-axis 615 (FIG. 6a) are collinear, effective cross-section 774 takes the place of imaginary inlet 6131 (FIG. 6a), and cross-section 778.B of the minimal area provides the critical condition for the de Laval effect triggering. Thus, the imaginary convergent-divergent tunnel, constituted by streamlines 776.A and 776.B, performs a de Laval-like nozzle. A de Laval-like jet-effect, which is similar to the classical de Laval jet-effect but arising in the de Laval-like nozzle having imaginary walls formed by streamlines 776.A and 776.B of the flowing air, is triggered, as described hereinbefore referring to FIGS. 6a, 6b, 6c, 6d, and 6e, thereby resulting in an extra-acceleration and extra-cooling of jetstream 775.B immediately downstream-behind cross-section 778.B. This provides one of the primary features of improved blowing ventilator 770.

The de Laval-like nozzle, having imaginary convergent-divergent tunnel formed by streamlines 776.A and 776.B of the flowing air, geometrically, is not identical with an optimized de Laval nozzle having solid walls, described hereinbefore referring to FIGS. 6a, 6b, 6c, 6d, and 6e, at least because of the osmotic-like effect inherently occurring on imaginary contours 776.A and 776.B, as described above with references to FIGS. 4 and 5b. The osmotic-like effect is defined as an effect of exchange of molecular matter and heat between moving air portions. The osmotic-like effect includes a mutually-directed effect of diffusion, occurring because of both: the Brownian random motion of the fluid's molecules, and the effect of molecules motion in a cross-sectional plane, caused by the gradients of fluid density ∇ρ and temperature ∇T in the cross-sectional plane, which are interrelated with the jetstream 775.B convergent-divergent motion. The osmotic-like effect, reducing the gradients, is accumulative, making equation (6.13) applicable qualitatively to a local neighborhood of a coordinate at sagittal axis 771 only.

Since a certain distance downstream-behind cross-section 778.B of minimal area, namely, in transitional space “E7”, marked schematically as a cylindrical space portion between frontal planes 779.3 and 779.4, the extra-accelerated jetstream 775.B, subjected to a diffusion of molecules of air portions 775.D as the airflow moving along sagittal axis 771, becomes transformed into transitional jetstream 775.E, characterized by a local maximum of cross-sectional area, where the density and temperature of transitional jetstream 775.E are already not reducing and a high M-velocity of transitional jetstream 775.E, being higher than the specific M-velocity M_{*}=\sqrt{(γ−1)/γ}, is not increasing more.

Farther, in space “F7” located downstream-behind transitional space “E7”, transitional jetstream 775.E is transformed into slowing jetstream 775.F, which, according to equation (6.13) qualitatively applicable to a local neighborhood, is characterized by an increase of airflow density and temperature. Slowing jetstream 775.F, bordered by convergent-divergent streamlines 776.F, reaches cross-section 778.F of minimal area, where the M-velocity of jetstream 775.F reverts to the specific M-velocity M_{*}=\sqrt{(γ−1)/γ} and the de Laval-like retarding-effect is triggered resulting in an extra-slowing and extra-warming of jetstream 775.F downstream behind cross-section 778.F of minimal area, as described hereinabove referring to FIGS. 6f and 6g, relating to jet-nozzle 650, having solid walls.

Gradual variations of the air thermodynamic parameters are expected in the open space, thereby providing optimized shapes of imaginary contours 776.A, 776.B, 776.E, and 776.F. These optimizations result in that improved blowing ventilator 770:
on the one hand, powered by the inherent engine, expends the power for:
   the headway-motion of air portions 775.A, further transformed into directional jetstreams 775.B, 775.E, and 775.F,
   the directional motion 775.C, further transformed into directional motion 775.D,
   the overcoming of air viscous-resistance, and
   the compensation of inner resistance of the inherent engine; and
on the other hand, triggering the de Laval-like jet-effect in an adiabatic process, saves the power for the jetstream 775.B acceleration and extra-acceleration, correspondingly, upstream-afore and downstream-behind cross-section 778.B, providing one of the primary features of improved blowing ventilator 770.

The resulting functionality net-efficiency of improved blowing ventilator 770 is defined by the ratio of the kinetic-power of launched jetstream 775.E to the power, consumed by the inherent engine of improved blowing ventilator 770.

In view of the foregoing description referring to FIG. 7e, it will be evident to a person skilled in the art that improved blowing ventilator 770 provides for jetstream 775.B launching and further acceleration and extra-acceleration at the expense of both: the power of inherent engine and the warmth of ambient air, so the resulting functionality net-efficiency of improved blowing ventilator 770 may exceed 100%. Furthermore, improved blowing propeller 770, having the resulting functionality net-efficiency higher than 100% and pushing a vehicle, in the final analysis, can operate at the expense of ambient warmth only.

In view of the foregoing description referring to FIG. 7e, it will be evident to a person skilled in the art that, to implement an improved blowing ventilator, having real corpus 777 occupying a certain space, comprising a part of transitional space “T7”, one should implement real corpus 777 as a fragment of a convergent-divergent tunnel for air portions 775.A and jetstream 775.B, applying principles of the present invention to an optimization of the tunnel shape, in order to suppress undesired power-consuming shock and Mach waves, as described hereinabove referring to FIGS. 6a, 6b, 6c, 6d, and 6e. As well, it will be evident to a person skilled in the art that real corpus 777 of an improved blowing ventilator may have real walls, occupying also substantial portions of spaces “A7” and “B7”, implementing optimized contours 776.A and 776.B now becoming actual, such that the improved blowing ventilator comprises a real specifically shaped convergent-divergent tunnel having narrow throat with the critical condition point, as described hereinabove referring to FIG. 6a. As well, it will be evident to a person skilled in the art that an improved blowing ventilator can be used to accelerate and focus an ionized gas, i.e. plasma, controlled by an external magnetic field, wherein geometry of the imaginary walls, formed by streamlines 776.A and 776.B, can be controlled by the magnetic field, such that the imaginary walls, occupying substantial portions of spaces “A7” and “B7”, form a specifically shaped convergent-divergent tunnel having narrow throat with the critical condition point, as described hereinabove referring to FIG. 6a.

In view of the foregoing description referring to FIG. 7e, it will be evident to a person skilled in the art that one can implement transitional space “T7” of an improved propeller, characterized by the primary features of improved blowing ventilator 770, using a pair of rotating airfoil Archimedes screws having helically coiled airfoil-profiled walls, similar to walls of spirals 592 and 593, described hereinbefore referring to FIG. 5i, instead of the use of rotating first-airfoil-blades 772.1 and second-airfoil-blades 772.2. As well, transitional space “T7” can be implemented using a combination of many rotating airfoil blades and stationary or rotating airfoil screws of Archimedes.

FIG. 7f is a schematic drawing of improved sucking propeller or ventilator 780, constructed according to the principles of the present invention to operate in fluid surroundings. For simplicity and without loss of the description generality, consider improved sucking ventilator 780 operating in an open air space. Improved sucking ventilator 780 is defined by the main functionality, being inverse to the main functionality of improved blowing ventilator 770, described above with the reference to FIG. 7e, namely, to make an incoming jetstream, characterized by the flow headway-motion kinetic-power. Looking ahead, point out that improved sucking ventilator 780, constructed according to the principles of the present invention, is as inverse improved blowing ventilator 770. Improved sucking ventilator 780 has an inherent engine, which is not shown here, consuming either a power of burned fuel or an electrical power and operating in a steady-state mode. Improved sucking ventilator 780 comprises airfoil blades: first-airfoil-blades 782.1 and second-airfoil-blades 782.2, which are shown schematically, each having an asymmetrical and chiral geometrical configuration, wherein, preferably, the geometrical configuration of first-airfoil-blades 782.1 is mirror-symmetrical relative to the geometrical configuration of second-airfoil-blades 782.2. Mutually complemental first-airfoil-blades 782.1 and second-airfoil-blades 782.2 are forcedly rotating in transitional space “T8”, marked schematically as a cylindrical space portion between frontal planes 789.1 and 789.2. First-airfoil-blades 782.1 and second-airfoil-blades 782.2 are forcedly rotating in mutually-opposite directions, indicated by curved arrows marked by reference numerals 783.1 and 783.2, correspondingly. First-airfoil-blades 782.1 and second-airfoil-blades 782.2 have geometrical configurations such that, when forcedly mutually-opposite rotating and covering effective cross-section 784, entrap and suck incoming jetstream 785.B from space “B8”, which is located upstream-afore effective cross-section 784, convert incoming jetstream 785.B into defocusing airflow 785.A, divergently entering space “A8”, which is located downstream-behind effective cross-section 784.

Incoming jetstream 785.B, subjected to the sucking, is bordered by streamlines forming imaginary contours 786.B. The imaginary contours 786.B separate space “B8” from space “D8”, comprising air portions 785.D, drawn by incoming jetstream 785.B and flowing toward transitional space “T8” out of effective cross-section 784. Space “A8”, comprising divergent airflow 785.A, is bordered by streamlines forming imaginary contours 786.A. The imaginary contours 786.A separate space “A8” from space “C8”, comprising air portions 785.C, drawn by divergent airflow 785.A and flowing downstream-behind transitional space “T8”. Forcedly mutually-opposite rotating first-airfoil-blades 782.1 and second-airfoil-blades 782.2 are optimized to prevent the power-consuming whirling motion and provide the desired dominant headway-motion of air portions 785.A, 785.B, 785.C, and 785.D, as one of the primary features of improved sucking ventilator 780.

Mutually-opposite rotating first-airfoil-blades 782.1 and second-airfoil-blades 782.2 have optimized shapes, in addition providing a certain defocusing of incoming jetstream 775.B, such that streamlines 786.B and 776.A constitute an imaginary convergent-divergent tunnel. Furthermore, the mutually-opposite rotations speeds are optimized such that incoming jetstream 785.B moves through cross-section 788.B of the minimal area with the specific M-velocity M_{*}=\sqrt{(γ−1)/γ}, thereby making the imaginary convergent-divergent tunnel, constituted by streamlines 786.B and 786.A, similar to the specifically shaped tunnel of convergent-divergent jet-nozzle 650 shown in FIG. 6f, wherein imaginary sagittal axis 781 and imaginary sagittal x-axis 655 (FIG. 6f) are collinear, effective cross-section 784 takes the place of imaginary outlet 6532 (FIG. 6f), and cross-section 788.B of the minimal area provides the critical condition for the de Laval effect triggering. Thus, the imaginary convergent-divergent tunnel, constituted by streamlines 786.B and 786.A, performs an inverse de Laval-like nozzle. A de Laval-like retarding-effect, which is similar to the classical de Laval retarding-effect described hereinbefore referring to FIG. 6f but occurring in the inverse de Laval-like nozzle having imaginary walls formed by streamlines 786.B and 786.A of the flowing air, is triggered, thereby resulting in an extra-slowing and extra-warming of incoming jetstream 785.B immediately downstream-behind cross-section 788.B. Furthermore, the condition of incoming jetstream 785.B moving through cross-section 788.B of the minimal area with the specific M-velocity M_{*}=\sqrt{(γ−1)/γ} interrelates with the condition of extra-pre-acceleration of incoming jetstream 785.B just upstream-afore cross-section 788.B, according to equation (6.13) qualitatively applicable to a local neighborhood. Thus, the M-velocity of incoming jetstream 785.B just upstream-afore cross-section 788.B is higher than the specific M-velocity M_{*}=\sqrt{(γ−1)/γ}. This provides one of the primary features of improved sucking ventilator 780.

Furthermore, again, according to equation (6.13) qualitatively applicable to a local neighborhood, the high M-velocity, higher than the specific M-velocity M_{*}=\sqrt{(γ−1)/γ}, can be reached due to the direct de Laval-like jet-effect in an earlier pre-history of incoming jetstream 785.B, namely, in space “F8” comprising pre-incoming jetstream 785.F moving through imaginary convergent-divergent tunnel constituted by streamlines 786.F and having cross-section 788.F of local minimum area providing the critical condition. Then the accumulative osmotic-like effect results in that since a certain distance downstream-behind cross-section 788.F of local minimum area, namely, in transitional space “E8”, marked schematically as a cylindrical space portion between frontal planes 789.3 and 789.4, pre-incoming jetstream 785.F, subjected to a diffusion of air molecules as moving along sagittal axis 781, becomes transformed into transitional jetstream 785.E, characterized by a local maximum of cross-sectional area, where the density and temperature of transitional jetstream 785.E are already not reducing and the M-velocity of transitional jetstream 785.E, being higher than the specific M-velocity M_{*}=\sqrt{(γ−1)/γ}, is not increasing more. Transitional jetstream 785.E becomes transformed into incoming jetstream 785.B subjected to the de Laval-like retarding-effect resulting in incoming jetstream 785.B slowing and extra-slowing.

Thus, relatively slow divergent airflow 785.A has an upstream pre-history, comprising the pre-accelerated and extra-pre-accelerated headway-motion of jetstream 785.B downstream-behind and upstream-afore cross-section 788.B, correspondingly, wherein gradual variations of the air thermodynamic parameters are expected in the open space, thereby providing optimized shapes of imaginary contours 786.B and 786.A. These optimizations result in that improved sucking ventilator 780:
on the one hand, powered by the inherent engine, expends the power for:
   the headway-motion of pre-incoming jetstream 785.F, further transformed sequentially into directional motion of transitional jetstream 785.E, incoming jetstream 785.B, and divergent airflow 785.A,
   the directional motion of outer portions 785.D, further transformed into directional motion of outer portions 785.C,
   the overcoming of air viscous-resistance, and
   the compensation of inner resistance of the inherent engine; and
on the other hand, triggering the de Laval-like retarding-effect having pre-history comprising the de Laval-like jet-effect in an adiabatic process, saves the power for the incoming jetstream 785.B motion, accelerated and pre-extra-accelerated, correspondingly, downstream-behind and upstream-afore cross-section 788, providing one of the primary features of improved sucking ventilator 780.

The resulting functionality net-efficiency of improved sucking ventilator 780 is defined by the ratio of the kinetic-power of sucked transitional jetstream 785.E to the power, consumed by the inherent engine of improved sucking ventilator 780.

In view of the foregoing description referring to FIG. 7f, it will be evident to a person skilled in the art that improved sucking ventilator 780 provides for pre-incoming jetstream 785.F sucking pre-acceleration and extra-pre-acceleration at the expense of both: the power of inherent engine and the warmth of ambient air, so the resulting functionality net-efficiency of improved sucking ventilator 780 may exceed 100%. Furthermore, improved sucking propeller 780, having the resulting functionality net-efficiency higher than 100% and pulling a vehicle, in the final analysis, can operate at the expense of ambient warmth only.

In view of the foregoing description referring to FIG. 7f, it will be evident to a person skilled in the art that, to implement an improved sucking ventilator, having real corpus 787 occupying a certain space, comprising a part of transitional space “T8”, one should implement real corpus 787 as a fragment of a convergent-divergent tunnel for incoming jetstream 785.B and divergent airflow 785.A, applying principles of the present invention to an optimization of the tunnel shape, in order to suppress undesired power-consuming shock and Mach waves, as described hereinabove referring to FIGS. 6a, 6b, 6c, 6d, 6e, and 6f. As well, it will be evident to a person skilled in the art that real corpus 787 of an improved sucking ventilator may have real walls, occupying also substantial portions of spaces “B8” and “A8”, implementing optimized contours 786.B and 786.A now becoming actual, such that the improved sucking ventilator comprises a real specifically shaped convergent-divergent tunnel having narrow throat with the critical condition point, as described hereinabove referring to FIG. 6f.

In view of the foregoing description referring to FIGS. 7e and 7f, it will be evident to a person skilled in the art that one can implement the schematically shown mutually-opposite rotating and mutually complemental airfoil blades using many relatively small mutually-opposite rotating and mutually complemental airfoil blades, distributed spatially, altogether providing the mentioned primary features of an improved blowing and/or sucking propeller and/or ventilator.

In view of the foregoing description referring to FIGS. 7e and 7f, it will be evident to a person skilled in the art that one can cascade an improved sucking propeller and an improved blowing propeller such that imaginary sagittal axis 771 is as a continuation of imaginary sagittal axis 781, and space “A7” follows downstream behind space “A8”, thereby creating a combined improved sucking-and-blowing propeller. A vehicle, supplied with such a combined improved sucking-and-blowing propeller, provides for an optimized motion with a reduced drag.

In view of the foregoing description referring to FIGS. 7e and 7f, it will be evident to a person skilled in the art that one can implement transitional space “T7” and/or “T8” of an improved propeller, characterized by the primary features of improved blowing ventilator 770 and/or improved sucking ventilator 780, correspondingly, as a not obligatorily connected transitional space, but comprising several separate sub-spaces, each defined by at least one smaller propeller.

In view of the foregoing description referring to FIGS. 7e and 7f, in combination with the foregoing description referring to FIGS. 5h, 5j, and 5k, it will be evident to a person skilled in the art that one can implement a device, similar to improved blowing and/or sucking propeller 770 and/or 780, correspondingly, but comprising first-airfoil-blades 772.1 and/or 782.1 and second-airfoil-blades 772.2 and/or 782.2, both remain stationary, wherein the device, having no moving parts, is submerged in water surroundings, and wherein at least some sides of the stationary airfoil blades are covered with a hydrophobic material, that provides creating of a launched and/or sucked water jetstream at the expense of the water warmth only. Furthermore, estimations, made referring to FIG. 5h, show that a big quantity of such small hydrophobic-propellers, in particular, comprising stationary but hydrophobic blades, altogether cumulatively functioning like an improved launching and/or sucking propeller, can provide a powerful water jetstream that can be used, in particular, for pushing a submarine at the expense of the water warmth.

### Wing as a Convergent-Divergent Jet-Nozzle

FIG. 8a is a schematic visualization 800 of an oncoming wind portion 820, without loss of generality, moving horizontally. Oncoming wind portion 820 comprises airflow sub-portions 821, 822, 823, and 824 flowing around airfoil-wing 810, having a sectional profile, constructed according to the principles of the present invention. The upper side of airfoil-wing 810 comprises:
(a) a forward part meeting upper sub-portion 822 having imaginary cross-section 831;
(b) a withers defined as the highest point on the upper side of the airfoil profile, where sliding sub-portion 822 has imaginary narrowed cross-section 832, and
(c) a rearward part, attracting and, thereby, redirecting the mass-center of the upper sliding sub-portion 822 backward-downward, where sliding sub-portion 822 has imaginary widened cross-section 833.
   When airflow sub-portions 821, 822, 823, and 824 are flowing around airfoil wing 810, the streamlines [not shown here] of sub-portions 822 and 823, flowing near airfoil-wing 810, are curving in alignment with the airfoil-profile, the streamlines [not shown here] of portions 821 and 824, flowing farther from airfoil-wing 810, keep substantially straight trajectories aligned with imaginary horizontal lines 811 and 812 correspondingly above and under airfoil-wing 810. Airfoil wing 810's surface material properties, porosity, and structure are implemented according to the principles of the present invention providing that air sub-portions 822 and 823 are subjected to the Coanda-effect, defined by the partial pressure-“c” P_{c}, rather than to the skin-friction resistance, occurring in an imaginary boundary layer and being quantified by the difference (a_{w}−a−δa).

Imaginary lines 811 and 812 can be considered as imaginary walls, thereby, together with the airfoil-profile forming imaginary nozzles. The upper imaginary nozzle comprises imaginary cross-sections 831, 832, and 833, and the lower imaginary nozzle comprises imaginary cross-sections 834 and 835. Cross-section 831 is wider than cross-section 832 and cross-section 832 is narrower than cross-section 833, thereby, the upper imaginary nozzle has a convergent-divergent shape and sliding sub-portion 822 represents a convergent-divergent jetstream while flowing through cross-sections 831, 832, and 833. Cross-section 834 is wider than cross-section 835, so the lower imaginary nozzle has a converging shape. Consider a case, when airfoil-wing 810 flies with a de Laval low M-velocity M₈₁₀ that is lower than the specific M-velocity M_{*}=\sqrt{(γ−1)/γ}≈0.5345 Mach≈664 km/h, but such that sliding sub-portion 822, moving through the upper imaginary nozzle, reaches the specific M-velocity M_{*}when passes through the narrowest cross-section 832. So, the de Laval-like jet-effect arising is expected above airfoil-wing 810, i.e. within the upper imaginary convergent-divergent jet-nozzle. This is accompanied by the static pressure decrease and extra-decrease, as described hereinabove with the reference to FIG. 6b, and thereby results in the lift-effect, becoming stronger. In frames of the aerodynamics, one estimates the narrowest cross-section 832 linear size, i.e. thickness of a so-called “boundary layer”, normalized to a so-called “characteristic size” of the considered wing, as proportional to so-called Reynolds Number. As well, the thickness of boundary layer can be specified experimentally for a kind of body corpuses. In view of the foregoing description referring to FIG. 6a and FIG. 8a, it will be evident to a person skilled in the art that, basing on the defined narrowest cross-section 832 linear size as the thickness of boundary layer, one can apply the equation of principle (6.13) to design an improved profile of the wing.

In view of the foregoing description referring to FIG. 8a, it will be evident to a person skilled in the art that the described de Laval-like jet-effect is similar to the classical de Laval jet-effect, but arising in an optimized convergent-divergent tunnel having imaginary walls formed by streamlines of a flow. Namely, the specifically shaped convergent-divergent tunnel comprises two opposite walls; wherein one of the two opposite walls is constructed from a solid material and another of the two opposite walls is imaginary and formed by streamlines of the flowing fluid subjected to the Coanda-effect operation.

Thus, a method for a wing profile design, based on equation (6.13) according to an exemplary embodiment of the present invention, allows optimizing the wing airfoil shape to reach the best efficiency of the lift-effect as a result of the enhanced jet-effect occurring above the wing.

### The Coanda-Effect Operation Providing an Imaginary Convergent-Divergent Nozzle

FIG. 8b is a schematic illustration of a flying airfoil body 840 having the shape of an elongated drop.

For simplicity and without loss of reasoning, the shape is axis-symmetrical around the longitudinal axis 841. The airfoil body 840 comprises:
a forward part meeting oncoming flow portion 851;
a “withers”, defined as the highest point on the upper side of the airfoil profile, where sliding sub-portion 853 has an imaginary narrowed cross-section 868, and
a rearward part.

When an oncoming air portion 851, originally having a cross-sectional area 861, is running at the forward part of flying body 840, it is subjected to the Coanda-effect operation resulting in air portion 851 reshaping, and thereby forming an ambient-adjoining convergent-divergent jetstream, comprising sliding sub-portions: 852 being convergent, 853 being narrow and having imaginary narrowed cross-section 868 of the minimal cross-sectional area, 854 being divergent, and 855 becoming convergent due to the Coanda-effect attraction. Body 840's surface material properties, porosity, and structure are implemented according to the principles of the present invention, thereby providing that air portion 851 is subjected to the Coanda-effect, defined by the partial pressure-“c” P_{c}, rather than to the skin-friction resistance, occurring in an imaginary boundary layer and being quantified by the difference (a_{w}−a−δa). Furthermore, sliding sub-portions 855, join together, forming the resulting cumulative air portion 856. Oncoming air portion 851 and all the mentioned derivative sub-potions move within space “bordered” by imaginary walls marked by dashed contours 842. The imaginary walls 842 together with the airfoil surface of body 840 constitute an imaginary tunnel. The tunnel's cross-section gradually constricts from the inlet cross-section 862 to the narrowest cross-section 868 and then gradually widens up to the outlet cross-section 863. I.e. sliding sub-portions 852 are shrinking while reaching the withers of airfoil body 840, where the cross-sections 868 of sub-portions 853 become minimal. Then, behind the withers, the cross-sections of sub-portions 854 and 855 are widening as moving.

Sliding sub-portions 855, being under the subjection of the Coanda-effect operation, turn aside in alignment with the slippery surfaces of airfoil body 840's rearward part and join together, forming the resulting air portion 856. It results in a convergence of resulting air portion 856, i.e. in that, cross-section 864, located farther downstream, becomes narrower than cross-section 863 located immediately behind airfoil body 840, and opposite streamline-fragments 843 form an imaginary convergent funnel.

Furthermore, opposite streamline-fragments 844, which are bordering flow portion 857, constitute an imaginary divergent stage of a tunnel downstream-behind the narrowest cross-section 864. Thereby, the converging opposite streamline-fragments 843 and divergent opposite streamline-fragments 844 together constitute the imaginary convergent-divergent tunnel, and, correspondingly, portions 856 and 857 together constitute an outflowing convergent-divergent jetstream.

Jet-Booster Based on the Venturi-Effect

First, consider a case, when airfoil body 840 flies with a low M-velocity, lower than the specific M-velocity M_{*}=\sqrt{(γ−1)/γ}≈0.5345 Mach, and low enough to provide that M-velocity M₈₆₈ of accelerated sliding sub-portions 853, passing cross-sections 868 over the withers, and M-velocity M₈₆₄ of accelerated sub-portions 856, passing through the narrowest cross-section 864, both remain lower than the specific M-velocity M_{*}, i.e. M₈₆₈<M_{*} and M₈₆₄<M_{*}. In this case, the narrowest cross-section 864 of outflowing air portion 856 is narrower than the original cross-section 861 of oncoming air portion 851, and the M-velocities M₈₆₁, M₈₆₃, M₈₆₄, M₈₆₅, and M₈₆₈, where the indices correspond to markers of associated cross-sections, satisfy the following conditions:

M₈₆₁<M₈₆₈<M_{*},

M₈₆₃<M₈₆₈<M_{*},

M₈₆₃<M₈₆₄<M_{*},

M₈₆₁<M₈₆₄<M_{*}, and

M₈₆₅<₈₆₄<M_{*},

Thus, body 840 operates as a jet-booster basing on the Venturi-effect occurring in the imaginary tunnel adjacent to body 840's surfaces.

A practical application of the phenomenon that, under certain conditions, outflowing portion 856, moving through the narrowest cross-section 864, has a velocity higher than the velocity of oncoming portion 851 is one of the primary teachings of the present invention.

Jet-Boosters Based on the De Laval-Like Jet-Effect

Secondly, consider a case, when airfoil body 840 flies relatively slowly, such that sliding sub-portions 853 pass cross-sectional areas 868 with an M-velocity that remains lower than the specific M-velocity, i.e. M₈₅₃<M_{*}, but high enough to provide that the increased M-velocity of portion 856 is higher than M-velocity of sub-portions 853 and reaches the specific M-velocity M_{*}=\sqrt{(γ−1)/γ} at the critical condition point 864. In this case, M-velocity M₈₆₃ is the de Laval low velocity and the de Laval-like jet-effect is triggered, resulting in that the M-velocity of the divergent flow portion 857 exceeds the specific M-velocity M_{*}=\sqrt{(γ−1)/γ}. In this case, the M-velocities M₈₆₁, M₈₆₃, M₈₆₄, M₈₆₅, and M₈₆₈ satisfy the following conditions:

M₈₆₁<M₈₆₈<M_{*},

M₈₆₃<M₈₆₈<M_{*},

M₈₆₃<M₈₆₄=M_{*},

M₈₆₁<M₈₆₄=M_{*}, and

M₈₆₅>M₈₆₄=M_{*}.

So, body 840 operates as a jet-booster basing on the de Laval-like jet-effect occurring in the imaginary tunnel downstream-behind airfoil body 840.

Thereby, the Coanda-jet-effect operation forcedly forms convergent-divergent laminar-like streamlines downstream-behind airfoil body 840, wherein the static pressure is distributed gradually along the convergent-divergent laminar-like streamlines that provides an optimized extension of air portion 857 resulting in the de Laval-like enhanced jet-effect accompanied by extra-cooling and extra-acceleration of air portion 857. This is one more teaching of the present invention.

A practical application of the phenomenon that, under certain conditions, outflowing portion 857 has an M-velocity higher than the specific M-velocity is one of the primary teachings of the present invention.

It will be evident to a person skilled in the art that the enhanced jet-effect results in an optimized reactive thrust-force applied to airfoil body 840.

Thirdly, consider a case, when airfoil body 840's shape is optimized using the equation of principle (6.13), basing on an estimated linear size of cross-section 868, and when airfoil body 840 flies with a de Laval low M-velocity M₈₅₁, i.e. lower than the specific M-velocity M_{*}=\sqrt{(γ−1)/γ}≈0.5345 Mach, but high enough to provide that M-velocity of sliding sub-portions 853 reaches the value of the specific M-velocity, i.e. M₈₆₈=M at the critical condition point 868. Thereby, the enhanced de Laval-like jet-effect occurs downstream-behind the withers, providing that M_{*}<M₈₅₄<M₈₅₅, where the indexes correspond to associated sliding air sub-portions. In this case, according to equation (6.13), shrinking portion 856, moving with a de Laval high M-velocity, is slowing down, becoming warmer and more compressed, as moving on the way to the critical condition point associated with cross-section 864. The de Laval-like retarding-effect occurs downstream-behind cross-section 864 resulting in portion 857 expanding and further slowing down, warming, and compressing while reaching cross-section 865. The M-velocities M₈₆₁, M₈₆₃, M₈₆₄, M₈₆₅, and M₈₆₈ satisfy the following conditions:

M₈₆₁<M₈₆₈=M_{*},

M₈₆₃>M₈₆₈=M_{*},

M₈₆₃>M₈₆₄=M_{*},

M₈₆₁<M₈₆₄=M_{*}, and

M₈₆₅<M₈₆₄=M_{*}.

So, in the final analysis, body 840 operates as a jet-booster, triggering both the de Laval-like jet-effect and the de Laval-like retarding-effect.

Fourthly, consider a case, when airfoil body 840's shape is optimized using the equation of principle (6.13), basing on an estimated linear size of cross-section 868, and when airfoil body 840 flies with a de Laval high M-velocity, i.e. higher than the specific M-velocity M_{*}=\sqrt{(γ−1)/γ}≈0.5345 Mach. According to equation (6.13), the de Laval-like retarding-effect occurs in the imaginary convergent-divergent tunnel formed by streamlines 842. Namely, shrinking air portions 852 are slowing down, becoming warmer and more compressed, as moving on the way to withers such that the M-velocity of the narrowest sliding sub-portions 853 reaches the specific M-velocity, i.e. M₈₆₈=M_{*} at the critical condition point 868; and further, portions 854 continue to slow down while expanding downstream-behind the withers. Relatively slowly moving sliding sub-portions 855, now having a de Laval low M-velocity, join downstream-behind cross-section 863, thereby, providing for resulting shrinking portion 856 acceleration, accompanied by decrease of temperature and static pressure, while reaching again the specific M-velocity M_{*} at the narrowest cross-section 864. The de Laval-like jet-effect occurs downstream-behind cross-section 864 resulting in expanding portion 857 further acceleration accompanied by a deeper decrease of temperature and static pressure on the way to cross-section 865. So, the M-velocities M₈₆₁, M₈₆₃, M₈₆₄, M₈₆₅, and M₈₆₈ satisfy the following conditions:

M₈₆₁>M₈₆₈=M_{*},

M₈₆₃<M₈₆₈=M_{*},

M₈₆₃<M₈₆₄=M_{*},

M₈₆₁>M₈₆₄=M_{*}, and

M₈₆₅>M₈₆₄ M_{*}.

Again, in the final analysis, body 840 operates as a jet-booster, triggering both the de Laval-like retarding-effect and the de Laval-like jet-effect.

In view of the foregoing description referring to FIGS. 6a, 7a, 7b, 7c, 8a and 8b, it will be evident to a person skilled in the art that a method for an airfoil body shape design, based on equation (6.13) according to an exemplary embodiment of the present invention, allows, modifying the overall geometry of the body, to optimize efficiency of the enhanced jet-effect occurring outside of the body.

In view of the foregoing description referring to FIGS. 6a, 7a, 7b, 7c, 8a and 8b, it will be evident to a person skilled in the art that the described convergent-divergent jet-nozzles can be applicable to many apparatuses using mechanical and heat energy provided by either a flowing gas or liquid.

In view of the foregoing description referring to FIGS. 6a, 7a, 7b, 7c, 8a and 8b, it will be evident to a person skilled in the art that triggering and controlling the desired de Laval-like jet-effect can be provided by manipulating by the oncoming wind de Laval M-velocity. As the M-velocity is temperature-dependent, one can heat or cool air portions flowing within a specifically shaped tunnel, in particular, in an imaginary tunnel around a flying body.

In view of the foregoing description referring to FIGS. 6a, 7a, 7b, 7c, 8a and 8b, it will be evident to a person skilled in the art that reaching and controlling the desired de Laval-like jet-effect can be provided by manipulating by the value of specific M-velocity, depending on the generalized adiabatic compressibility parameter γ. For example, one can inject a gas composed of multi-atomic particles into a tunnel, in particular, into an imaginary tunnel around a flying body. As well, it will be evident to a person skilled in the art that, for example, micro-flakes-of-snow could play a role of such multi-atomic particles. Another technique to change the generalized adiabatic compressibility parameter γ and thereby to control the specific M-velocity is to ionize the flow, moving through the tunnel.

In view of the foregoing description referring to FIGS. 6a, 7a, 7b, 7c, 8a and 8b, it will be evident to a person skilled in the art that the described convergent-divergent jet-nozzles can be applicable to many apparatuses using mechanical and heat energy, provided by flowing gas or liquid.

Two-Stage Operation of the Coanda-Jet-Effect

FIG. 8c is a schematic illustration of flying airfoil bodies 850 and 860, arranged such that the withers of airfoil bodies 860 follow downstream-behind the withers of body 850. For simplicity and without loss of reasoning, each airfoil body 850 and 860 has the shape of an elongated drop 840 described above with reference to FIG. 8b. All reference numerals 841, 861, 851, 862, 852, 868, 853, 842, and 854 are the same as described referring to FIG. 8b.

Consider a case, when flying airfoil bodies 850 and 860 meet oncoming portion 851 with a de Laval high M-velocity M₈₅₁, higher than the specific M-velocity M_{*}=\sqrt{(γ−1)/γ}≈0.5345 Mach. According to equation (6.13), air sub-potions 852 are slowing down as constricting on the way to the withers of body 850, such that M-velocity of the narrowest sliding sub-portions 853 reach the specific M-velocity, i.e. M₈₅₃=M_{*}at the critical condition point 868. The de Laval-like retarding-effect occurs downstream-behind the withers. It provides the condition M_{*}>M₈₅₄, where index “854” corresponds to air sub-portions 854. So, airfoil bodies 860 meet oncoming sub-portions 854 flowing slower than with the specific M-velocity M_{*}=\sqrt{(γ−1)/γ}, but high enough to provide the critical condition near their [bodies 860's] withers. Again, according to equation (6.13), air sub-potions 859 have an M-velocity M₈₅₉ higher than the specific M-velocity M_{*}. Thus, flying airfoil bodies 850 and 860 meet the upstream air portions, and leave the downstream air portions, flowing faster than with the specific M-velocity M_{*}=\sqrt{(γ−1)/γ}. Furthermore, a cumulative cross-section of air sub-potions 859, wider than cross-section 861 of oncoming portion 851, means that the M-velocity M₈₅₉ is higher than the high M-velocity M₈₅₁ of oncoming portion 851. In this case, the Coanda-jet-effect two-stage operation accelerates a portion of ambient airflow that originally moves faster than with the specific M-velocity M_{*}. Thus, in contrast to the case when a body, having not-optimized shape, flies in air-environment with transonic, and/or supersonic, and/or hypersonic velocities, flying airfoil body 850, operating in tandem with each flying airfoil body 860, moving downstream behind the withers of airfoil body 850, results in a specific effect of acceleration and cooling air portion 851, oncoming faster than with the specific M-velocity M_{*}. This is one other primary teaching of the present invention.

FIG. 8d is a schematic drawing of a flying wing 870 having a two-humped airfoil profile 871, constructed according to the principles of the present invention. The flying wing 870 comprises two withers: forward 872 and rear 873, separated by concavity 874. The flying M-velocity is higher than the specific M-velocity M_{*}=\sqrt{(γ−1)/γ}≈0.5345 Mach.

An oncoming flow portion 875 runs at wing 870 and passes positions: 801, 802, 803, 804, 805, 806, 807, 808, and 809 sequentially with associated M-velocities: M₈₀₁, M₈₀₂, M₈₀₃, M₈₀₄, M₈₀₅, M₈₀₆, M₈₀₇, M₈₀₈, and M₈₀₉, correspondingly. The two-humped airfoil profile 871 provides for the Coanda-jet-effect two-stage operation: upstream-afore and downstream-after concavity 874. At position 801, flow portion 875, having the de Laval high M-velocity M₈₀₁, is yet to be subjected to the Coanda-jet-effect operation over wing 870's profiled surfaces. The two-humped airfoil profile 871 causes that the cross-sectional area of portion 875 is varying as portion 875 moves over wing 870. So, portion 875 shrinks at position 802 while upping over the forward part, has the first local minimum of cross-section area at position 803 above the forward withers 872, expands at position 804 while downing into concavity 874, reaches the local maximum of cross-section area at position 805 when passing concavity 874, shrinks again at position 806 on the way to the rear withers 873, gets the second local minimal value of cross-section area at position 807 above the rear withers, and expands at positions 808 and 809. According to equation (6.13), portion 875 is subjected to the de Laval-like jet-effect and the de Laval-like retarding-effect such that:
at position 802, the flow convergence is accompanied by the de Laval-like retarding-effect resulting in compressing and warming of flow portion 875 and a decrease of M-velocity, i.e. M₈₀₁>M₈₀₂;
at position 803, the first critical condition point, where the varying value of flow portion 875's cross-sectional area has the first local minimum, provides for that the M-velocity of flow portion 875 reaches the specific M-velocity M_{*}, so, M₈₀₁>M₈₀₂>M₈₀₃=M_{*}, i.e. the critical condition of the de Laval-like retarding-effect triggering is satisfied;
at position 804, the flow divergence is accompanied by further compressing and warming of flow portion 875 and a decrease of M-velocity lower than the specific M-velocity M_{*}, i.e. M_{*}>M₈₀₄;
at position 805 above concavity 874, the M-velocity M₈₀₅ is minimal, thereby, providing the condition:
   M₈₀₁>M₈₀₂>=M_{*}>M₈₀₄>M₈₀₅
at position 806, the flow convergence is accompanied by cooling of flow portion 875, a decrease of static pressure, and an increase of M-velocity, i.e. M₈₀₅<M₈₀₆;
at position 807, the second critical condition point, where the varying value of the flow portion 875's cross-sectional area has the second local minimum, is designed to provide for that the M-velocity of flow portion 875 reaches the specific M-velocity M_{*}, i.e. the condition M₈₀₅<M₈₀₆<M₈₀₇=M_{*} triggering the de Laval-like jet-effect is satisfied; and so,
at positions 808 and 809, the flow divergence is accompanied by further cooling of flow portion 875, a decrease of static pressure, and an increase of M-velocity, i.e. M₈₀₅<M₈₀₆<M₈₀₇=M_{*}<M₈₀₈<M₈₀₉.
   Depending on profile 871, the M-velocity M₈₀₉ of flow portion 875 at downstream position 809, may exceed the high M-velocity M₈₀₁ of flow portion 875 at upstream position 801, so, wing 870 may be used as a jet-booster based on the de Laval-like jet-effect, operating at high velocities. In general, a use of a two-humped airfoil profile of a wing flying with the de Laval high M-velocities, in order to provide for the desired jet-effect, is yet one of the teachings of the present invention.

In view of the foregoing description referring to FIG. 8d, it will be evident to a person skilled in the art that the effect of high M-velocity acceleration by the Coanda-jet-effect two-stage operation is applicable, for example, to a high-speed aircraft design.

In view of the foregoing description referring to FIGS. 6h, 7d, 8c, and 8d, it will be evident to a person skilled in the art that, considering a body, flying in air-environment with transonic, and/or supersonic, and/or hypersonic velocities, i.e. with high M-velocities higher than the specific M-velocity M_{*}=\sqrt{(γ−1)/γ},
in contrast to a case, wherein a body having an arbitrary shape is decelerating when air-fluxes, which flow nearby around the body, become warmer and extra-warmed,
a specifically-shaped body, having a two-humped airfoil profile providing for the two-stage operation of the Coanda-jet-effect, is accelerating, and air-fluxes, which flow nearby around the accelerating specifically-shaped body, become cooled and extra-cooled.

Cascaded Jet-Boosters

FIG. 9a is a schematic illustration of a sequential cascade of in-line arranged airfoil bodies 9011, 9013, 9014, 9015, and 9016, each in the shape of an elongated drop, exposed to oncoming wind 900 having the ambient M-velocity substantially lower than the specific M-velocity M_{*}=\sqrt{(γ−1)/γ}. The shape of the elongated drops is optimized using the equation of principle (6.13), basing on specified thickness of a boundary layer over convex withers, as described hereinabove referring to FIGS. 8a and 8b. Points 9012 symbolize that the sequence of airfoil bodies may be much longer than shown. For simplicity, oncoming wind 900 is laminar. Trace a moving-small-portion 910 of ambient oncoming wind 900 passing positions 911, 9110, 912, 913, 9130, 914, 9140, 915, 9150, 916, 9160, and 917, considering a case when moving-small-portion 910 is subjected to the Coanda-jet-effect in an adiabatic process, defined by the partial pressure-“c” P_{c}, rather than affected by the skin-friction resistance, quantified by the difference (a_{w}−a−δa). Moving-small-portion 910 at position 911 is yet to be subjected to the Coanda-jet-effect operation. I.e. at least the forward airfoil body 9011 meets moving-small-portion 910 with M-velocity, lower than the specific M-velocity M_{*}=\sqrt{(γ−1)/γ}, and so body 9011 operates as a jet-booster based on the Venturi-effect occurring in the adiabatic process in an imaginary tunnel adjacent to body 9011, as described above with reference to FIG. 8b. Further, moving-small-portion 910 is subjected to a cascaded operation of the Coanda-jet-effect in the adiabatic process by in-line arranged airfoil bodies 9011, 9013, 9014, 9015, and 9016, each of which operates as an elemental jet-booster, while meeting moving-small-portion 910 with M-velocity, lower than the specific M-velocity M_{*}=\sqrt{(γ−1)/γ}. The cascaded operation of the Coanda-jet-effect results in aligning of the Brownian random motion of moving-small-portion 910's molecules with the surfaces of in-line arranged airfoil bodies 9011, 9013, 9014, 9015, and 9016, that is observed as an increase of the effective velocity of moving-small-portion 910, accompanied by moving-small-portion 910 temperature decrease, as moving-small-portion 910 sequentially passes positions 9110, 9130, 9140, 9150, and 9160, where flowing as ambient-adjoining convergent-divergent jetstreams. Thus, this results in an increase of moving-small-portion 910's kinetic energy at the expense of moving-small-portion 910's internal heat energy. Consider certain identical cross-sectional areas at positions 911, 912, 913, 914, 915, 916, and 917, marked by dashed ellipses, such that the Coanda-jet-effect operation influence is still perceptible within the marked areas. Considering flow velocities much lower than the specific M_{*}=\sqrt{(γ−1)/γ}, the effective velocity of flow crossing the marked areas at positions 911, 912, 913, 914, 915, 916, and 917 increases exponentially as the flow moves along the sequential cascade of in-line arranged airfoil bodies 9011-9016. For example, if the Coanda-jet-effect operation of each of airfoil bodies 9011-9016 in the adiabatic process provides an increase of the effective velocity of a flow portion, crossing the associated marked area, on 2%, then after 35 airfoil bodies 9011-9016 the effective velocity of the wind portion, crossing the marked area, is twice as high as the velocity of oncoming wind 900 yet to be subjected to the Coanda-jet-effect multi-stage cascaded operation. Consider a case, when the M-velocity M₉₁₃₀ of moving-small-portion 910, flowing as an ambient-adjoining convergent-divergent jetstream nearby the withers of airfoil body 9013, reaches the specific M-velocity M_{*}=\sqrt{(γ−1)/γ} at position 9130. Triggering of the de Laval-like jet-effect causes the M-velocity M₉₁₄ at position 914 to become higher than the specific M-velocity M_{*}. The moving-small-portion 910 becomes cooled between positions 913 and 9130 and becomes extra-cooled between positions 9130 and 914. Running at airfoil body 9014, moving-small-portion 910 is subjected to the de Laval-like retarding-effect, such that the portion's M-velocity decreases down to the specific M-velocity M_{*}=\sqrt{(γ−1)/γ} at position 9140 nearby the withers of airfoil body 9014, and becomes lower than the specific M-velocity M_{*} at position 915. The moving-small-portion 910 becomes warmer between positions 914 and 9140 and becomes extra-warmed between positions 9140 and 915. Then moving-small-portion 910 is subjected to the de Laval-like jet-effect and the M-velocity increases again. Thus, when the sequence of airfoil bodies 9011-9016 is sufficiently long, the effective M-velocity of moving-small-portion 910 reaches the value of the specific M-velocity M_{*}=\sqrt{(γ−1)/γ} nearby the withers of airfoil bodies and varies around the value between the airfoil bodies. This is yet one more of the teachings of the present invention.

In view of the foregoing description referring to FIG. 9a, it will be evident to a person skilled in the art that, in a more general case, when oncoming wind 900 is turbulent, such that moving-small-portion 910 comprises whirling groups of molecules, the Coanda-jet-effect multi-stage cascaded operation results in aligning also of the turbulent motion of the whirling groups of molecules with the surfaces of in-line arranged airfoil bodies 9011, 9013, 9014, 9015, and 9016, that is observed as an increase of the effective velocity of moving-small-portion 910, accompanied by moving-small-portion 910's inner turbulence decrease, as moving-small-portion 910, flowing as ambient-adjoining convergent-divergent jetstreams nearby around the withers of airfoil bodies 9011, 9013, 9014, 9015, and 9016, sequentially passes positions 9110, 9130, 9140, 9150, and 9160, correspondingly. Thus, this results in an increase of moving-small-portion 910's kinetic energy also at the expense of moving-small-portion 910's inner turbulent energy.

In view of the foregoing description referring to FIG. 9a, it will be evident to a person skilled in the art that the effect of M-velocity acceleration and stabilization by a multi-stage cascaded operation of the Coanda-jet-effect thereby reinforced multi-repeatedly is applicable, for example, to a high-speed long-train design.

In view of the foregoing description referring to FIG. 9a, it will be evident to a person skilled in the art that the effect of M-velocity stabilization is applicable, for example, to a flying train-like object, in particular, supplied with wings, which are not shown here, providing for a lift-force.

In view of the foregoing description referring to FIG. 9a, it will be evident to a person skilled in the art that an arrangement of airfoil bodies 9011, 9013, 9014, 9015, and 9016 along a smoothly curved locus, instead of the in-line arrangement, can be implemented.

In view of the foregoing description referring to FIG. 9a, it will be evident to a person skilled in the art that the stabilized temperature difference between the extra-cooled airflow portions subjected to the triggered de Laval-like jet-effect and the extra-warmed airflow portions subjected to the triggered de Laval-like retarding-effect may be used to power a Peltier-element operating as a thermoelectric generator producing electricity.

FIG. 9b is a schematic illustration of a sequential multi-stage cascade of outer and nested airfoil rings 920, exposed to oncoming wind 921. Outer and nested airfoil rings 920 are formed by coiled-up walls having an airfoil-wing profile, similar, for example, to the profile of airfoil-wing 810, shown schematically in FIG. 8a. Thereby, outer and nested airfoil rings 920 have shapes of streamlined converging nozzles. The airfoil-wing profiles are optimized using the equation of principle (6.13), basing on specified thickness of a boundary layer over convex withers, as described hereinabove with the references to FIG. 8a. Points 929 symbolize that the sequence of outer and nested airfoil rings 920 may be much longer than shown. Airflow portions 922, flowing as ambient-adjoining convergent-divergent jetstreams, sliding outside of the sequential multi-stage cascade of outer rings 920, as well as wind portions 923, flowing and impacting inside of outer and nested airfoil rings 920, are subjected to the Coanda-jet-effect operation. Again, consider a case when airflow portions 922 and 923 are subjected to the Coanda-effect operation rather than to skin-friction resistance, thereby providing that each pair of outer and nested airfoil rings 920 operates as an elemental jet-booster. Airflow portions 922 and 923 join a cumulative outflow 924, wherein the Coanda-effect provides streamlines 925 forming an imaginary convergent-divergent nozzle downstream-behind the sequential multi-stage cascade of outer and nested airfoil rings 920. A long enough multi-stage cascade of outer and nested airfoil rings 920 provides that the M-velocity of resulting cumulative outflow 924 reaches the specific M-velocity M_{*}=\sqrt{(γ−1)/γ} at the minimal cross-section 926 of the imaginary convergent-divergent nozzle and the de Laval-like jet-effect is triggered downstream-behind the minimal cross-section 926. Airflow portion 927 is expanded adiabatically; therefore, it is extra-cooled and extra-accelerated. A prolonged multi-stage cascade of outer and nested airfoil rings 920 may enable the M-velocity of airflow portions 922 to reach the specific M-velocity M_{*} nearby the withers of airfoil outer rings 920. In this case, airflow portions 922 become subjected to the de Laval-like jet-effect, such that the effective M-velocity of airflow portions 922 is stabilized, as described hereinbefore with reference to FIG. 9a, considering a sequential multi-stage cascade of in-line arranged airfoil bodies, each having the shape of an elongated drop.

FIG. 9c is a schematic illustration of a modified sequential multi-stage cascade of the outer and nested airfoil rings 920 of FIG. 9b into a pair of unbroken spirals shaped as the Archimedean screws 931 and 932 by helical coiling-up walls having airfoil profile 937, for example, similar to described above with reference to FIG. 8a. Airfoil profile 937, also shown separately above and to the left in an enlarged scale, is optimized using the equation of principle (6.13), basing on specified thickness of a boundary layer over convex withers, as described hereinabove with the reference to FIG. 8a. Oncoming airflow portion 933 is yet to be subjected to the Coanda-jet-effect operation. Both: the sliding outside air sub-portions 934 flowing around and the inside impacting air sub-portions 935 flowing through the pair of spirals 931 and 932, are subjected to the Coanda-jet-effect operation, resulting in a converging flow when convergent flow sub-portions 934 and 935 laminarly join a resulting cumulative outflow 936. I.e. a fragment [for instance, one coil] of the pair of spirals 931 and 932 operates as an elemental jet-booster, and a longer fragment of converging spirals 931 and 932 provides higher acceleration of the airflow. Again, the Coanda-jet-effect provides streamlines 930 forming an imaginary convergent-divergent jet-nozzle downstream-behind the airfoil construction.

Moreover, the two spirals 931 and 932 have opposite helical screwing rotations, namely: clockwise and inverse-clockwise, thereby providing a variable cross-sectional area of gaps between the walls of the two spirals 931 and 932. The variable cross-sectional area of the gaps provides a Venturi effect for velocities lower than the specific M-velocity M_{*}=\sqrt{(γ−1)/γ} and the de Laval-like jet-effect for velocities providing for reaching the specific M-velocity M_{*}=\sqrt{(γ−1)/γ} at the critical condition point where the variable cross-sectional area of gaps becomes minimal. Sufficiently long converging spirals 931 and 932 provide acceleration of the airflow and stabilization of the effective velocity at the value of the specific M-velocity M_{*}=\sqrt{(γ−1)/γ} analogous to the cases described above with references to FIGS. 9a and 9b.

In view of the foregoing description of FIGS. 9a, 9b, and 9c, it will be evident to a person skilled in the art that one can implement many alterations, re-combinations and modifications of elemental jet-boosters, taught herein, without departing from the spirit of the disclosure that can be generalized as the following. A sufficiently long aggregation of elemental jet-boosters provides acceleration of an airflow portion, reaching the specific M-velocity M_{*}=\sqrt{(γ−1)/γ}, thereby triggering alternating the de Laval-like jet-effect and the de Laval-like retarding-effect, resulting in a stable alternation of the airflow portion effective M-velocity above and below the specific M-velocity M_{*}=\sqrt{(γ−1)/γ} between the elemental jet-boosters.

In view of the foregoing description of FIGS. 9a, 9b, and 9c, it will be evident to a person skilled in the art that the cumulative useful kinetic-power, including both: the originally brought kinetic-power and the acquired kinetic-power, provided by a multiplicity of elemental jet-boosters, aggregated into an adiabatic converging system, depends on a quality and quantity of the elemental jet-boosters and how the elemental jet-boosters are arranged and exploited. Moreover, it will be evident to a person skilled in the art that a sequential in-line multi-stage cascading of the elemental jet-boosters has especial sense.

For example, consider an aggregation comprising N elemental jet-boosters exposed to an ambient flow and oriented such that each elemental jet-booster provides an increase of the effective velocity of the flow portion moving through a certain effective cross-sectional area, by a factor F, wherein F>1, and for simplicity and without loss of the explanation generality, consider a case of sufficiently low velocity of the ambient flow and assume that it is the same factor, independently of the elemental jet-boosters arrangement and exploitation. As well, for simplicity, consider the case, when the M-velocities of accelerated flow remain lower than the specific M-velocity M_{*}=\sqrt{(γ−1)/γ}, thereby, justifying neglecting the flow density change in further approximate estimations. As the kinetic-power of a flow portion moving through a certain cross-sectional area is directly-proportional to the cross-sectional area and proportional to the third power of the flow portion velocity, each elemental jet-booster, when operating separately, launches a jetstream having the solitary useful kinetic-power, indicated by W₁, proportional to the third power of the factor F, expressed by W₁=W₀×F³, where W₀ is the originally brought ambient useful kinetic-power associated with the effective cross-sectional area of one elemental jet-booster.

The solitary acquired kinetic-power ΔW₁ is defined by the difference between the solitary useful kinetic-power W₁ and the originally brought ambient useful kinetic-power W₀, namely, ΔW₁=W₀(F³−1).

The aggregation, comprising N such elemental jet-boosters and thereby accelerating the flow portions, moving through N effective cross-sectional areas, results in the cumulative useful kinetic-power:
indicated by Wₚₐᵣₐₗₗₑₗ, equal to Wₚₐᵣₐₗₗₑₗ=N×W₁=N×W₀×F³, wherein the cumulatively acquired kinetic-power ΔWₚₐᵣₐₗₗₑₗ is defined as:

ΔWₚₐᵣₐₗₗₑₗ=N×ΔW₁=N×W₀(F³−1),
in the case, when the elemental jet-boosters operate independently, that occurs,
   if the elemental jet-boosters are arranged in parallel, or
   if the elemental jet-boosters are arranged sequentially, but operating in a not adiabatic process, allowing for the solitary useful kinetic-power W₁ to be consumed in parallel within or behind each elemental jet-booster and restored afore each next elemental jet-booster;
or, alternatively,
indicated by W_{sequential}, equal to W_{sequential}=W₀×(F³)^{N}, wherein the cumulatively acquired kinetic-power ΔW_{sequential} is defined as:

ΔW_{sequential}=W₀×[(F³)^{N}−N],
in the case, when the elemental jet-boosters are arranged sequentially operating in the adiabatic process, and the consumption of the cumulative useful kinetic-power is allowed behind the downstream-end of the last elemental jet-booster only.
   In an exemplary practical case, the effective velocity increase factor equals F=1.097. Then the following conditions become satisfied:
the condition W_{sequential}<Wₚₐᵣₐₗₗₑₗ is satisfied for N≦8;
the condition W_{sequential}>Wₚₐᵣₐₗₗₑₗ is satisfied for N≧9;
the condition W_{sequential}>2Wₚₐᵣₐₗₗₑₗ is satisfied for N≧13;
the condition W_{sequential}>3Wₚₐᵣₐₗₗₑₗ is satisfied for N≧15; and
the condition W_{sequential}>4Wₚₐᵣₐₗₗₑₗ is satisfied for N≧16.
   In view of the foregoing description of FIGS. 9a, 9b, and 9c, one of the primary teachings is that an artificial wind can be used for a profitable harvesting of electricity. For example, one can:
use a big-front ventilator [or group of ventilators], having 50%-net-efficiency, i.e. consuming electric-power W_{consumed} and creating an originally incoming artificial airflow, bringing kinetic-power W_{income}=0.5×W_{consumed}, wherein the originally incoming artificial airflow has the front area A_{income} of 4 times bigger than the effective cross-sectional area of an elemental jet-booster and has the effective velocity u_{income};
implement a sequential multi-stage cascade, comprising N=15 elemental jet-boosters, each of which is characterized by the effective velocity increase factor F=1.097, such that altogether making an outflowing artificial jetstream, having velocity uⱼₑₜₛₜᵣₑₐₘ=u_{income}×F^{N}[F^{N}=1.097¹⁵≈4] and having the resulting effective front cross-sectional area Aⱼₑₜₛₜᵣₑₐₘ, decreased approximately 4 times relative to the area A_{income} of originally incoming airflow [A_{income}/Aⱼₑₜₛₜᵣₑₐₘ=F^{N}≈4]. Thus, the outflowing artificial jetstream brings the resulting useful kinetic-power Wⱼₑₜₛₜᵣₑₐₘ, estimated as:

Wⱼₑₜₛₜᵣₑₐₘ=((uⱼₑₜₛₜᵣₑₐₘ/u_{income})³×(Aⱼₑₜₛₜᵣₑₐₘ/A_{income}))×W_{income}, i.e.

Wⱼₑₜₛₜᵣₑₐₘ=(4³/4)×W_{income}=(64/4)×0.5×W_{consumed}=8×W_{consumed}
and
use a wind-turbine, producing electricity with 50%-net-efficiency, thereby, harvesting the useful electric-power W_{useful} of 4 times higher than the consumed electric-power W_{consumed}, namely,

W_{useful}=0.5×Wⱼₑₜₛₜᵣₑₐₘ=0.5×(8×W_{consumed})=4×W_{consumed},

Wherein, the profit becomes greater than estimated, when the de Laval-like jet-effect is triggered. Thereby, in view of the foregoing description referring to FIGS. 9a, 9b, and 9c, it will be evident to a person skilled in the art that a profitable harvesting of electricity, using a jet-effect created by a multi-stage cascaded operation of the Coanda-jet-effect thereby reinforced multi-repeatedly, is feasible, for example, attaching sequentially arranged elemental jet-boosters to a sufficiently-long moving vehicle and using a wind-turbine, arranged behind the downstream-end of the last elemental jet-booster.

### Kinetic Energy Accumulation, Conservation, and Use

FIG. 9d illustrates schematically a circulating system 940 comprising a multi-stage cascade of many [8 shown] airfoil bodies 941 submerged in a fluid and arranged circumferentially. The rotation is in the inverse-clockwise direction as indicated by curved arrow 942.

For simplicity, the shape and multi-stage cascading of airfoil bodies 941 are similar to the shape and multi-stage cascading of airfoil bodies 9011-9016 described above with reference to FIG. 9a, but now an asymmetry of shapes and attack angles of airfoil bodies 941 are such that the trajectories of flowing fluid portions 944 are aligned with the associated arc of circling.

The fluid sub-portions 943, flowing around airfoil bodies 941, are subjected to the Coanda-effect and skin-friction; wherein when flowing adjacent to the withers of airfoil bodies 941, fluid sub-portions 943 are subjected to a cross-sectional varying, performing ambient-adjoining convergent-divergent jetstreams. Consider a case, when flowing fluid sub-portions 943 are subjected to the Coanda-effect operation rather than affected by the skin-friction resistance, and are, thereby, accelerated in the clockwise direction, forming flowing fluid portions 944 between circulating airfoil bodies 941. I.e. airfoil bodies 941 operate as elemental jet-boosters, analogous to the operation of airfoil bodies 9011-9016 (FIG. 9a).

The sequential operation of the Coanda-jet-effect results in fluid portion 944's velocity distribution within cross-sections 9440, wherein the distribution occurs at the expense of fluid portion 944's temperature decrease. The term “local velocity” refers to the velocity of a flowing fluid sub-portion relative to the nearest flying body 941. The local velocity is directed substantially along a local sagittal axis, associated with the nearest flying body 941.

The circulation creates a positive feedback loop, providing a cycling operation of the Coanda-jet-effect within an imaginary toroidal space having cross-sections 9440. The cycling operation of the Coanda-jet-effect results in further aligning of the Brownian random motion of fluid sub-portions 943 molecules with the profiles of airfoil bodies 941 that is observed as a further increase of the effective local velocity of circulating fluid sub-portions 943, accompanied by the fluid sub-portions 943 temperature further decrease. This provides further distribution of portions 944 local velocity and further acceleration of flowing fluid sub-portions 943 up to reaching the specific M-velocity M_{*}=\sqrt{(γ−1)/γ} in the narrowest cross-section near the withers. The reaching of the specific M-velocity M_{*}=\sqrt{(γ−1)/γ} triggers alternating both the de Laval-like jet-effect and the de Laval-like retarding-effect, similar to that described hereinbefore with reference to FIG. 9a. Thus, the M-velocities of sub-portions 943 become stabilized at the specific M-velocity M_{*}=\sqrt{(γ−1)/γ}, and M-velocities of flowing portions 944 alternate above and below the specific M-velocity M_{*}=\sqrt{(γ−1)/γ}. Thus, the stabilized circulation of portions 944 within the imaginary toroidal space, having cross-sections 9440, may be interpreted as a conservation of the flowing portions 944 kinetic energy within the imaginary toroidal space. The accumulated and conserved kinetic energy of flow, indicated by K_{acc}, is equal to K_{acc}=0.5ρ_{eff}Vₜₒᵣu_{eff}², where ρ_{eff} is the effective density of circulating fluid, Vₜₒᵣ is the volume of the imaginary toroidal space, and u_{eff} is the effective local velocity of the circulating fluid, equal to u_{eff}=M_{*}×u_{sound}, where u_{sound} is the speed of sound in the fluid.

In view of the foregoing description of FIG. 9d, it will be evident to a person skilled in the art that:
a part of the accumulated kinetic energy K_{acc} of flow can be consumed, for instance, in the form of a jetstream, outflowing from the imaginary toroidal space, that is not shown here; and
an arisen lack of the consumed kinetic energy of flow can be accumulated again up to the value K_{acc} by sucking fresh portions of the surrounding fluid into the imaginary toroidal space.

In view of the foregoing description of FIG. 9d, it will be evident to a person skilled in the art that circulating multi-stage cascade 940 operates similarly to a long in-line multi-stage cascade of many airfoil bodies 9011-9016 described hereinbefore with reference to FIGS. 9a, 9b, and 9c, but now fluid portions 944 move along a curved and closed trajectory. Such an implementation of inverse circulation of flow relative to the direction of bodies 941s' rotation is one of the teachings of the present invention as well.

In view of the foregoing description of FIG. 9d, and referring to the description of FIG. 4, it will be evident to a person skilled in the art that the fluid portion, circulating within the imaginary toroidal space and having the local velocity, static pressure, temperature, and density substantially distributed in cross-sections 9440, is subjected to inter-diffusion with the contacting fluid portion remained out of the imaginary toroidal space. This results, in particular, in a caloric exchange between the fluid portions.

In view of the foregoing description referring to FIG. 9d, it will be evident to a person skilled in the art that a circulating multi-stage cascade of elemental jet-boosters may function as a self-rotating warmth-to-motion engine.

FIG. 9e is a schematic top-view of a stationary circumferential arrangement of many [42 shown] elemental jet-boosters 950, thereby embodying a vortex-generator, constructed according to the principles of the present invention and exposed to natural ambient wind 951, bringing fresh air portions storing both:
the kinetic energy of flow [i.e. the kinetic energy the directional laminar motion, or, in terms of the kinetic theory of gas, the kinetic energy of the air molecules headway motion];
the kinetic energy of the Brownian random motion of air molecules [i.e. the inner heat]; and, in a more general case,
the kinetic energy of whirling groups of air molecules [i.e. the turbulent energy].

The center of the circle is marked by point 957. The elemental jet-boosters 950 have an effective height 9571 and the circumferential arrangement occupies a circle having effective overall diameter 9572. So, the circumferential arrangement overall shape is an imaginary cylinder having a base of effective overall diameter 9572 and a side of height 9571.

For simplicity, the shown shape and multi-stage cascading of elemental jet-boosters 950 are similar to the shape and multi-stage cascading of airfoil outer and nested airfoil rings 920 described hereinbefore with reference to FIG. 9b. The airflow portions 953, flowing through the inner space of elemental jet-boosters 950, and portions 955 and 956 flowing as ambient-adjoining convergent-divergent jetstreams nearby around elemental jet-boosters 950, are subjected to the Coanda-jet-effect operation and, thereby converge. The circumferential arrangement provides that some elemental jet-boosters 950 are oriented to natural ambient wind 951, such that they operate as converging-nozzles; and some other elemental jet-boosters 950 are oriented to natural ambient wind 951, such that they operate as divergent nozzles. This asymmetry of elemental jet-boosters 950 orientations causes the oncoming airflow front to be non-uniform in direction and therefore has a tendency to flow around a side of the arrangement, as schematically shown by arrows 952. Considering flow M-velocities much lower than the specific M-velocity M_{*}=\sqrt{(γ−1)/γ}, the multiplicity of elemental jet-boosters 950 causes accelerated wind sub-portions at position 954 to have local velocities, substantially higher than the velocity of natural ambient wind 951. This results in a circulation of airflow portions 953, 955, and 956 within an imaginary toroidal space, having effective overall diameter 9572 and a cross-section, marked by dashed ellipse 9573 having a diameter corresponding to effective height 9571. Circulating airflow portions 953, 955, and 956, become subjected to the Coanda-jet-effect circulating operation in a positive feedback loop, resulting in further aligning of the Brownian random motion of air molecules with the airfoil surfaces of elemental jet-boosters 950 that is observed as an increase of the effective local velocity of circulating airflow portions 953, 955, and 956, accompanied by the airflow portions temperature decrease. In a more general case, when airflow portions 953, 955, and 956 have inner turbulence, i.e. airflow portions 953, 955 and 956 comprise whirling groups of molecules, the Coanda-jet-effect multi-stage cascaded operation results in aligning also of the turbulent motion of the whirling groups of molecules with the airfoil surfaces of elemental jet-boosters 950, that is observed as an increase of the effective local velocity of airflow portions 953, 955, and 956, accompanied by the airflow portions inner turbulence decrease, as the airflow portions move within the imaginary toroid, sequentially passing elemental jet-boosters 950. Thus, this results in an increase of airflow portions 953, 955, and 956 kinetic energy also at the expense of airflow portions 953, 955, and 956 inner turbulent energy. The effective local velocity increase continues until reaching the specific M-velocity M_{*}=\sqrt{(γ−1)/γ}. Then the effective local velocity is stabilized triggering alternating both the de Laval-like jet-effect and the de Laval-like retarding-effect, as described hereinbefore with references to FIGS. 9a and 9d. In particular, an even number of jet-boosters 950 provides that the circulating airflow local velocities become steady-stately distributed in space. The circulating portions become cooled and extra-cooled, where the de Laval-like jet-effect is triggered, and become warmer and extra-warmed, where the de Laval-like retarding-effect is triggered.

In view of the foregoing description of FIG. 9e, and referring to the description of FIG. 4, it will be evident to a person skilled in the art that airflow portions 953, 955, and 956, circulating within the imaginary toroidal space and having the local velocity, static pressure, temperature, and density substantially distributed in cross-sections 9573, are subjected to inter-diffusion with the contacting airflow portions remained out of the imaginary toroidal space. This results, in particular, in the caloric exchange between the airflow portions.

In view of the foregoing description referring to FIG. 9e, it will be evident to a person skilled in the art that that the circumferential arrangement of many elemental jet-boosters 950 exposed to the natural ambient wind may function as a warmth-to-vortex/tornado generator that can power a rotor of an electricity generator.

In view of the foregoing description referring to FIG. 9e, it will be evident to a person skilled in the art that the circumferential arrangement of many elemental jet-boosters 950 exposed to the natural ambient wind accumulates and conserves the kinetic energy of flow K_{acc} independently of the direction of horizontal wind, as well as independently of any variation in the natural gusty wind direction, and furthermore, independently of any variation of the natural gusty wind non-zero velocity.

In view of the foregoing description referring to FIG. 9e, it will be evident to a person skilled in the art that the stabilized temperature difference between the extra-cooled airflow portions, subjected to the triggered de Laval-like jet-effect, and the extra-warmed airflow portions, subjected to the triggered de Laval-like retarding-effect, may be used to power a Peltier-element operating as thermoelectric generator producing electricity, while the consumed heat power is restoring at the expense of the surrounding air caloric entering the imaginary toroidal space.

In view of the foregoing description referring to FIG. 9e, it will be evident to a person skilled in the art that the circumferential arrangement of many converging airfoil bodies operating as elemental jet-boosters 950 exposed to natural ambient humid wind can be used, for example, as an air cooler triggering condensation of water-vapor into water-drops that can be applied to water harvesting from humid air. Furthermore, it will be evident to a person skilled in the art that the condensation of water-vapor into water-drops is an exothermic process resulting in that the stabilized circulation of airflow has the stabilized temperature defined by the so-called “dew-point temperature” corresponding to the humidity of ambient wind; thus, the area, bordered by the circumferentially arranged elemental jet-boosters, performs an oasis of a stably-eddying windiness and refreshing coolness.

In view of the foregoing description referring to FIG. 9e, it will be evident to a person skilled in the art that, in a more general case, the circumferential arrangement of many converging airfoil bodies, operating as elemental jet-boosters 950 exposed to natural ambient wind 951, can enable rotations around the vertical axis through point 957 and power a rotor of an electricity generator. Alternatively, different arrangements of wind-turbines can be adapted to use the fast rotations of wind portions, again, while the consumed heat-power is restoring at the expense of the surrounding air caloric entering the imaginary toroidal space.

In view of the foregoing description referring to FIGS. 9a, 9b, 9c, 9d, and 9e, it will be evident to a person skilled in the art that one can configure many modifications of airfoil bodies operating as elemental jet-boosters, providing flow acceleration due to a multi-stage cascaded operation of the Coanda-jet-effect to reach the specific M-velocity M_{*}=\sqrt{(γ−1)/γ} and, thereby, to trigger the de Laval-like jet-effect arising.

In view of the foregoing description referring to FIGS. 9a, 9b, 9c, 9d, and 9e, it will be evident to a person skilled in the art that one can configure many modifications of elemental jet-boosters arrangements along smoothly curved loci, instead of the circumferential arrangement. The arrangement locus can be at least one of a line, an arc, a spiral of Archimedes, an outer helical outline of the Archimedean screw, a rounded contour, an ellipse, and a circumference.

FIG. 9f is a schematic top-view of an adiabatic aerodynamic system 960, constructed according to the principles of the present invention, comprising:
the stationary circumferential arrangement of many elemental jet-boosters 950, described above with reference to FIG. 9e having the same reference numerals 951, 952, 953, 954, 955, 956, 957, 9571, 9572, and 9573; and
stationary airfoil wings 958, arranged within the mentioned imaginary cylinder having the basis of effective overall diameter 9572 and the side of height 9571.

Airflow portions 959 are entrapped and drawn by stably circulating adjacent airflow portions 956, and so are stably circulating as well.

In one application, stationary airfoil wings 958 are configured and oriented to originate lift-forces under the influence of stably circulating airflow portions 959.

Alternatively, the airfoil wings 958 have symmetrical airfoil shape relative to a horizontal plane, and thereby do not originate lift-forces, but result in reactive thrust-forces directed along local sagittal axes, associated with nearest airfoil wings 958, due to the jet-effect as described hereinbefore referring to FIG. 8b, thereby enabling airfoil wings 958 rotations around the vertical axis through point 957. Wherein, if airflow portions 959 are subjected to the Coanda-effect operation rather, than affected by the skin-friction resistance, then airfoil wings 958 rotation is in the inverse-clockwise direction, i.e. against the direction of airflow portions 959 rotation. This phenomenon is one of the teachings of the present invention as well.

In view of the foregoing description referring to FIG. 9f, it will be evident to a person skilled in the art that the lift-force, acting on wings 958, is independent of the direction of horizontal natural ambient wind 951, as well as independent of any variation in the natural gusty wind direction, and furthermore, independent of any variation of the natural gusty wind non-zero velocity; and it will be evident to a person skilled in the art that the lift-force, acting on wings, can be controlled by the airfoil wings configuration, arrangement, and orientation. An implementation of an adiabatic aerodynamic system, having no moving parts and providing for a stable and predictable lift-force generated at the expense of ambient air heat energy, is also one of the teachings of the present invention.

In view of the foregoing description referring to FIGS. 9e and 9f, it will be evident to a person skilled in the art that, implementing an adiabatic aerodynamic system comprising a circumferential arrangement of many elemental jet-boosters, either a wide-front fluid flow or many fluid jetstreams, made artificially, can be used instead of the natural ambient wind.

In view of the foregoing description referring to FIG. 9f, it will be evident to a person skilled in the art that the principles, applied to the construction of adiabatic aerodynamic system 960, allow for a design of a flying-saucer. Wherein, in contrast to a principle of helicopter, where rotating wing-like blades interact with stationary air, here, stationary wings 958 interact with rotating airflow portions 959. As well, to provide a controlled maneuvering, adiabatic aerodynamic system 960 can be supplied with airfoil blades, similar to stationary wings 958, but having controllable degrees of freedom to be oriented asymmetrically relative to point 957, thereby, redirecting the stably circulating airflow portions out of the adiabatic aerodynamic system and allowing for a reactive push in any desired direction, as well as for stabilizing the flying-saucer position in atmosphere. Furthermore, in view of the foregoing description referring to FIG. 9f, it will be evident to a person skilled in the art that the energy, conserved in the form of the stably circulating airflow portions kinetic energy, allows for a fast maneuvering of the flying-saucer.

In view of the foregoing description referring to FIG. 9f, it will be evident to a person skilled in the art that adiabatic aerodynamic system 960, exposed to natural humid wind, can be adapted for the humidity condensation, and thereby, water harvesting from humid air. To estimate an efficiency of the water condensation, consider a stationary circumferential arrangement of many elemental jet-boosters 950 exposed to natural ambient humid wind moving with velocity, indicated by u₉₅₁, and characterized by parameters of static pressure P₉₅₁, temperature T₉₅₁, density ρ₉₅₁, and relative humidity h₉₅₁, wherein in a normal exemplary case, the parameters are quantified as: u₉₅₁=10 m/sec, P₉₅₁=100 kPa, T₉₅₁=298K, ρ₉₅₁=1.2 kg/m³, and h₉₅₁=60%. The values of P₉₅₁, T₉₅₁, ρ₉₅₁, and h₉₅₁, correspond to absolute humidity H₉₅₁=14 g/m³ and so-called “dew-point temperature”, equal to T_{dew}=289K for the case. Consider an exemplary implementable case, when the effective overall diameter 9572 is equal to D₉₅₇₂=20.3 m, and the stabilized air motion with effective M-velocity, indicated by M₉₅₇₃, equal to the specific M-velocity M_{*}=\sqrt{(γ−1)/γ}, is through cross-sections 9573, having the effective diameter, indicated by d₉₅₇₃, equal to 0.5 m. The volume of the imaginary toroidal space, having the effective overall diameter D₉₅₇₂ and the cross-sectional diameter d₉₅₇₃, is equal to Vₜₒᵣ=π×D₉₅₇₂×0.25π×d₉₅₇₃²≈12.5 m³, and the imaginary toroidal space bordering area, indicated by Aₜₒᵣ, is equal to Aₜₒᵣ=πD₉₅₇₂×πd₉₅₇₃≈100 m². The imaginary toroidal space volume Vₜₒᵣ comprises potentially yet to be condensed water-vapor, having mass M_{V}, equal to M_{V}=VₜₒᵣH₉₅₁≈175 g. The acquired kinetic energy of the circulating airflow, K_{acquired}, is defined as K_{acquired}=0.5×Vₜₒᵣ[ρ_{eff}u_{eff}²−ρ₉₅₁u₉₅₁²], where the effective local velocity u_{eff} of the airflow, circulating within the imaginary toroidal space, is quantified as u_{eff}=M₉₅₇₃×u_{sound}≈184 m/sec, and the effective density ρ_{eff} interrelates with the stabilized dew-point temperature T_{dew}, according to the Clapeyron-Mendeleev gas state law for an adiabatic process. Namely,

$${ρ}_{eff} = {{ρ}_{951} ( \frac{{T}_{dew}}{{T}_{951}} )}^{\frac{1}{γ - 1}} \approx 1.2 \times {( 289 / 298 )}^{2.5} \approx 1.1 kg / {m}^{3}$$

Thereby, the acquired kinetic energy K_{acquired}, is estimated approximately as

K_{acquired}=0.5×Vₜₒᵣ[ρ_{eff}u_{eff}²−ρ₉₅₁u₉₅₁²]≈0.5×12.5×[1.1×184²−1.2×10²]≈232 kJ.

To reach the dew-point temperature making the air portion saturated with humidity, the circulating humid air portion of the volume Vₜₒᵣ must lose the internal heat energy, estimated as:

ΔE=ρ_{eff}VₜₒᵣR(T₉₅₁−T_{dew})≈1.1×12.5×(8.31/0.0285)×9≈38 kJ.

The estimated value of the acquired kinetic energy K_{acquired} is much greater than the value of internal heat energy loss ΔE, so after reaching the dew-point temperature, the energy difference (K_{acquired}−ΔE)≈194 kJ goes to trigger the water condensation process. Condensation of water at the dew-point temperature requires a reducing of the saturated humid air portion's heat energy per unit mass on the value Λ_{water}=2260 kJ/kg. Thereby, the estimated acquired kinetic energy of airflow K_{acquired} potentially may be accompanied by the condensed water amount of M_{water}=(K_{acquired}−ΔE)/Λ_{water}≈86 g. The value M_{water} is substantially lesser than the estimated above mass M_{V} of water-vapor that potentially could be condensed, so the water mass amount M_{water}≈86 g is actually feasible for condensation.

Further, a part of the circulating airflow can be permanently withdrawn in the form of outflowing jetstreams, for instance, under the influence of wings 958, arranged adjacent to the elemental jet-boosters 950 to redirect circulating airflow portions 959, resulting in drawing out air portions 956, 954, and 955 from the imaginary toroidal space. The outflowing jetstreams take away the acquired kinetic energy of circulating airflow K_{acquired}. As the accumulated kinetic energy K_{acc} of the airflow, circulating within the imaginary toroidal space, has a tendency to stabilization, so, an arisen lack of the accumulated kinetic energy of airflow K_{acc}, caused by the withdrawn of the acquired kinetic energy of airflow K_{acquired}, has a tendency to be reacquired again by sucking fresh portions of the surrounding air into the imaginary toroidal space and further, by an acceleration of the sucked fresh portions, increasing the sucked fresh portions local velocity up to the stabilized effective local velocity u_{eff}=M_{*}×u_{sound}. The possible airflow discharge from and sucking into the imaginary toroidal space, indicated by Q_{fresh}, is defined by the condition Q_{fresh}>Aₜₒᵣu₉₅₁, as the ambient velocity u₉₅₁ is substantially lower than the expected airflow local velocities at the borders of the imaginary toroidal space. Thus, the condition of the possible airflow discharge Q_{fresh} is quantified as Q_{fresh}>1000 m³/sec. The possible airflow discharge Q_{fresh} is much greater than the airflow F₉₅₇₃ moving through cross-section 9573 of the imaginary toroidal space, estimated as F₉₅₇₃=0.25π×d₉₅₇₃²×u_{eff}≈36 m³/sec, and is sufficient to refresh the humid air in the imaginary toroidal space volume Vₜₒᵣ, several times per second, indicated by N_{refresh}, defined and estimated as N_{refresh}=Q_{fresh}/Vₜₒᵣ>80 sec⁻¹. The intensity of water condensate harvesting, indicated by F_{condensation}, is defined by the feasible condensed water amount M_{water}≈86 g multiplied on the N_{refresh}. Thus, the intensity of water condensate harvesting F_{condensation} is estimated as:

F_{condensation}=N_{refresh}×M_{water}>6.88 kg/sec≈413 kg/min.

The estimated intensity of water harvesting F_{condensation} is at least of the same order of the value as a flux of water head discharging from a hose of a fire-extinguishing machine. Thereby, a stationary circumferential arrangement of many elemental jet-boosters 950 can be used for water harvesting from air for domestic and industrial needs, and, for example, attached to a helicopter, can be adapted for a fire-extinguishing.

In view of the foregoing description referring to FIG. 9f, it will be evident to a person skilled in the art that airfoil wings 958, exposed to stably-circulating airflow portions 959 and enabling rotations around the vertical axis through point 957, may power a rotor of an electricity generator. Alternatively, the stabilized temperature difference between the extra-cooled airflow portions, subjected to the triggered de Laval-like jet-effect, and the extra-warmed airflow portions, subjected to the triggered de Laval-like retarding-effect, may be used to power a Peltier-element operating as thermoelectric generator producing electricity, while the consumed heat power is restoring at the expense of the surrounding air caloric entering the imaginary toroidal space. Thus, the acquired kinetic energy of airflow K_{acquired}, refreshed N_{refresh} times per second, may provide an acquired kinetic-power of airflow W_{acquired}, defined as F_{acquired}=N_{refresh}×K_{acquired}. Taking into the account the estimations made herein above, the possible acquired kinetic-power of airflow W_{acquired} is estimated as: W_{acquired}>18.56 MW. Thereby, a relatively compact stationary circumferential arrangement of many elemental jet-boosters 950 can be used for electrical power producing for domestic and industrial needs.

In view of the foregoing description referring to FIGS. 9a, 9b, 9c, 9d, 9e, and 9f, it will be evident to a person skilled in the art that the circumferential arrangement of many elemental jet-boosters exposed to moving seawater can be adapted for electricity harvesting from the seawater motion.

In view of the foregoing description referring to FIGS. 9e and 9f, it will be evident to a person skilled in the art that the circumferential arrangement of many converging airfoil bodies operating as elemental jet-boosters 950 exposed to either natural or artificial wind can be used, for example, as a wind tunnel in an aerodynamic laboratory, providing a stable spatial distribution of the wind velocities.

### Improved Wind-Turbine

FIG. 9g is a schematic drawing of modified improved wind-turbine 9.0, constructed according to the principles of the present invention to operate under fast airflow 9.1 for producing the electrical power at the expense of the warmth of fast airflow 9.1.

Modified improved wind-turbine 9.0 comprises:
axle 9.2 oriented along sagittal axis 9.21 codirected with fast airflow 9.1,
identical asymmetrical biconvex airfoil blades 9.3, attached to axle 9.2; and
an engine [not shown here], capable of transforming the power of the forced mechanic rotational motion 9.4 of axle 9.2 into the electrical power.

The presence of covering airfoil corpus 9.5, having an optimized proportion between the inlet and outlet cross-sectional areas, is optional and not obligatory.

The primary feature, making the modified wind-turbine 9.0 practically implementable and extremely efficient, is the specifically configured and so specifically functioning biconvex airfoil blades 9.3. Namely, in contrast to standard wind-turbines having standardly shaped blades configured to be subjected to impacting by an incoming airflow that, in particular, results in the airflow turbulence, retarding, and warming, the modified improved wind-turbine 9.0 has asymmetrical biconvex wing-like airfoil blades 9.3:
having opposite convex sides 9.31 and 9.32 with withers differing in convexity and
being oriented along and so adapted to the incoming fast airflow jetstream 9.1 headway motion.
   Thereby configured and oriented blades provide the so-called zero attack angle:
to exclude or at least to minimize the impact by the incoming fast airflow jetstream 9.1, but
to provide an interaction with the fast airflow jetstream 9.1 by the Coanda-jet-effect only, thereby resulting in an acceleration and cooling of outflowing jetstream 9.6 and resulting in lift-forces, acting on identical biconvex airfoil blades 9.3 and being disbalanced because of the aligned asymmetry of the identical biconvex airfoil blades.
   In this case, the axle 9.2 rotational motion, shown by the curved arrow having numeral 9.4, is caused by the cumulative resulting lift-force. Take note again, that the Coanda-jet-effect is triggered by the airflow kinetic-power and is actually powered at the expense of the airflow warmth but not at the expense of the incoming fast airflow jetstream 9.1 kinetic-power; contrariwise, the kinetic-power of outflowing jetstream 9.6 is increased or at least not decreased with respect to the incoming fast airflow jetstream 9.1. Thus, in contrast to the standard wind-turbines, the proposed improved wind-turbine 9.0 is specifically characterized:
by the mechanism of operation, that is the Coanda-jet-effect but not the impact; and
by the power source of operation, that is the warmth but not the kinetic power of airflow.

Also, in contrast to a kind of the standard wind-turbines having wing-like blades moving around a vertical axis, the proposed improved wind-turbine 9.0 is specifically characterized by the excluding of varying poorly-streamlined positions of the wing-like blades.

As well, in contrast to the standard wind-turbines, a productivity of the proposed improved wind-turbine 9.0 is defined by the area of the biconvex airfoil blades rather than by a so-called “swept area”, namely, the produced electrical power due to the Coanda-effect is specified as proportional to the biconvex airfoil blades area, i.e. the productivity can be increased substantially for a given swept area.

In view of the foregoing description referring to FIG. 9g, it will be evident to a person skilled in the art that modified improved wind-turbine 9.0 comprising:
the biconvex airfoil blades, having a wing-like sectional contour with a longer so-called chord of wing, and/or
an increased quantity of the biconvex airfoil blades,
   both circumstances provide for enforcing of the desired Coanda-jet-effect. As well, it is self-suggested a sequential in-line arrangement of a multiplicity of modified improved wind-turbines 9.0 one downstream after another (optionally, alternatingly differing in asymmetry to become forcedly rotated alternatingly clockwise and inverse-clockwise, correspondingly), each separately and all together efficiently operating within the given swept area.

Moreover, at least one of the profiles 9.31 and 9.32 is implemented to provide the de Laval enhanced jet-effect, when the incoming fast airflow jetstream 9.1 is flowing with a de Laval M-velocity and so a portion of jetstream 9.1 is reaching the specific M-velocity nearby the withers of the asymmetrical biconvex airfoil blades 9.3. In this case, the extra-efficiency of the modified improved wind-turbine is expected.

Furthermore, optionally, sides 9.31 and 9.32 differ in shape such that one of the sides has one convex withers and the opposite side has a two-humped airfoil profile providing for the two-stage operation of the Coanda-jet-effect as described hereinabove with the reference to FIG. 8d. Such asymmetrical blades, when exposed to incoming fast airflow jetstream 9.1 moving with a high M-velocity, higher than the specific M-velocity, become subjected, on the one hand, to the de Laval retarding effect, and on the other hand, to the de Laval enhanced jet-effect. This provides for extra-increased lift-forces rotating axle 9.2. In this case, the extra-efficiency of the modified improved wind-turbine is expected in a wide range of velocities.

In view of the foregoing description referring to FIG. 9g, it will be evident to a person skilled in the art that modified improved wind-turbine 9.0, when attached to a flying aircraft, is capable for efficient harvesting of the electrical power from the ambient air warmth.

In view of the foregoing description referring to FIG. 9g in combination with the foregoing description of subparagraphs “Point of Sail” and “Flying Large Bird”, both with the reference to prior art FIG. 1i, it will be evident to a person skilled in the art that the construction of modified improved wind-turbine 9.0, when having a controllable speed of the axle 9.2 rotation adapted to the velocity of incoming airflow 9.1 to keep the airflow remaining laminar, provides a controllable net thrust against the incoming airflow and so becomes applicable as a kind of jet-engine for a controllable and substantially noiseless flying.

### Method for Computational Analysis

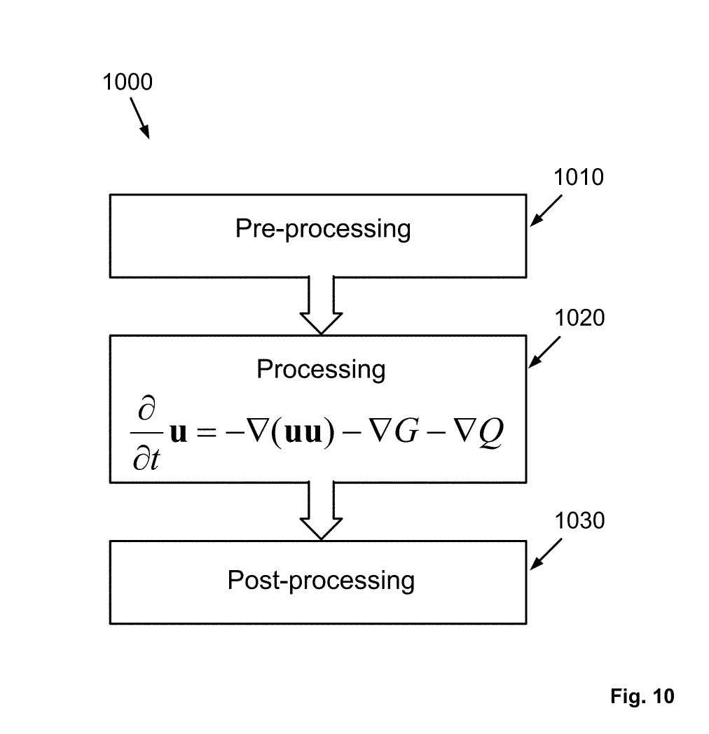

FIG. 10 is a schematic block-diagram 1000 of a method for computational fluid dynamics numerical analysis, based on the principles of the present invention.

Block 1010 represents standard pre-processing comprising a defining the calculation space and mesh for the space quantization.

Block 1020 represents the processing itself, i.e. the algorithm calculating numerically the spatial distribution of the velocity-vector (three components), static pressure, temperature, and density (total six components), programmed according to the principles of the present invention, and applying a computational analysis basic principle, comprising a digital approximation of a space, comprising the flowing fluid, by a virtual spatial mesh partitioned into non-overlapping quantization cells bordered by imaginary boundaries.

The processing is such that the calculated spatially distributed values are satisfied, on the one hand, to suggested modified equations of fluid motion (5.6), (5.7), (5.9) having an exact solution, and, on the other hand, to the gravitational, thermodynamic, and kinetic theory laws represented by specified equations (5.2), (5.3), (5.4), (5.5), and (5.8), wherein the adequacy of the solution is confirmed by the Bernoulli theorem, equation (5.10).

Block 1030 represents the standard post-processing procedure for the solution filing and visualization.

Thereby, one can implement blocks 1010, 1020, and 1030 as a computer program product comprising a computer usable medium having computer readable code and instructions embodied and stored therein for execution on a general purpose computer. The code and instructions, when executed by the computer, cause the computer to perform the method for computational fluid dynamics.

The method, based on the kinetic theory of matter, provides the modified equations of fluid motion, thereby, reducing a sense of one of the Millennium Goals to solve the problem of the Navier-Stokes equation solution existence.

Considering a fluid as a substance composed of randomly moving molecules, the method enables applications optimization, the physical essence of which is to bring-in an asymmetrical influence into the molecular fluid, and, thereby, to originate a motion of molecules in a prevalent direction. For instance, such an asymmetry is provided by a structured and heated surface thereby repelling the molecular fluid in a prevalent direction, or by a structured naturally hydrophobic surface contacting with water, or by a structured and electrically charged surface interacting with an ionized fluid, or by an airfoil body moving relative to the molecular fluid and thereby acting on the molecular fluid by the Coanda-effect.

The method enables optimized designs of apparatuses for electricity harvesting from the molecular fluid heat energy, providing a positive net-efficiency. The method, accompanied by novel teachings, allows for optimized designs of engines having novel functionalities, for examples, such as:
Fluid-repellent jet-gears, described with references to FIGS. 5d, 5e, 5f, 5h, 5i, 5j, and 5k, which, when submerged in ambient fluid, originate a circulating and/or headway self-motion at the expense of the ambient fluid warmth; as well, creating a controllable omniphobic repellency using heating elements, one can originate a fluid-repellent jet-gear motion with a high net-efficiency, even higher than 100%, again, at the expense of the ambient fluid warmth;
A capillary tube having inner saw-like hydrophobic walls, described with reference to FIG. 5d, which, when filled with water, provides the water transportation;
Referring to FIG. 5i comprising a spiral, having a form of the Archimedean screw and having a hydrophobic surface, a mechanism, synthesizing a natural protein, or more fundamentally, of ribonucleic acid (RNA) molecules, hypothetically, can be specified and implemented artificially;
An electrically charged propeller-like jet-gear, described with references to FIG. 5h, which, when submerged in an ionized gas or liquid, provides a motion of the jet-gear at the expense of the ionized fluid's warmth;
An optimized convergent-divergent tunnel, described with reference to FIG. 6a, which, when triggering the de Laval enhanced jet-effect, provides conditions to acquire a kinetic power and/or to harvest electricity from air warmth with a positive net-efficiency;
A two-stage convergent-divergent jet-nozzle, described with reference to FIG. 6h, which, when exposed to transonic and/or supersonic and/or hypersonic flow, in contrast to the known phenomenon of the incoming flow warming and retarding, provides the incoming flow cooling and acceleration;
An airfoil flying capsule having an optimized single-stage or two-stage convergent-divergent tunnel, which, when moving in air, is capable of transforming the air warmness into a useful jet-thrust;
An improved propeller, preferably composed of many small propellers distributed in space, which focuses and/or defocuses sub-portions of air, thereby forming a cumulative blowing and/or sucking jetstream, correspondingly, wherein the jetstream has an optimally-variable cross-section providing for the critical condition, triggering the de Laval-like enhanced jet-effect;
An improved wind-turbine configured:
   to exclude or at least to minimize the impact by incoming airflow, but
   to trigger at least one of the Coanda-effect and the de Laval enhanced jet-effect, both having the jet-effect nature, and, in the final analysis,
   to produce the electrical power at the expense of the airflow warmth but not at the expense of the airflow kinetic-power; and
An adiabatic aerodynamic system, described with reference to FIGS. 9e and 9f, comprising a stationary circumferential arrangement of many elemental jet-boosters, that is capable of acquiring the kinetic energy of circulating airflow at the expense of the ambient air heat energy, further, to accumulate and conserve the airflow kinetic energy in a form of stably-circulating airflow. Wherein the adiabatic aerodynamic system, exposed to the natural ambient wind, accumulates and conserves the kinetic energy of the stably-circulating airflow independently of weather conditions, namely, independently of the direction of horizontal wind, as well as independently of any variation in the natural gusty wind direction, and furthermore, independently of any variation of the natural gusty wind non-zero velocity. This provides at least the following novel applications:
   The adiabatic aerodynamic system can operate as vortex-generator of an electro-station, providing for electrical power harvesting from the warmth of natural air. Furthermore, it is found that the adiabatic aerodynamic system exposed to an artificial wind, made by consuming either a power of burned fuel or an electrical power, under certain conditions, can convectively accelerate the wind at the expense of the airflow warmth providing an acquired kinetic power of airflow being higher than the power consumed for the making of artificial wind;
   The adiabatic aerodynamic system can be used as engine, powering a flying-saucer of high mobility, wherein, in contrast to a principle of helicopter where rotating wing-like blades interact with stationary air, here, just stationary wings of the flying-saucer interact with the stably-circulating airflow;
   The adiabatic aerodynamic system can be adapted for a condensation of natural air humidity, wherein, considering a relatively compact adiabatic aerodynamic system, an estimated intensity of the water harvesting is at least of the same order of the value as a flux of water head discharging from a hose of a fire-extinguishing machine; and
   The adiabatic aerodynamic system, made in large-scale, can be used as a windbreak of an oasis of a stably-eddying windiness and refreshing coolness.

The method enables a technology to control the transformation of the surrounding air and/or water warmth into a directional motion of the fluid providing for a renewable cycle, comprising:
transformation of the flowing fluid heat-power into acquired kinetic-power of an originated jetstream;
conversion of the jetstream kinetic-power into useful electric-power; and
consumption of the electric-power, in the final analysis, inevitably dissipating back into the warmth of surrounding matter.

### DRAWINGS

It should be understood that the sketched exemplary embodiments are merely for purposes of illustrating the teachings of the present invention and should in no way be used to unnecessarily narrow the interpretation of, or be construed as, being exclusively definitive of the scope of the claims which follow.

It is anticipated that one of skill in the art will make many alterations, re-combinations, and modifications of the embodiments taught herein without departing from the spirit and scope of the claims.

I claim:

1. A method for computational fluid dynamics; said method for computational fluid dynamics comprising a computational analysis basic principle, providing for a digital approximation of a space by a virtual spatial mesh partitioned into non-overlapping quantization cells, thereby each said non-overlapping quantization cell occupies a volume bordered by imaginary boundaries;
wherein said space is filled with a fluid matter composed of moving and inter-acting molecules, wherein motion of the molecules comprises two components: the Brownian random motion and a motion in a prevalent direction;
wherein a set of interrelated terms being defined as follows:
(a) a molecular fluid is defined as said fluid matter composed of moving and inter-acting molecules;
(b) a small portion is defined as a portion of said molecular fluid occupying said non-overlapping quantization cell;
(c) an excluded volume is defined as a volume, excluded by presence of molecules in the van der Waals theory of said molecular fluid;
(d) a stationary wall is defined as a stationary impermeable surface;
(e) wall-fluid molecular interaction van der Waals forces are defined as molecular inter-attraction forces between said stationary wall and fluid matter molecules, wherein said wall-fluid molecular interaction van der Waals forces being at least one of
phobic-repulsive forces, directed inward said small portion,
inert to the molecules of said fluid matter, and
sticking attractive forces, directed outward said small portion;
(f) an inert wall is defined as a kind of said stationary wall being hypothetically inert to said fluid matter molecules;
(g) a stationary body corpus is defined as a space-portion bordered by said stationary walls;
(h) a flow is defined as a motion of said molecular fluid, wherein the flow is characterized by the following spatially distributed parameters:
three components of velocity-vector, indicated by u, related to the molecules motion in the prevalent direction and defined as a velocity-vector of said small portion motion relative to said stationary body corpus; wherein the absolute value of said velocity-vector u equals u, and, when measured in Mach numbers, equals M;
absolute temperature, indicated by T, defined by the molecules Brownian random motion, according to the kinetic theory of matter, as a measure proportional to the average molecular kinetic energy of said fluid matter molecules Brownian random motion,
inner-static-pressure, indicated by Pᵢₙ, defined as a measure of a cumulative impact effect caused by of said fluid matter molecules Brownian random motion, according to the kinetic theory of matter, and
density, indicated by ρ, defined as a measure of concentration and mass of said fluid matter molecules, according to the kinetic theory of matter, said density equal to said molecular fluid mass per unit volume;
(i) a steady-state flow is defined as the flow characterized by said spatially distributed parameters being constant in time;
(j) a hypothetical ideal gas is defined, according to the kinetic theory of matter, as said molecular fluid such that inter-molecular forces are negligible and said excluded volume is inessential;
(k) a stationary-small-portion is defined as said small portion, being static relative to said stationary body corpus;
(l) a moving-small-portion is defined as said small portion, moving with the velocity-vector u relative to said stationary body corpus;
(m) static pressure of said hypothetical ideal gas, indicated by ρ_{ideal}, is defined as a measure of said hypothetical ideal gas's molecules cumulative impact on said inert wall of a stationary container, wherein the static pressure of said hypothetical ideal gas P_{ideal} is quantified by the Clapeyron-Mendeleev gas law as equal to
P_{ideal}=ρᵢR₀Tᵢ/μᵢ, where
ρᵢ is the density of said hypothetical ideal gas,
Tᵢ is the absolute temperature of said hypothetical ideal gas,
R₀ is the universal gas constant, and
μᵢ is the molar mass of said hypothetical ideal gas;
(n) the van der Waals static pressure of said molecular fluid, indicated by P_{Waals}, is defined as a measure of said fluid matter molecules cumulative impact on said inert wall of a stationary container, wherein the van der Waals static pressure is quantified by the van der Waals equation of state for said molecular fluid, namely:
(P_{Waals}+a/Vₛ²)=ρₛrₛR₀Tₛ/μₛ, where
R₀ is the universal gas constant, and
a, rₛ, ρₛ, Vₛ, μₛ, and Tₛ are parameters characterizing matter and state of said stationary-small-portion of said molecular fluid, namely:
ρₛ is the density,
Tₛ is the absolute temperature,
μₛ is the molar mass,
Vₛ is the volume,
a is the van der Waals parameter defining said molecular fluid's inter-molecular forces; and
rₛ is the compression ratio of said molecular fluid,
wherein rₛ equals Vₛ/(Vₛ−b),
where b is the van der Waals parameter quantifying said excluded volume;
wherein the van der Waals equation of state for said molecular fluid is defined in a wider sense, allowing for the van der Waals parameters a and b to be variable;
(o) inner-stationary-static-pressure of said molecular fluid, indicated by Pₛ, is defined as a measure of said fluid matter molecules cumulative stationary-impact on said non-overlapping quantization cell's imaginary boundaries associated with said stationary-small-portion, and wherein the van der Waals equation of state for said molecular fluid, written in a form expressing said inner-stationary-static-pressure, is:
Pₛ=(P_{Waals}+a/Vₛ²)=ρₛRₛTₛ=ρₛQₛ, where
Rₛ and Qₛ are parameters characterizing the matter and state of said stationary-small-portion of said molecular fluid, namely:
Rₛ is the specific fluid constant equal to Rₛ=rₛR₀/μₛ, and
Qₛ is the characteristic heat portion per unit mass, stored in said molecular fluid's molecular Brownian random motion related to degrees of freedom causing said fluid matter molecules cumulative stationary-impact and quantified as Qₛ=RₛTₛ;
(p) a stationary-effect is defined as an effect of interrelating the parameters: Pₛ, a, b, rₛ, ρₛ, Vₛ, μₛ, Rₛ, Tₛ, and Qₛ according to the van der Waals equation of state for said molecular fluid, namely:
Pₛ=(P_{Waals}+a/Vₛ²)=ρₛRₛTₛ=ρₛQₛ;
(q) a stagnation-impact-effect is defined as an effect, related to said moving-small-portion flowing in a boundary layer adjacent to said stationary wall and being stagnated, and is defined as a cumulative impact of said fluid matter molecules on said non-overlapping quantization cell's imaginary boundaries, associated with said moving-small-portion flowing in the boundary layer; wherein said stagnation-impact-effect arises in addition to said stationary-effect and is characterized by a changed volume of said moving-small-portion and so by a changed compression ratio, indicated by r, associated with said moving-small-portion and quantified as r=V/(V−b), where
V is the volume of said moving-small-portion being stagnated, and
b is the van der Waals parameter quantifying said excluded volume associated with said moving-small-portion being stagnated; and
wherein partial stagnation pressure-“b”, indicated by δP_{b}, is defined as a measure of said stagnation-impact-effect, wherein the compression ratio r, associated with said moving-small-portion being stagnated, differs from the compression ratio rₛ, associated with said stationary-small-portion, so that providing for the conditions r=rₛ and δP_{b}=0 being interrelated;
and wherein a generalized specific fluid constant, indicated by R, is related to said moving-small-portion and defined as equal to R=rR₀/μ, where μ, identical with μₛ, is the molar mass of said molecular fluid;
(r) wherein a deep-stagnation-effect of an arisen inter-molecular stress is defined as an effect, related to said moving-small-portion flowing in a boundary layer adjacent to said stationary wall and being deeply-stagnated;
wherein said deep-stagnation-effect arising in addition to said stationary-effect and said stagnation-impact-effect; and wherein said deep-stagnation-effect being characterized by the van der Waals parameter variation δa relative to the van der Waals parameter a associated with said stationary-small-portion yet to be subjected to said deep-stagnation-effect; wherein the variation δa quantifying a potential energy stored in the arisen inter-molecular stress, so that a change of potential-energy-per-unit-mass, indicated by δU, of said molecular fluid, stored in the inter-molecular stress arisen due to said deep-stagnation-effect, is equal to ρδa/V²; and wherein the partial deep-stagnation pressure-“a”, indicated by δPₐ, is defined as a measure of said deep-stagnation-effect and quantified as equal to δa/V², such that the partial deep-stagnation pressure-“a” δPₐ and the potential-energy-per-unit-mass δU of the arisen inter-molecular stress are interrelated as δU=δPₐ/ρ; wherein said moving-small-portion being stagnated and being further subjected to said deep-stagnation-effect and thereby being deeply-stagnated;
(s) the Coanda-effect is defined as a tendency of said moving-small-portion to be attracted to and aligned with a curvature of a nearby fragment of said stationary wall, the tendency being accompanied by a cumulative aligning-impact of said fluid matter molecules on said non-overlapping quantization cell's imaginary boundaries, associated with said moving-small-portion flowing in a boundary layer adjacent to said stationary wall in alignment with the curvature of the nearby fragment of said stationary wall, and
wherein partial pressure-“c”, indicated by δP_{c}, is defined as a measure of the Coanda-effect cumulative aligning-impact of said fluid matter molecules on said non-overlapping quantization cell's imaginary boundaries;
(t) a drag-effect is defined as an effect of an asymmetrical disbalanced impact of molecules moving randomly and in a prevalent direction, wherein said drag-effect is a cumulative effect comprising both:
said stagnation-impact-effect providing for the partial stagnation pressure-“b” δP_{b},
said deep-stagnation-effect providing for the partial stagnation pressure-“b” δPₐ, and
the Coanda-effect providing for the partial pressure-“c” δP_{c},
wherein partial drag-static-pressure, indicated by P_{drag}, is defined as a measure of said drag-effect, the partial drag-static-pressure P_{drag}, acting on said moving-small-portion, is quantified as equal to the sum of three items, as expressed by: P_{drag}=δPₐ+δP_{b}+δP_{c};
(u) a skin-friction effect, in general, is defined as an influence of said stationary wall on said moving-small-portion; said influence arising in a boundary layer adjacent to said stationary wall, and more specifically, said skin-friction effect is defined as an effect of said molecular fluid molecules sticking to said stationary wall, wherein said skin-friction effect resulting in a specific spatial distribution of velocities of said moving-small-portions flowing in said boundary layer adjacent to said stationary wall, and
wherein partial skin-friction static-pressure, indicated by Pₛₖᵢₙ, acting on said moving-small-portion is defined as a measure of said wall-fluid molecular interaction forces cumulative action specifying, how much said stationary wall is sticky for said molecular fluid motion providing said skin-friction effect; wherein the partial skin-friction static-pressure Pₛₖᵢₙ is defined as proportional to the difference (a_{w}−a−δa), where a_{w} is a parameter defined as the van der Waals parameter a, but related to said wall-fluid molecular interaction forces thereby providing for at least one of:
the conditions (a_{w}−a−δa)=0 and Pₛₖᵢₙ=0 being interrelated, corresponding to a free-slip condition for said molecular fluid contacting with said stationary wall,
the condition (a_{w}−a−δa)>0 corresponding to said wall-fluid molecular interaction forces cumulative action against said moving-small-portion's motion direction accompanied by a dissipation of said moving-small-portion's kinetic energy into said moving-small-portion's heat energy, and
the condition (a_{w}−a−δa)<0 corresponding to said wall-fluid molecular interaction forces cumulative action, repelling said moving-small-portion from said stationary wall by said phobic-repulsing forces accompanied by a positive acceleration of said moving-small-portion at the expense of said moving-small-portion's heat energy;
(v) an osmotic-like effect is defined as an effect of exchange of matter and heat between said moving-small-portions, which have a common boundary and differ in at least one of density and temperature, and wherein partial osmotic-like static-pressure, indicated by P_{osmotic}, acting on said moving-small-portion, is defined as a measure of said osmotic-like effect;
(w) an effect of viscosity is defined as a cumulative effect comprising said skin-friction effect and said osmotic-like effect, and
wherein partial viscous-static-pressure, indicated by P_{viscous}, acting on said moving-small-portion, is defined as equal to the sum of two items, as expressed by: P_{viscous}=Pₛₖᵢₙ+P_{osmotic};
(x) a generalized adiabatic compressibility parameter, indicated by γ, is defined for said molecular fluid as
$$\{ \begin{matrix}γ = j & for hypothetical ideal gases \\ γ = 1 + r ( j - 1 ) & for real gases \\ γ >> 1 & for real liquids and plasma \\ γ \to ∞ & for incompressible liquids\end{matrix} ,$$
where j is an adiabatic compressibility-constant defined for said molecular fluid imagined as said hypothetical ideal gas, wherein the adiabatic compressibility-constant j is quantified as j=1+2/f, where f is the number of degrees of freedom per said molecule of said molecular fluid; and
(y) said cumulative impact effect,
characterized by the inner-static-pressure Pᵢₙ, is further specified as comprising:
said stationary-effect,
said drag-effect, and
said effect of viscosity,
and the inner-static-pressure Pᵢₙ is further defined as expressed by:
Pᵢₙ=Pₛ+P_{drag}+P_{viscous},
and wherein the inner-static-pressure Pᵢₙ interrelates with thermodynamic characteristics of said molecular fluid moving-small-portion by the equation Pᵢₙ=ρQ=ρRT, where Q is the characteristic heat portion per unit mass stored in said molecular fluid's molecular Brownian random motion related to degrees of freedom causing said fluid matter molecules cumulative impact effect acting on said imaginary boundaries of said moving-small-portion;
said method for computational fluid dynamics, providing a numerical analysis and estimation of said spatially distributed parameters, namely: the three components of the velocity-vector u, the temperature T, the density ρ, and the inner-static-pressure Pᵢₙ of said molecular fluid;
said numerical analysis comprising equations applied to each said small portion of said molecular fluid, as follows:
a generalized vector equation of momentum conservation specified as:
$$\frac{\partial }{\partial t} u = - ∇ ( uu ) - ∇ Q ,$$
where ∇ is the vector differential operator, and ∂/∂t is the time derivative operator;
an equation of mass conservation specified as:
$$\frac{\partial }{\partial t} ρ + ∇ \cdot ( ρ u ) = 0 ;$$
an equation of energy conservation specified as:
$$\frac{\partial }{\partial t} ρ ( \frac{{u}^{2}}{2} + \frac{Q}{( γ - 1 )} ) + ∇ [ ( ρu ) ( \frac{{u}^{2}}{2} + Q ) ] = 0 ;$$
an equation of fluid state, specified as: Pᵢₙ=ρQ=ρRT;
an equation of fluid inner-static-pressure specified as:
Pᵢₙ=Pₛ+P_{drag}+P_{viscous}; and
an equation of an adiabatic process, specified as: PᵢₙV^{γ}=Const; wherein said generalized vector equation of momentum conservation, the equation of mass conservation, the equation of energy conservation, the equation of fluid state, and the equation of an adiabatic process, altogether have an exact solution for streamlines of said molecular fluid steady-state flow, and wherein said exact solution for streamlines is the Bernoulli theorem saying that the value (Pᵢₙ/φ+(u²/2) is constant along any streamline of said molecular fluid steady-state flow;
and wherein said generalized vector equation of momentum conservation, the equation of mass conservation, the equation of energy conservation, the equation of fluid state, and the equation of an adiabatic process, altogether have an exact solution for a varying cross-sectional area of said molecular fluid steady-state flow, and wherein said exact solution for the varying cross-sectional area interrelates the varying cross-sectional area, indicated by A, with said velocity measured in Mach numbers by an equation of principle, the equation of principle being expressed by:
$$\frac{A}{{A}_{*}} = \frac{1}{M} {( \frac{γ - 1}{γ} )}^{\frac{1}{2}} {( \frac{2 + γ {M}^{2}}{γ + 1} )}^{\frac{γ + 1}{2 ( γ - 1 )}} ,$$
where A_{*} is a critical condition cross-sectional area of said molecular fluid steady-state flow moving with the specific said velocity measured in Mach numbers equal to \sqrt{γ−1/γ};
and wherein said generalized vector equation of momentum conservation, the equation of mass conservation, the equation of energy conservation, the equation of fluid state, the equation of fluid inner-static-pressure, and the equation of an adiabatic process, altogether have an exact solution for said steady-state flow, and wherein said exact solution for said steady-state flow interrelating the partial skin-friction static-pressure Pₛₖᵢₙ with the difference (a_{w}−a−δa), thereby predefining said wall-fluid molecular interaction forces cumulative action between said moving-small-portion and said stationary wall, wherein the cumulative action is at least one of attracting, repelling, and inert; and wherein said exact solution for said steady-state flow interrelating the partial drag-static-pressure P_{drag} with shape features and orientation of said stationary wall with respect to the velocity-vector u of said moving-small-portion, thereby predefining the Coanda-effect in said numerical analysis and predefining the shape features of said stationary wall when said method for computational fluid dynamics is applied for designing the shape features and thereby allowing for a design a fluid-repellent jet-gear corpus, comprising at least an outer layer made from a fluid-repellent material and having a substantially-airfoil orientation; wherein said outer layer having a relief-structured surface, contacting with nearby portions of said fluid and repelling said nearby portions of said fluid in said substantially-airfoil orientation.

2. The method for computational fluid dynamics of claim 1,
wherein said method for computational fluid dynamics further taking into account that said molecular fluid is in a potential gravitational field, wherein said generalized vector equation of momentum conservation is further specified and written in a differential form in terms of:
the characteristic heat portion per unit mass stored in said molecular fluid's molecular Brownian random motion related to degrees of freedom causing said fluid matter molecules cumulative impact, and
potential energy, stored in the potential gravitational field,
namely:
$$\frac{\partial }{\partial t} u = - ∇ ( uu ) - ∇ G - ∇ Q ,$$
where G is potential-energy-per-unit-mass of said molecular fluid stored in the gravitational field; wherein, without loss of generality, the potential-energy-per-unit-mass of said molecular fluid stored in the gravitational field of the Earth being approximated by the equation G=zg, where z is effective height of said molecular fluid portion above the Earth's ocean surface level, and g is the gravitational acceleration near the Earth's ocean surface level; wherein said equation of energy conservation is further specified and written in a differential form in terms of the heat energy, stored in the Brownian random motion of said fluid matter molecules, and the potential energy, stored in the gravitational field, namely:
$$\frac{\partial }{\partial t} ρ ( \frac{{u}^{2}}{2} + G + \frac{Q}{( γ - 1 )} ) + ∇ [ ( ρu ) ( \frac{{u}^{2}}{2} + G + Q ) ] = 0$$
wherein said further specified generalized vector equation of momentum conservation, the equation of mass conservation, said further specified equation of energy conservation, the equation of fluid state, and the equation of an adiabatic process, altogether have an exact solution for streamlines of said molecular fluid steady-state flow, and wherein said exact solution for streamlines is the Bernoulli theorem saying that the value (Pᵢₙ/φ+zg+(u²/2) is constant along any streamline of said molecular fluid steady-state flow.

3. A specifically shaped tunnel comprising two open butt-ends: inlet and outlet; wherein said specifically shaped tunnel having cross-sectional area specifically varying along said specifically shaped tunnel such that said specifically shaped tunnel performs a stage comprising three major successive constituents:
(a) a convergent funnel having said open inlet butt-end,
(b) a narrow throat having a shape comprising:
a narrowing sub-stage,
a cross-section of minimal area, and
a divergent sub-stage, and
(c) a divergent exhaust tailpipe having said open outlet butt-end;
said specifically shaped tunnel is exposed to a flowing fluid such that an incoming portion of said flowing fluid, further called said flowing fluid inward portion, entering said open inlet butt-end, flows along said specifically shaped tunnel through said three major successive constituents and exits through said open outlet butt-end;
wherein said fluid is at least one of liquid, gas, and plasma;
wherein said specifically shaped tunnel's variable cross-sectional area, indicated by A, being identical with said flowing fluid inward portion's variable cross-sectional area, thereby providing for said flowing fluid inward portion becoming a convergent-divergent flow portion comprising a convergent flow sub-portion, moving through said convergent funnel and said narrowing sub-stage of said specifically shaped tunnel, and comprising a divergent flow sub-portion, moving through said divergent sub-stage and said divergent exhaust tailpipe of said specifically shaped tunnel;
wherein a set of interrelated terms being defined as follows:
(a) an x-axis is defined as an imaginary axis oriented along said specifically shaped tunnel;
(b) x-coordinates, indicated by x, are defined as spatial coordinates located along the x-axis;
(c) a principal interval of the x-coordinates is defined as a fragment of the x-axis comprising at least the x-coordinates corresponding to location of said specifically shaped tunnel between said open inlet butt-end and said open outlet butt-end;
(d) a critical condition area, indicated by A_{*}, is defined as the minimal cross-sectional area of said narrow throat;
(e) a critical condition point, indicated by x_{*}, is defined as said x-coordinate corresponding to location of said critical condition area A_{*};
(f) a corpus of body, further called also said body corpus, is defined as a geometrical configuration aspect of the body and specified as a space-portion bordered by a solid shell contacting with said flowing fluid;
(g) an airfoil profile of said body corpus is defined as an elongated closed contour in a sectional plane, wherein said elongated closed contour having:
a rounded leading edge,
a sharp trailing end, and
two opposite lengthened smoothly curved sides, joining said rounded leading edge and said sharp trailing end, and thereby forming said elongated closed contour, wherein at least one of said two opposite lengthened smoothly curved sides comprising a convexity;
(h) a local sagittal axis, associated with said airfoil profile, is defined as an imaginary axis joining said rounded leading edge and said sharp trailing end;
(i) an airfoil shape of said body corpus is defined as a shape, having said airfoil profile of a longitudinal section in a local sagittal plane comprising said local sagittal axis, associated with the airfoil profile of the body corpus; wherein the body corpus, further called said airfoil body corpus, has at least one side comprising at least one convex withers; wherein the airfoil body corpus is oriented to meet an oncoming portion of said flowing fluid at said rounded leading edge of said airfoil profile, and thereby providing for said oncoming portion becoming an ambient-adjoining portion characterized by a static pressure distributed along said opposite lengthened smoothly curved sides of said airfoil profile at least one of linearly and substantially gradually, while flowing around the airfoil body corpus, and further, when stalling at said sharp trailing end of said airfoil profile, becoming an outflowing portion of said flowing fluid;
(j) the Coanda-effect is defined as a tendency of an ambient-adjoining portion of said flowing fluid to be attracted to and aligned with a nearby curved surface of said airfoil body corpus, the tendency being accompanied by a varying of said flowing fluid ambient-adjoining portion's cross-sectional area as said flowing fluid ambient-adjoining portion moves in alignment with the nearby curved surface of said airfoil body corpus;
(k) an M-velocity, indicated by M, is defined as said flowing fluid inward portion's velocity, measured relative to said specifically shaped tunnel, wherein said flowing fluid inward portion's velocity is measured in Mach numbers;
(l) an excluded volume is defined as a volume, excluded by the presence of molecules in the theory of molecular fluid by van der Waals;
(m) the compression ratio of said flowing fluid, indicated by r, is defined as V/(V−b), where V is the volume of said flowing fluid inward portion, and b is the van der Waals parameter, quantifying the excluded volume related to said flowing fluid;
(n) the specific M-velocity, indicated by M_{*}, related to said flowing fluid, is defined as equal to \sqrt{(γ−1)/γ}, where γ is so-called adiabatic compressibility parameter of said flowing fluid;
(o) a de Laval low M-velocity is defined as said M-velocity, lower than the specific M-velocity M_{*} and high enough to reach the specific M-velocity M_{*} at said critical condition point x_{*};
(p) a de Laval high M-velocity is defined as said M-velocity, higher than the specific M-velocity M_{*} and low enough to reach the specific M-velocity M_{*}, at said critical condition point x_{*};
(q) a de Laval M-velocity is at least one of said de Laval low M-velocity and said de Laval high M-velocity;
(r) an essential M-velocity range is defined as a range of said M-velocities, comprising said M-velocities of said flowing fluid inward portion moving along and within said principal interval of the x-coordinates, wherein the essential M-velocity range comprises the specific M-velocity M_{*};
(s) the Venturi effect is defined as an effect of a convective acceleration of said convergent flow sub-portion and a convective retarding of said divergent flow sub-portion, occurring, when said convergent-divergent flow portion moves with M-velocities lower than the specific M-velocity;
(t) the de Laval jet-effect is defined as an effect of a convective extra-acceleration and extra-cooling of said flowing fluid inward portion, the de Laval jet-effect occurring in an adiabatic process in a so-called de Laval nozzle, wherein the effect is observed as an acceleration and cooling of said incoming portion of said flowing fluid, entering the de Laval nozzle with said de Laval low M-velocity, wherein the acceleration and cooling of said flowing fluid inward portion remaining monotone along the de Laval nozzle and therefore resulting in an extra-accelerated and extra-cooled jetstream, outflowing through said open outlet butt-end with an M-velocity higher than the specific M-velocity M_{*};
(u) the de Laval retarding-effect is defined as an effect of a convective extra-slowing and extra-warming of said flowing fluid inward portion, the de Laval retarding-effect occurring in an adiabatic process in a de Laval nozzle, wherein the effect is observed as a slowing and warming of said incoming portion of said flowing fluid, entering the de Laval nozzle with the de Laval high M-velocity, wherein the slowing and warming of said flowing fluid inward portion remaining monotone along the de Laval nozzle resulting in an extra-slowed and extra-warmed jetstream, outflowing through said open outlet butt-end with an M-velocity lower than the specific M-velocity M_{*};
(v) the de Laval effect is at least one of the de Laval jet-effect and the de Laval retarding-effect;
(w) an enhanced jet-effect is defined as the de Laval effect optimized by smoothing of variable thermodynamic parameters of said flowing fluid, wherein said smoothing is a result of a specific varying of the cross-sectional area of said specifically shaped tunnel; and
(x) an equation of principle is defined as an equation interrelating the ratio A/A_{*} and the values M of said flowing fluid inward portion, wherein said equation of principle being expressed by:
$$\frac{A}{{A}_{*}} = \frac{1}{M} {( \frac{γ - 1}{γ} )}^{\frac{1}{2}} {( \frac{2 + γ {M}^{2}}{γ + 1} )}^{\frac{γ + 1}{2 ( γ - 1 )}} ;$$
thus, when said flowing fluid inward portion enters said open inlet butt-end with the de Laval M-velocity, thereby said enhanced jet-effect becomes triggered; wherein said specifically shaped tunnel's cross-sectional area A variation along said principal interval of the x-coordinates being specific, thereby providing said enhanced jet-effect optimization, wherein a gradualness of said M-velocity change being a criterion of said enhanced jet-effect optimization, such that the values M, varying in said essential M-velocity range, relate with the x-coordinates x of said principal interval as a monotonic smooth function M(x), wherein the values M and the ratio A/A_{*} are interrelated by said equation of principle for the values M belonging at least to said essential M-velocity range corresponding to the x-coordinates x of said principal interval, thereby, said equation of principle providing a certain dependency of the ratio A/A_{*} upon the x-coordinates x, thereby forming the cross-sectional area specifically varying along said specifically shaped tunnel;
namely, the ratio A/A_{*} varying versus the x-coordinates x, being functionally interrelated with a monotonic smooth function M(x) by the equation of principle, and, in turn, the monotonic smooth function M(x) being expressed versus a preferred linear function of the x-coordinate, wherein said preferred linear function of the x-coordinate is at least one of:
M̅(x)=M_{*}+α_{M}(x−x_{*}), where M̅(x) is a specific linear distribution of said flowing fluid M-velocity along the x-axis, and α_{M}=∂M̅(x)/∂x is a constant gradient of the M-velocity specific linear distribution along the x-axis within said specially shaped tunnel, thus, M(x)=M̅(x), thereby said preferred linear function M̅(x) providing that said enhanced jet-effect becoming optimized by the linear change of said flowing fluid inward portion M-velocity as said flowing fluid inward portion moves through said specifically shaped tunnel;
P̅(x)=P_{*}+α_{P} (x−x_{*}), where P̅(x) is a specific linear distribution of said flowing fluid static pressure, P_{*} is the static pressure of said flowing fluid inward portion at the critical condition point x_{*}, and α_{P}=∂P̅(x)/∂x is a constant gradient of the static pressure specific linear distribution along the x-axis within said specially shaped tunnel, and wherein,
M(x)={square root over (2{[P₀/P̅(x)]^{(γ-1/γ}−1}/γ)}, where P₀ is the stagnation pressure, thereby said preferred linear function P̅(x) providing that said enhanced jet-effect becoming optimized by the linear change of said flowing fluid inward portion static pressure as said flowing fluid inward portion moves through said specifically shaped tunnel;
T̅(x)=T_{*}+α_{T}(x−x_{*}), where T̅(x) is a specific linear distribution of said flowing fluid temperature, T_{*} is the temperature of said flowing fluid inward portion at the critical condition point x_{*}, and α_{T}=∂T̅(x)/∂x is a constant gradient of the temperature specific linear distribution along the x-axis within said specially shaped tunnel, and wherein
M(x)=\sqrt{2{[T₀/T̅(x)]−1}/γ}, where T₀ is the stagnation temperature, thereby said preferred linear function T̅(x) providing that said enhanced jet-effect becoming optimized by the linear change of said flowing fluid inward portion temperature as said flowing fluid inward portion moves through said specifically shaped tunnel; and
ρ̅(x)=ρ_{*}+α_{ρ}(x−x_{*}), where ρ̅(x) is a specific linear distribution of said flowing fluid density, ρ_{*} is the density of said flowing fluid inward portion at the critical condition point x_{*}, and α_{ρ}=∂ρ̅(x)/∂x is a constant gradient of the density specific linear distribution along the x-axis within said specially shaped tunnel, and wherein
M(x)={square root over (2{[ρ₀/ρ̅(x)]^{(γ-1)/γ}−1}/γ)}, where ρ₀ is the stagnation density, thereby said preferred linear function ρ̅(x) providing that said enhanced jet-effect becoming optimized by the linear change of said flowing fluid inward portion density as said flowing fluid inward portion moves through said specifically shaped tunnel;
thereby said specific varying of said specifically shaped tunnel's cross-sectional area being optimized by smoothing of distributions of said flowing fluid thermodynamic parameters, namely: the static pressure, the temperature, and the density along said specifically shaped tunnel, thereby providing suppression of said specifically shaped tunnel's walls mechanic vibrations and tensions;
and wherein at least one of said specifically shaped tunnel's walls is at least one of:
real, constructed from a solid material;
imaginary, formed by streamlines of said flowing fluid being subjected to an operation of the Coanda-effect; and
imaginary, formed by streamlines of said flowing plasma subjected to an action of a magnetic field.

4. The specifically shaped tunnel of claim 3;
wherein said open outlet butt-end being extra-widened according to the equation of principle, thereby, when said flowing fluid inward portion enters said open inlet butt-end with said de Laval low M-velocity, making enable for said flowing fluid inward portion to reach M-velocities of belonging to at least one of the following velocity ranges: high-subsonic, transonic, supersonic, and hypersonic downstream behind the critical condition point x_{*}.

5. The specifically shaped tunnel of claim 3;
wherein said open inlet butt-end being specifically-widened, at least one of stationary and controlled, thereby, when said flowing fluid inward portion enters said open inlet butt-end with said de Laval M-velocity being at least one of steady-state and varying in time, interrelating said de Laval M-velocity of said entering flowing fluid inward portion and said variable cross-sectional area of said entering flowing fluid inward portion according to the equation of principle, thereby providing such a conformity of said specifically-widened open inlet butt-end cross-sectional area with said de Laval M-velocity of flowing fluid inward portion crossing said specifically-widened open inlet butt-end, that a spatial distribution of said flowing fluid inward portion's M-velocity being substantially smooth upstream afore-and-nearby said specifically-widened open inlet butt-end, thereby further specifying said principal interval of the x-coordinates as a prolonged fragment of the x-axis comprising at least the x-coordinates of said specifically shaped tunnel location and at least the x-coordinates located upstream afore-and-nearby said specifically-widened open inlet butt-end.

6. A jet-engine comprising the specifically shaped tunnel of claim 3, and a compressor, arranged upstream afore said open inlet butt-end of the specifically shaped tunnel, thereby providing for said flowing fluid inward portion to be sufficiently at least one of pre-pressured and pre-heated, and thereby making enable for said flowing fluid inward portion to reach the specific M-velocity in said narrow throat at said critical condition point.

7. An aerodynamic device comprising the specifically shaped tunnel of claim 3, and an engine, arranged downstream behind said open outlet butt-end of the specifically shaped tunnel; said engine using said extra-accelerated and extra-cooled jetstream, outflowing through said open outlet butt-end; and wherein said engine is at least one of a jet-engine, a turbo-jet engine, a motor applied to a vehicle, a generator of electricity, a cooler, a Peltier element operating as thermoelectric generator, and a vapor-into-water condenser.

8. An improved propeller operating in fluid surroundings;
wherein a functionality of said improved propeller operation is defined as at least one of launching and sucking a jetstream; wherein said jetstream moving substantially along a sagittal axis;
said improved propeller comprising:
at least one set of airfoil blades,
an engine, consuming at least one of a power of burned fuel and electrical power, and transforming the consumed power into a power of the airfoil blades forced rotation thereby originating said jetstream, and
the specifically shaped tunnel of claim 3, bordering said jetstream, wherein the x-axis and said sagittal axis are substantially collinear;
wherein said at least one set of airfoil blades comprises first-airfoil-blades and second-airfoil-blades, each asymmetrically screwed and oriented relative to said sagittal axis, thereby, said first-airfoil-blades, when imaginarily compounded with said sagittal axis, constituting a chiral unit related to said first-airfoil-blades, and said second-airfoil-blades, when imaginarily compounded with said sagittal axis, constituting a chiral unit related to said second-airfoil-blades; wherein, the chiral unit related to said first-airfoil-blades is substantially in mirror-symmetrical conformance with the chiral unit related to said second-airfoil-blades;
wherein said engine provides forced rotations of said first-airfoil-blades and said second-airfoil-blades in a transitional space, wherein said forced rotations of said first-airfoil-blades and said second-airfoil-blades being in mutually-opposite directions, namely, from a frontal point of view, clockwise and inverse-clockwise, correspondingly; and wherein said first-airfoil-blades and said second-airfoil-blades, when rotating in the mutually-opposite directions, have an impacting side, being asymmetrically screwed and oriented relative to said sagittal axis, to push said fluid portions in unison, thereby causing that:
on the one hand, said forced rotations of each said first-airfoil-blades and said second-airfoil-blades inherently originating motions of said fluid portions in said transitional space, wherein said fluid portions motions comprise whirling motions and headway-motions, and
on the other hand, said forced rotations of said first-airfoil-blades and said second-airfoil-blades, occurring simultaneously and in the mutually-opposite directions, thereby compensating the whirling motions of said fluid portions and thereby resulting in a dominant headway-motion of said fluid portions forming said jetstream, moving directionally along the x-axis;
wherein said impacting sides of said first-airfoil-blades and said second-airfoil-blades are configured to at least one of focus and defocus said jetstream, thereby to vary a cross-sectional area of said jetstream as at least one of:
said launching jetstream moves along the x-axis behind and away from said transitional space, and
said sucking jetstream moves along the x-axis afore and toward said transitional space,
thereby providing for said jetstream cross-sectional area varying being in conformance with said specific varying of said specifically shaped tunnel's cross-sectional area;
wherein said specifically shaped tunnel's walls being at least partially at least one of
imaginary, constituted by said jetstream streamlines, and
real, made from a solid material;
and wherein the critical condition point x_{*} is located at least one of
downstream behind said transitional space while said improved propeller launching said jetstream; and
upstream afore said transitional space while said improved propeller sucking said jetstream.

9. An improved wind-turbine;
wherein a biconvex airfoil profile is defined as an elongated closed contour in a sectional plane, wherein said elongated closed contour having:
a rounded leading edge,
a sharp trailing end, and
two opposite lengthened smoothly curved sides, joining said rounded leading edge and said sharp trailing end, and thereby forming said elongated closed contour, wherein each of said two opposite lengthened smoothly curved sides comprising at least one convex withers;
said improved wind-turbine comprising:
an axle capable of a forced mechanic rotational motion, said axle oriented along a sagittal axis;
a set of identical airfoil blades attached to said axle; and
an engine, capable of transforming a power of said forced mechanic rotational motion of said axle into electrical power;
wherein each of said identical airfoil blades having an asymmetrical sectional profile, said asymmetrical sectional profile being said biconvex airfoil profile with said two opposite lengthened smoothly curved convex sides differing in convexity, thereby, when said improved wind-turbine is exposed to airflow moving along said sagittal axis, providing for,
a set of sub-portions of said oncoming airflow flowing around said set of identical airfoil blades, correspondingly, and
each said sub-portion of said set of sub-portions becoming divided between two jetstreams flowing adjacent to said two opposite lengthened smoothly curved convex sides, correspondingly,
wherein each of said two opposite lengthened smoothly curved convex sides is shaped to act on each of said two adjacent jetstreams by the Coanda-effect, thereby:
curving streamlines of each of said two adjacent jetstreams to form the specifically shaped tunnel of claim 3, said curving streamlines bordering said adjacent jetstream, wherein the x-axis, the local sagittal axis, and said sagittal axis are substantially collinear thereby providing the zero attack angle and thereby minimizing an impact of said two jetstreams on said two opposite lengthened smoothly curved convex sides of said identical airfoil blades, correspondingly;
causing arising of lift-forces acting on each of said identical airfoil blades, wherein all said asymmetrical sectional profiles being oriented to provide for a set of said lift-forces acting on said set of identical airfoil blades, correspondingly, in unison and thereby providing for said forced mechanic rotational motion of said axle at least one of clockwise and inverse-clockwise with respect to a frontal point of view; and
when the M-velocity of at least one of said two jetstreams reaching said de Laval M-velocity and, when moving nearby said at least one convex withers, reaching the specific M-velocity, triggering the de Laval enhanced jet-effect;
thus, said set of identical airfoil blades of said improved wind-turbine being configured to minimize the impact and to trigger at least one of the Coanda-effect and the de Laval enhanced jet-effect, both having the jet-effect nature, in the final analysis, to produce the electrical power at the expense of said airflow warmth.

10. An elemental jet-booster; wherein said elemental jet-booster's body corpus configuration comprising the specifically shaped tunnel of claim 3 and having said airfoil shape of the body corpus as a whole; thereby, when said elemental jet-booster being exposed to said flowing fluid, said flowing fluid becoming divided into said flowing fluid inward portion and said flowing fluid ambient-adjoining portion, and at least said flowing fluid ambient-adjoining portion becoming subjected to the Coanda-effect operation;
wherein said elemental jet-booster's body corpus configuration representing at least one of:
a convergent-divergent jet-nozzle, having an overall shape being said airfoil shape, and having a through hole being the specifically shaped tunnel;
a convergent funnel, having walls having said airfoil profile, wherein said convergent funnel being a convergent part of the specifically shaped tunnel, thereby, when said flowing fluid inward portion moving through said convergent funnel with said de Laval M-velocity, said flowing fluid inward portion becoming subjected to said enhanced jet-effect, providing for said flowing fluid inward portion's varying cross-sectional area interrelating with said varying M-velocity of said flowing fluid inward portion by said equation of principle, satisfying a condition of gradual smoothing of distributions of said flowing fluid thermodynamic parameters along the x-axis, and thereby further said flowing fluid inward portion stalling at said sharp trailing end of said airfoil profile and joining with said flowing fluid ambient-adjoining portion, and thereby forming said jetstream as a part of said outflowing portion of said flowing fluid, moving laminarly and becoming convergent-divergent and bordered by imaginary laminar streamlines of said flowing fluid ambient-adjoining portion, and thereby satisfying a condition of gradual smoothing of distributions of said flowing fluid thermodynamic parameters along the x-axis, thereby, the specifically shaped tunnel becoming partially formed by said imaginary streamlines of said outflowing jetstream; and
a specifically shaped airfoil body corpus, having said airfoil profile, wherein said airfoil profile being a part of a wall of the specifically shaped tunnel, satisfying a condition of gradual smoothing of distributions of said flowing fluid thermodynamic parameters along said airfoil profile, and having an opposite wall formed by said imaginary streamlines where thereby inherently providing a condition of gradual smoothing of distributions of said flowing fluid thermodynamic parameters along said airfoil profile, thereby, when said flowing fluid ambient-adjoining portion flowing around said airfoil body corpus with said de Laval M-velocity, said flowing fluid ambient-adjoining portion becoming subjected to said enhanced jet-effect, providing for said flowing fluid ambient-adjoining portion's varying cross-sectional area interrelating with said varying M-velocity of said flowing fluid ambient-adjoining portion by said equation of principle, satisfying a condition of gradual smoothing of distributions of said flowing fluid thermodynamic parameters along said airfoil profile, thereby, the specifically shaped tunnel becoming formed by said imaginary streamlines of said flowing fluid ambient-adjoining portion, and thereby said flowing fluid ambient-adjoining portion becoming identical to said flowing fluid inward portion;
thereby, said airfoil shape of said elemental jet-booster's body corpus as a whole being at least one of:
axis-symmetrical or mirror-symmetrical, thereby providing that said enhanced jet-effect resulting in an optimized reactive thrust-force applied to said airfoil body corpus and directed to said rounded leading edge, and
asymmetrical, having two opposite sides differing in convexity, thereby providing for said enhanced jet-effect resulting in an optimized both:
reactive thrust-force applied to said airfoil body corpus and directed to said rounded leading edge, and
lift-force applied to said airfoil body corpus and directed to that of said two opposite sides which being more convex.

11. An adiabatic aerodynamic system comprising a set of the elemental jet-boosters, claimed in claim 10;
wherein said set of the elemental jet-boosters comprises a sequential multi-stage cascade of at least N said elemental jet-boosters; wherein an overall arrangement of said sequential multi-stage cascade of at least N said elemental jet-boosters is along a smoothly curved locus; wherein said smoothly curved locus is at least one of a straight line and a curve; wherein said smoothly curved locus is at least one of unclosed and closed such that each pair of neighbor said elemental jet-boosters of said sequential multi-stage cascade comprises a previous elemental jet-booster and a next elemental jet-booster, oriented along said smoothly curved locus; wherein the previous elemental jet-booster is located upstream afore the next elemental jet-booster, and wherein each two neighbor said elemental jet-boosters of said sequential multi-stage cascade are at least one of spatially-separated and unbrokenly-connected; wherein:
an oncoming flow portion, associated with said elemental jet-booster, is defined as said flowing fluid portion, running at said rounded leading edge of said airfoil profile of the elemental jet-booster body corpus;
an outflowing convergent-divergent jetstream, associated with said elemental jet-booster, is defined as said flowing fluid inward portion, outflowing through said open outlet butt-end of the elemental jet-booster;
an ambient-adjoining convergent-divergent jetstream, associated with said elemental jet-booster, is defined as said flowing fluid ambient-adjoining portion, flowing around the elemental jet-booster;
thereby, said flowing fluid portion, while moving with M-velocities lower than said de Laval low M-velocities, is subjected to the Venturi effect, originated by the previous elemental jet-booster as a whole, thereby resulting in an integral acceleration of said flowing fluid portion as said flowing fluid portion flowing around the previous elemental jet-booster;
thereby, each next elemental jet-booster is exposed to said oncoming flow portion, associated with the next elemental jet-booster, comprising said outflowing convergent-divergent jetstream, associated with the previous elemental jet-booster, and thereby intensifying an effect of convergence of said ambient-adjoining convergent-divergent jetstream and said outflowing convergent-divergent jetstream, both associated with the next elemental jet-booster,
wherein the number N of said elemental jet-boosters in said sequential multi-stage cascade is chosen to satisfy a condition that for said flowing fluid, originally moving with said M-velocity, lower than the specific M-velocity, the resulting operation of said sequential multi-stage cascade of at least N said elemental jet-boosters provides for that a sub-portion of said ambient-adjoining convergent-divergent jetstream, associated with at least one of said elemental jet-boosters, reaches the specific M-velocity when moving through the cross-section of minimal area corresponding to said ambient-adjoining convergent-divergent jetstream;
thereby, said flowing fluid portion:
when reaching said de Laval low M-velocity, is inevitably subjected to the de Laval jet-effect, resulting in said flowing fluid portion's divergent sub-portion said extra-acceleration and extra-cooling, and thereby resulting in a motion with M-velocities higher than the specific M-velocity; and
when reaching said de Laval high M-velocity, is subjected to the de Laval retarding-effect, resulting in said flowing fluid portion's said divergent sub-portion extra-slowing and extra-warming, and thereby resulting in a motion with M-velocities lower than the specific M-velocity;
wherein said smoothly curved locus is at least one of a straight line, an arc, a spiral of Archimedes, an outer helical outline of the Archimedean screw, a rounded contour, an ellipse, and a circumference;
wherein said adiabatic aerodynamic system is at least one of stationary and moving;
and wherein said flowing fluid is at least one of natural and artificial, and is at least one of airflow and streaming water.

12. An air cooler and vapor-to-water condenser, comprising the adiabatic aerodynamic system of claim 11, wherein said ambient flowing fluid is a humid airflow bringing water-vapor; wherein, when said flowing fluid portion, originally moving with said M-velocity, lower than the specific M-velocity, being subjected to at least one of:
the Venturi effect, resulting in said flowing fluid portion acceleration and cooling, and
the de Laval jet-effect, resulting in said flowing fluid portion extra-acceleration and extra-cooling;
thereby reaching the so-called dew-point temperature corresponding to the humidity of airflow, the temperature of said flowing fluid portion, reduced down to the dew-point temperature, inevitably triggers a condensation of the water-vapor into airborne water-aerosols or drops of dew, sticking to an exposed body corpus surface.

13. A vortex generator, comprising the adiabatic aerodynamic system of claim 11, wherein said closed smoothly curved locus is a circumference, providing that said elemental jet-boosters of said sequential multi-stage cascade, arranged circumferentially, act on said flowing fluid portions with a sequentially multi-stage cascaded operation of the Coanda-effect reinforced multi-repeatedly in an adiabatic process, thereby aligning a motion of said flowing fluid portions with nearby airfoil surfaces of said elemental jet-boosters, thereby resulting in that said ambient-adjoining convergent-divergent jetstreams become circulating ambient-adjoining convergent-divergent jetstreams, wherein said sub-portions of said circulating ambient-adjoining convergent-divergent jetstream, when moving with M-velocities lower than the specific M-velocity, are subjected to the Venturi effect in a positive feedback loop, thereby providing an acceleration of said sub-portions of said circulating ambient-adjoining convergent-divergent jetstreams in said positive feedback loop, thereby resulting in that said sub-portions of said circulating ambient-adjoining convergent-divergent jetstreams become moving with said de Laval M-velocities triggering alternating both: the de Laval jet-effect and the de Laval retarding-effect, thereby stabilizing an effective M-velocity alternating above and below the specific M-velocity.

14. An engine, comprising the vortex generator of claim 13, wherein said engine is at least one of:
an air cooler, wherein said ambient flowing fluid is natural air;
a vapor-to-water condenser, wherein said ambient flowing fluid is humid air;
an electricity generator further comprising a converter, transforming a kinetic power of said flowing fluid's molecules motion into electrical power; wherein said converter is at least one of:
a turbo-generator comprising a rotor and stator, primary transforming a kinetic power of said flowing fluid motion in a prevalent direction into electrical power; and
a Peltier element operating as a thermoelectric generator, primary producing electricity from temperature difference caused by a jet-effect, wherein said jet-effect is at least one of the Venturi effect, the de Laval jet-effect, and the de Laval retarding-effect; and
a thrust-engine for a flying-saucer; said thrust-engine for said flying-saucer further comprising a set of airfoil wings; wherein said ambient flowing fluid is at least one of an artificial airflow and natural wind; and wherein said closed smoothly curved locus forming a closed contour placed in an imaginary so-called transversal plane; wherein said elemental jet-boosters having an effective height in a direction, perpendicular to said transversal plane, such that the vortex generator occupies an effective space in a form of a cylinder having:
an oval base, parallel to said transversal plane comprising said closed smoothly curved locus, and
a side of said effective height;
wherein said circulating ambient-adjoining convergent-divergent jetstreams, associated with said elemental jet-boosters, contacting with said flowing fluid portions within said cylinder, and thereby drawing and circulating said flowing fluid portions within said cylinder; and wherein said airfoil wings are arranged within said cylinder and oriented to meet said flowing fluid portions circulating within said cylinder, wherein said airfoil shape of at least one said oriented airfoil wing having said airfoil profile of said longitudinal section in said local sagittal plane, said at least one oriented airfoil wing being asymmetrical relative to said transversal plane, thereby causing a thrust-force, frequently called a lift-force, being perpendicular to said transversal plane.

15. A two-stage convergent-divergent tunnel comprising two open butt-ends: inlet, exposed to a flow, and outlet, by definition releasing an outflowing jetstream; said two-stage convergent-divergent tunnel comprising two specifically shaped tunnels: first-stage and second-stage; each of the two specifically shaped tunnels: first-stage and second-stage, is as claimed in claim 3, wherein said flowing fluid is the flow;
wherein said first-stage specifically shaped tunnel comprises two open butt-ends: a first-stage inlet and a first-stage outlet; and wherein said second-stage specifically shaped tunnel comprises two open butt-ends: a second-stage inlet and a second-stage outlet;
and wherein said second-stage specifically shaped tunnel is arranged downstream behind said first-stage open outlet butt-end by superposing said second-stage open inlet butt-end with said first-stage open outlet butt-end, thereby forming said two-stage convergent-divergent tunnel having two sequential major successive constituents:
(a) said first-stage specifically shaped tunnel, having said first-stage inlet becoming identical with said open inlet butt-end, exposed to the flow; wherein a portion of the flow, as said flowing fluid inward portion, enters said first-stage specifically shaped tunnel moving through said first-stage open inlet butt-end with said de Laval high M-velocity, thereby providing a condition for the de Laval retarding-effect triggering, wherein said first-stage specifically shaped tunnel being suited for said values M of said de Laval M-velocity varying in said essential M-velocity range, thus, said values M relate with said x-coordinates x of said principal interval corresponding to said first-stage specifically shaped tunnel as a monotonic smooth function M₁(x) having a negative partial derivation ∂M₁(x)/∂x, and thereby resulting in an M-velocity of said portion of the flow at said open first-stage outlet butt-end becoming lower that the specific M-velocity; and
(b) said second-stage specifically shaped tunnel, having said second-stage outlet becoming identical with said open outlet butt-end, releasing said outflowing jetstream; wherein said second-stage specifically shaped tunnel, meeting said portion of the flow, as said flowing fluid inward portion, moving through said second-stage open inlet butt-end with said M-velocity at said open first-stage outlet butt-end, wherein said second-stage specifically shaped tunnel being suited for said values M of said de Laval M-velocity varying in said essential M-velocity range comprising said M-velocity of said portion of the flow at said open first-stage outlet butt-end, said M-velocity of said portion of the flow at said open first-stage outlet butt-end thereby becoming said de Laval low M-velocity at said open second-stage inlet butt-end, thereby triggering the de Laval jet-effect; thus, said values M relate with said x-coordinates x of said principal interval corresponding to said second-stage specifically shaped tunnel as a monotonic smooth function M₂(x) having a positive partial derivation ∂M₂(x)/∂x.

16. A two-stage jet-booster, having a corpus with an outer overall airfoil shape and having the two-stage convergent-divergent tunnel, according to claim 15; wherein said flowing fluid ambient-adjoining portion, flowing around said corpus of said two-stage jet-booster and thereby becoming subjected to an operation of the Coanda-effect;
and wherein the two-stage convergent-divergent tunnel is at least one of:
real, inner, built-in into said two-stage jet-booster, having said real specifically shaped tunnel's walls;
imaginary, outer, bordered by streamlines of said flowing fluid ambient-adjoining portion, flowing around a tandem arrangement of two airfoil bodies, each having a specifically shaped airfoil corpus having at most one convex withers, wherein said tandem arrangement of two airfoil bodies, together having at most two said convex withers, is such that said at most two convex withers of the two specifically shaped airfoil body corpuses meet said flowing fluid ambient-adjoining portion sequentially, thereby resulting in a two-stage convergent-divergent varying of said flowing fluid ambient-adjoining portion's cross-sectional area as said flowing fluid ambient-adjoining portion sequentially passes over said at most two convex withers; wherein imaginary walls, formed by said streamlines, bordering said flowing fluid ambient-adjoining portion, constitute the two-stage convergent-divergent tunnel, and wherein said flowing fluid ambient-adjoining portion is said flowing fluid inward portion moving through the two-stage convergent-divergent tunnel; and
imaginary, outer, formed by at least two opposite walls, namely:
at least one side of said two-stage jet-booster corpus as real specifically shaped tunnel's wall having said outer airfoil shape being two-humped, comprising two sequentially arranged convex withers separated by a concavity and oriented such that said two convex withers meet said flowing fluid ambient-adjoining portion sequentially; and
at least one imaginary said specifically shaped tunnel's wall, formed by streamlines of said flowing fluid ambient-adjoining portion, moving nearby and in alignment with said outer two-humped airfoil side of said two-stage jet-booster corpus; thereby providing that said flowing fluid ambient-adjoining portion is said flowing fluid inward portion moving through the two-stage convergent-divergent tunnel.

17. A corpus of a fluid-repellent jet-gear, submerged in a fluid;
wherein a phobic-repulsing jet-effect is defined as a kind of jet-effect, occurring in a fluid near to a surface made from a fluid-repellent material; said kind of jet-effect occurring, when nearby fluid portions, contacting with the surface, become substantially subjected to a repelling action of phobic-repulsive van der Waals forces originated by the fluid-repellent material, wherein said repelling action being appeared as an acceleration of the nearby fluid portions; said acceleration occurring at the expense of said nearby fluid portions' internal heat energy, thereby said acceleration being inevitably accompanied by said nearby fluid portions' temperature decrease, thereby creating a temperature difference between an original temperature of said fluid's portions, yet to be subjected to said phobic-repulsing jet-effect, and a decreased temperature of said nearby fluid portions, already subjected to said phobic-repulsing jet-effect, and wherein said repelling action being at least one of an inherent property of the fluid-repellent material and controlled by an external power source;
said fluid-repellent jet-gear corpus comprising at least an outer layer, made from a fluid-repellent material; wherein said outer layer having a relief-structured surface, contacting with nearby portions of said fluid;
wherein said relief-structured surface comprising asymmetrically shaped and co-oriented protrusions thereby providing a cumulative repelling action of said phobic-repulsive van der Waals forces on said nearby fluid portions in unison and co-oriented in a prevalent direction, thereby causing said nearby fluid portions motion in said prevalent direction; wherein said asymmetrically shaped and co-oriented protrusions having a form of at least one of saw-like teeth, curved cogs having concave sides with parabolic sectional profiles, teeth-like fins, fish-scales, humps, airfoil convexities, screwed blades, convex airfoil withers, and spiral turns;
wherein an overall configuration of said fluid-repellent jet-gear corpus having a substantially-airfoil orientation, aligned to said prevalent direction;
wherein said overall configuration of said fluid-repellent jet-gear corpus is in a form of at least one of:
a bar, shaped as saw, having said substantially-airfoil orientation along said bar;
a wheel, shaped as circle-saw, having said substantially-airfoil orientation being at least one of clockwise and inverse-clockwise;
a convex-concave configuration, wherein a convex side has said substantially-airfoil orientation, and a concave side comprises said outer layer, made from said fluid-repellent material;
a spiral staircase, having said substantially-airfoil orientation along a helical contour;
a screw of Archimedes, having airfoil turns;
a set of streamlined wings;
a propeller; and
a capillary tube; wherein an inner side of said capillary tube comprising said outer layer, and wherein said protrusions, being asymmetrically shaped and co-oriented and located within said capillary tube, thereby providing said cumulative repelling action of said phobic-repulsive van der Waals forces on said nearby fluid portions, located within said capillary tube, in unison and co-directed along said capillary tube, thereby resulting in said nearby fluid portions motion along said prevalent direction along and within said capillary tube;
wherein said asymmetrically shaped and co-oriented protrusions are at least one of stationary and rotating relative to said fluid-repellent jet-gear corpus; wherein said fluid-repellent jet-gear corpus is at least one of stationary and moving relative to said fluid's portions, yet to be subjected to said phobic-repulsing jet-effect;
wherein said prevalent direction of said nearby fluid portions motion, being at least partially at least one of whirling, headway, and streaming along a helical trajectory; wherein said fluid is at least one of a water-based liquid, an oil-based liquid, an alcohol-based liquid, and an ionized gas or liquid; and
wherein said fluid-repellent material is at least one of hydrophobic, oleophobic, omniphobic, and ion-repellent.

18. The corpus of a fluid-repellent jet-gear of claim 17;
wherein said fluid-repellent jet-gear corpus further having an airfoil shape;
wherein said fluid is ambient humid air composed of ambient dry air and ambient water vapor;
wherein said fluid-repellent material is a hydrophobic material;
wherein said hydrophobic material further being porous, thereby providing that small portions of said ambient dry air penetrating into said porous material and thereby becoming inherent portions of said outer layer and thus originating two features:
on the one hand, said portions of said ambient dry air, as said inherent portions of said outer layer, make said outer layer becoming more inert to said ambient dry air, and
on the other hand, said hydrophobic material prevents said outer of said porous material from filling by water condensed from natural humid air,
thereby said two features providing a decrease of a skin-friction effect;
wherein said hydrophobic and porous material is at least one of a fuzz, a sponge, and a fibrous structure, and wherein said hydrophobic and porous material is at least one of natural and artificial.

19. A jet-engine pushing a vehicle; wherein an aggregated corpus of said jet-engine being composed of a multiplicity of sub-corpuses; wherein each said sub-corpus is the corpus of fluid-repellent jet-gear of claim 17; and wherein said sub-corpuses having said overall configuration and said asymmetrically shaped and co-oriented protrusions to provide said cumulative repelling action of said sub-corpuses on said fluid in unison in said prevalent direction thereby providing a substantial cumulative jet-thrust.

20. A hydrophobic generator of electricity; wherein an aggregated corpus of said hydrophobic generator of electricity comprising a set of sub-corpuses; wherein each said sub-corpus is the corpus of fluid-repellent jet-gear of claim 17;
said hydrophobic generator of electricity comprising a power converter; wherein said power converter is at least one of:
a turbo-generator,
wherein a rotor-subset is defined as a subset, comprising said sub-corpuses repelling said nearby fluid portions in at least one of said clockwise and said inverse-clockwise direction;
wherein a stator-subset is defined as a subset, comprising said sub-corpuses differing from said sub-corpuses belonging to said rotor-subset at least in one of shape, motion direction, and motion velocity;
said turbo-generator having a rotor, powered by motion of said rotor-subset, and a stator, restrained by said stator-subset; wherein said turbo-generator primary transforming a kinetic power of said nearby fluid portions motion in said prevalent direction into electrical power; and
a Peltier element operating as a thermoelectric generator, primary producing electricity from the temperature difference caused by said phobic-repulsing jet-effect; wherein a “cold” side of the Peltier element being submerged in said nearby fluid portions being already subjected to said phobic-repulsing jet-effect and thereby cooled having said decreased temperature, while a “hot” side of the Peltier element being submerged in said fluid's portions, yet to be subjected to said phobic-repulsing jet-effect and so having said original temperature;
and wherein said fluid is at least one of a permanently refreshed warm fluid having said original temperature and a fluid permanently consuming caloric.
